(19) United States
(12) Patent Application Publication
(10) Pub. No.: US 2020/0034788 A1
(43) Pub. Date: Jan. 30, 2020

(54) METHOD, SYSTEM, APPARATUS, AND PROGRAM FOR REAL-TIME AND ONLINE FREIGHT MANAGEMENT

(71) Applicant: Eugenio S. YNION, JR., San Pedro City (PH)

(72) Inventor: Eugenio S. YNION, JR., San Pedro City (PH)

(21) Appl. No.: 16/520,205

(22) Filed: Jul. 23, 2019

Related U.S. Application Data
(60) Provisional application No. 62/702,613, filed on Jul. 24, 2018.

(51) Int. Cl. G06Q 10/08; G06Q 30/04; G06Q 30/06; G06Q 30/08; H04L 9/06

(52) U.S. Cl. CPC G06Q 10/0835; G06Q 30/04; G06Q 10/08345; H04L 9/0637; G06Q 30/0611; G06Q 30/08; G06Q 10/0838

(57) ABSTRACT

A method for real-time and online freight management in the global logistics industry using a real-time chained black box is provided. The method includes steps of (a) providing a booking request submission stage, (b) providing a booking request acceptance stage, (c) providing a service delivery/fulfillment stage; and (d) providing a service payment stage.

### CROSS-REFERENCE TO RELATED APPLICATION

The present nonprovisional application claims the benefit of U.S. Provisional Application No. 62/702,613 filed Jul. 24, 2018 and incorporates the same by reference.

Additionally, the present nonprovisional application incorporates U.S. Provisional Applications Nos. 62/450,836 filed on Jan. 26, 2017, 62/472,409 filed on Mar. 16, 2017, 62/547,064 filed on Aug. 17, 2017, 62/551,122 filed on Aug. 28, 2017, and U.S. patent application Ser. No. 15/879,127 filed on Jan. 24, 2018 by reference.

### BACKGROUND OF THE INVENTION

### Field of the Invention

The present invention generally relates to a method, system, apparatus, and program for real-time and online freight management, and more particularly to an improved method, system, apparatus, and program for real-time and online freight management in the global logistics industry using a real-time chained black box.

The present invention in one aspect provides a novel way of managing booking requests, deliveries, and payments by providing four distinctive stages, including a booking request submission stage, a booking request acceptance stage, a service delivery/fulfillment stage, and a service payment stage.

### Related Art

One problem with the current global situation in the shipping, logistics and freight forwarding industries is that they are operating based on old and fragmented manual and automated systems which vary per country. This entails a large amount of paperwork, phone calls, and back and forth communication among the parties involved. It also often requires several layers of intermediaries (persons, corporations, etc.), and this creates additional layers of cost and process delay in the importing and exporting of physical goods across the globe. Furthermore, the records from various stakeholders are prone to integrity and accuracy constraints.

At present, there is no integrated and central storage of the various transactions involving the various stakeholders in the import and export of goods. More particularly, there is no integrated solution which can operate in a real-time and online mode using the Internet and Electronic Data Interchange (EDI) standards. An improved approach is therefore needed.

The present invention provides a novel method and system for an integrated and central platform that manages different transactions involving numerous stakeholders, including but not limited to shippers and service providers, in a real-time and online mode.

### SUMMARY OF THE INVENTION

The foregoing and other problems are overcome by a new method for real-time and online freight management, and also by a system, apparatus, and program that operate in accordance with the method.

The present invention in one aspect provides integrated and central storage of the various transactions involving the various stakeholders in the import and export of goods. The invention can provide a central, real-time recording and fully immutable repository of all concerned transactions created by both human and automated systems, which does not exist today, especially in the global logistics and shipping industry. The present invention provides an integrated solution which can operate in a real-time and online mode using the Internet and Electronic Data Interchange (EDI) standards. In one aspect the invention is a real-time chained black-box.

The solution of the present invention is the creation of computer software in conjunction with customized processes and techniques which can allow for a fully automated and online manner of completing a shipping transaction or freight forwarding transaction (i.e., import or export) “anywhere and anytime” across the globe, directly connecting a shipper (the importer and/or exporter) to all its service providers. The “service providers” may include, for example: a. trucking company, b. warehouse operators, and c. shipping company.

The solution of the present invention involves the creation of a computer software leveraging on various technologies—including “blockchain.” The use of “blockchain” technology, not exclusively but in conjunction with other forms of technologies, in the creation of the “black-box” of the present invention is the first one in the industry and is a novel and unique way of recording transactions in an immutable mechanism.

A blockchain (database) is a continuously growing list of records or “blocks” which are linked and secured using cryptography. Each block typically contains a hash pointer as a link to a previous block, a timestamp, and transaction data. By design, blockchains are inherently resistant to modification of the data. Functionally, a blockchain can serve as an open, distributed ledger that can record transactions between two parties efficiently and in a verifiable and permanent way. For use as a distributed ledger a blockchain is typically managed by a peer-to-peer network collectively adhering to a protocol for validating new blocks. Once recorded, the data in any given block cannot be altered retroactively without the alteration of all subsequent blocks and a collusion of the network majority. Blockchains are secure by design and are an example of a distributed computing system with high Byzantine fault tolerance. Decentralized consensus has therefore been achieved with a blockchain. This makes blockchains suitable for records management activities, such as identity management, transaction processing, and documenting provenance.

The concept of “black-box” may be said to be common in the airline industry wherein a plane in flight will record almost all recordable events in the plane while in flight. However, the same concept has never been implemented in the software industry and in particular to shipping and logistics, and it is not easy to implement the concept in these industries. The “black-box” in the airline industry is a closed system which is only used by authorities in the airline industry. In contrast, the black-box of the present invention is open to both registered end users and/or to customers of the invention software and can also be open to private and government authorities to view the transaction history of any global shipment arranged through the platform of the present invention.

In the software industry the black-box concept is not used but there are various logs or recordings done at random. However, in the present invention, all recordable events are digitally recorded into a database and/or flat-file and subsequently into a blockchain-enabled system to ensure immutability of records and increased data integrity.

Some of the more notable preferred aspects or features of the invention include the following. First, the computer software can use any computer or mobile device that can run browser software (e.g., Chrome, Edge, Firefox, Safari, Explorer, etc.) over the Internet. Second, the computer software can also use any device which runs operating systems such as Windows, Android and Apple iOS operating systems with access to the Internet. Third, the computer software exchanges digital data and metadata with other computer software running on a private or public cloud in order to establish online and 24/7 interaction. Fourth, the computer software supports its various stakeholders for their respective management and staff to easily operate the computer software through customized processes and techniques.

The present invention can be implemented using hardware, software, or a combination of both, including using where suitable one or more computer programs, mobile applications or “apps” (such as in devices 108, 110, 112, 114, etc. shown in the drawings and described more fully below). As is well known in the art, an app is a software application designed to run on mobile devices such as smartphones. Mobile apps are available through application distribution platforms, which are typically operated by the owner of the mobile operating system. Usually, mobile apps are downloaded from the platform to a target device such as a smartphone. Mobile apps are also sometimes downloaded to less mobile computers, e.g., laptops or desktops.

A “smartphone” as used herein includes the class of mobile phones or devices built on a mobile operating system, with more advanced computing capability and connectivity than a feature phone. Smartphones typically include high-resolution touch screens and web browsers that display standard web pages, as well as mobile-optimized sites. High-speed data access is provided by, e.g., Wi-Fi or Mobile Broadband. Common mobile operating systems in use include but are not limited to Apple's iOS, Nokia's Symbian, RIM's BlackBerry OS, Google's Android, Samsung's Bada, Microsoft's Windows Phone, and Hewlett-Packard's webOS. Such operating systems can be installed on many different phone models.

The present invention according to an example aspect provides a system for processing and storing transactions and reservations for online freight management, comprising: an end-user module for interfacing with a user device through an exclusive ingress module to execute a login procedure, wherein a user of the user device may be, e.g., a service provider; a middleware module for processing a request for a transaction by the user; a back-office corporate module for performing a procedure-based integrity check on each transaction, for managing each transaction, and for interfacing with the user device through an exclusive egress module to execute a logout procedure; and a black-box module communicating with the middleware module and storing data including transaction data, user profile data, and communication data, wherein the black-box module includes an entity relationship database for storing the data in an organized and readily retrievable structure.

According to one aspect of the invention, a method for real-time and online freight management in the global logistics industry using a real-time chained black box, comprises (a) providing a booking request submission stage, (b) providing a booking request acceptance stage, (c) providing a service delivery/fulfillment stage; and (d) providing a service payment stage.

According to another aspect, a device of a service provider is configured to perform the following steps:

initiating a booking request in the booking request submission stage,

displaying at least one applicable contracts with regard to the booking provided by a platform in the booking request submission stage,

determining whether at least one applicable contract is selected in the booking request submission stage,

completing portal field information and submitting the portal field information through a portal of the platform in the booking request submission stage,

receiving suggestions or offers with regard to the booking from the platform in the booking request submission stage,

providing a bidding offer through a bidding engine of the platform in the booking request acceptance stage,

generating a quotation when rates are not available on the platform in the booking request acceptance stage,

sending the quotation to the device of the shipper in the booking request acceptance stage,

completing service fulfillment/action task(s) provided by the platform in the service delivery/fulfillment stage,

determining whether a trade document is required in the service delivery/fulfillment stage,

determining whether other documents are required if the trade document is not required in the service delivery/fulfillment stage,

uploading a proof of service delivery/fulfillment to the cloud database and to a blockchain in the service delivery/fulfillment stage,

generating and sending an invoice to the device of the shipper in the service delivery/fulfillment stage,

storing the invoice in the cloud database and in the blockchain in the service delivery/fulfillment stage, and

determining whether the service provider opted for financing in the service delivery/fulfillment stage.

According to another aspect, the platform is configured to perform the following steps:

validating a booking request received from a device of a service provider in the booking request submission stage,

providing at least one applicable contract with regard to the booking request to the device of the service provider in the booking request submission stage,

auto-populating portal fields using information as per a contract selected by the service provider in the booking request submission stage,

providing suggestions or offers with regard to the booking request in the booking request submission stage,

validating the booking request in the booking request submission stage,

summarizing the booking request for review in the booking request submission stage,

sending the booking request to SVCs (Services Available in the Platform) in the booking request submission stage, wherein the SVCs comprises sea freight, container yard, trucking, port, freight forwarding, custom brokerage, warehousing, air freight, and insurance,

triggering service workflow fulfillment task(s) and communicating with the SVCs in the service delivery/fulfillment stage,

determining whether a template is available if trade documents are determined to be required by the device of the service provider in the service delivery/fulfillment stage,

auto-generating at least one trade document if a template is available and storing the at least one trade document in the cloud database and in the blockchain in the service delivery/fulfillment stage,

triggering service workflow payment task(s) and sending the service workflow payment task(s) to the SVCs in the service payment stage,

determining whether an invoice template is available in the service payment stage,

auto-generating an invoice if an invoice template is available and storing an auto-generated invoice in the cloud database and in the blockchain in the service payment stage,

sending the auto-generated invoice to the device of the service provider in the service payment stage,

triggering transaction based financing for the service provider if it is determined that there are credit terms by the device of the shipper and that the service provider opted for financing by the device of the service provider in the service payment stage,

updating an AR/AP ledger (account receivable/account payable ledger) if it is determined that there are credit terms by the device of the shipper in the service payment stage,

sending notification alerts of payables on or before due dates in the service payment stage,

processing payment via the ledger platform when the device of the shipper proceeds with payment in the service payment stage,

when the payment was successfully processed in the step of processing payment, determining whether the service provider availed financing in the service payment stage,

disbursing loan payment, which includes a principal and an interest if the service provider availed financing in the service payment stage,

disbursing a service fee to the service provider in the service payment stage, and

triggering transaction based financing for the shipper if it is determined that the shipper opted for financing in the service payment stage.

According to another aspect, the device of the shipper is configured to perform the following steps:

accepting a bidding offer in the booking request acceptance stage,

confirming rates after receiving a quotation from the device of the service provider in the booking request acceptance stage,

receiving information from the SVCs in the booking request acceptance stage,

triggering the bidding engine when the offer bidding setting is on in the booking request acceptance stage,

sending and receiving information by the bidding engine to and from the device of the shipper and the device of the service provider in the booking request acceptance stage,

auto-generating a quotation when rates are not available in the booking request acceptance stage

storing generated quotations in a cloud date base in the booking request acceptance stage,

selecting templates based on a generated quotation in the booking request acceptance stage,

receiving an invoice from the platform in the service payment stage;

acknowledging the invoice and accepting charges in the service payment stage,

determining whether there are credit terms in the service payment stage,

determining whether the shipper opted for financing if there are no credit terms in the service payment stage, and

proceeding with payment if the shipper did not opt for financing in the service payment stage.

According another aspect, a device of a bank partner is configured to perform the following steps:

receiving information from the device of the platform after transaction based financing for service provider is triggered in the service payment stage,

determining whether credit line and loans are approved for the service provider in the service payment stage,

disbursing an approved amount to a bank account of the service provider in the service payment stage,

receiving a loan payments in the service payment stage,

receiving information from the device of the shipper after transaction based financing for the shipper is triggered in the service payment stage,

determining whether credit line and loans are approved for the shipper in the service payment stage, and

disbursing an approved amount to the platform in the service payment stage.

According to another aspect, a system for real-time and online freight management in the global logistics industry using a real-time chained black box, comprises: (a) a device of a service provider; (b) a device of a shipper; (c) a platform on a server computer; and (d) a device of a bank partner.

The system is configured to provide four stages including a booking request submission stage, a booking request acceptance stage, a service delivery/fulfillment stage, and providing a service payment stage.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will be more readily understood from a detailed description of the exemplary embodiments taken in conjunction with the following figures.

FIG. 1 is a block diagram 100 of a system of the present invention according to one example embodiment.

FIG. 2 shows another block diagram of the system 100 of the present invention according to an example embodiment.

FIG. 3 also shows another block diagram of the system 100 of the present invention according to an example embodiment.

FIG. 4 is a flowchart showing a method that can operate in accordance with the system(s) shown in FIGS. 1-3.

FIG. 5, which includes FIGS. 5A-D, shows the database design in an Entity Relationship Diagram (ERD), according to an example embodiment of the present invention.

FIG. 6 is an AWS computer server infrastructure schematic showing the overall hardware and software setup of the system 100 according to one example embodiment.

FIG. 7 shows the system 100 of the present invention according to an example embodiment in which transactions occurring inside the system are saved to the black-box module 105.

FIG. 8 shows a close-up view of the integration infrastructure of the middleware module 104 of FIGS. 1-3 according to an example embodiment of the present invention.

FIG. 9 shows the back-office module 106 of FIGS. 1-3 according to an example embodiment of the present invention.

FIG. 10 shows a detailed view of the exclusive ingress module 101 shown in FIGS. 2 and 3 and its processes according to an example embodiment of the present invention.

FIG. 11 shows a sample screenshot illustrating the home screen for a shipper or exporter/importer, as an example.

FIG. 12 shows a detailed view of the exclusive egress module 103 of FIG. 2 and FIG. 3 and its processes according to an example embodiment of the present invention.

FIG. 13 shows an example of a sub-module 102-A within the end-user module 102 of FIGS. 1-3, interacting with a customs broker in particular.

FIG. 14 shows an example of a sub-module 102-B within the end-user module 102 of FIGS. 1-3, interacting with a shipping company in particular.

FIG. 15 shows an example of a sub-module 102-C within the end-user module 102 of FIGS. 1-3, interacting with a warehouse operator in particular.

FIG. 16, which includes FIGS. 16A-O, shows the database design in an Entity Relationship Diagram (ERD), according to another example embodiment of the present invention.

FIG. 17 is a flowchart illustrating a process and technique of implementing a bidding process (rate) selection by the shipper given the various rates available from the different shipping carriers, according to an example embodiment of the present invention.

FIG. 18 is a high-level process workflow of the present invention, according to an example embodiment of the present invention.

FIGS. 19A and 19B together comprise a workflow of a stage of booking request submission, according to an example embodiment of the present invention.

FIG. 20 is a workflow of a stage of booking request acceptance, according to an example embodiment of the present invention.

FIGS. 21A and 21B together comprise a workflow of a stage of service delivery/fulfillment stage, according to an example embodiment of the present invention.

FIGS. 22A, 22B, and 22C together comprise a workflow of a stage of service payment, according to an example embodiment of the present invention.

The invention will next be described in connection with certain exemplary embodiments; however, it should be clear to those skilled in the art that various modifications, additions, and subtractions can be made without departing from the spirit or scope of the claims.

### DETAILED DESCRIPTION OF THE PREFERRED EMBODIMENTS

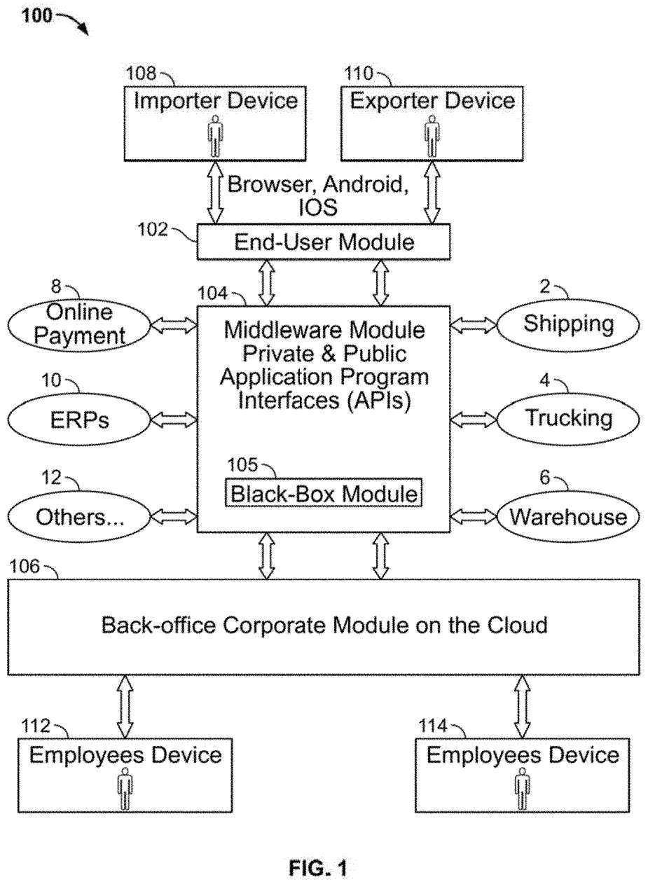

FIG. 1 is a block diagram of a system 100 of the present invention according to an example embodiment. One component of the system 100 is an end-user module 102, which is a component of the computer software that can interact with customers, e.g., importers and exporters, and all other stakeholders in the process via devices such as importer and exporter devices 108, 110 (or others). A second component is a middleware module 104. The middleware module 104 is the component of the computer software that talks to other computer software components being used by the other stakeholders in the import and export process. The middleware module 104 includes private and public Application Program Interfaces (APIs) that relate to shipping 2, trucking 4, warehouse 6, online payment 8, ERPs 10 (Enterprise Resource Planning), and other entities 12. A third component is a back-office corporate module 106, which may preferably be on the cloud (but need not be) and is the component of the computer software that is used by the employees and support or admin people of the corporation or entity that operates the computer software, who interact with the back-office corporate module via devices such as employee devices 112, 114 (or others). The back-office corporate module 106 is responsible for ensuring the integrity of all transactions.

With respect to implementing the middleware module 104 with a web service for third party applications integration infrastructure, a middleware in the software is similar to a bridge; it bridges external systems into the software through the use of a web service or application program interface (API). This bridging of systems through the middleware establishes a two-way communication channel among systems interacting with the software.

Another notable component of the invention is a black-box module 105, which is shown in FIG. 1 as a component of the middleware module 104 of the software platform, but of course the black-box module 105 could be a separate module interacting with the middleware module 104 and others. Anyone who is inside or using the system 100 is monitored by the black-box module 105. This means that all important digital transactions, user profile changes, and communication with other stakeholders can be performed inside the system 100. Online payments and related important actions can be permanently and immutably recorded inside by the black-box module 105.

The black-box module 105 is a combination of computer software, internet, database, blockchain, and related technologies. Notably, in one example embodiment of the invention, the black-box module 105 cannot be bypassed even if an unauthorized person or entity attempts to gain entry to the platform. The black-box module 105 has various levels of software triggers which allow for automatic recording at various levels in the overall hardware and software platform. The only allowed access to the black-box module 105 is for reporting and viewing of transactions inside the black-box module. No update, edit, or delete is possible for data recorded inside the black-box module 105.

The black-box module continuously records all pertinent or relevant transactions in the system of the present invention (XLOG). This recording of data ensures the integrity of all transactions in the database since all transactions can be reviewed or audited anytime. A virtually unlimited number of transactions can be recorded in the system. The black-box module can be fully integrated into the system.

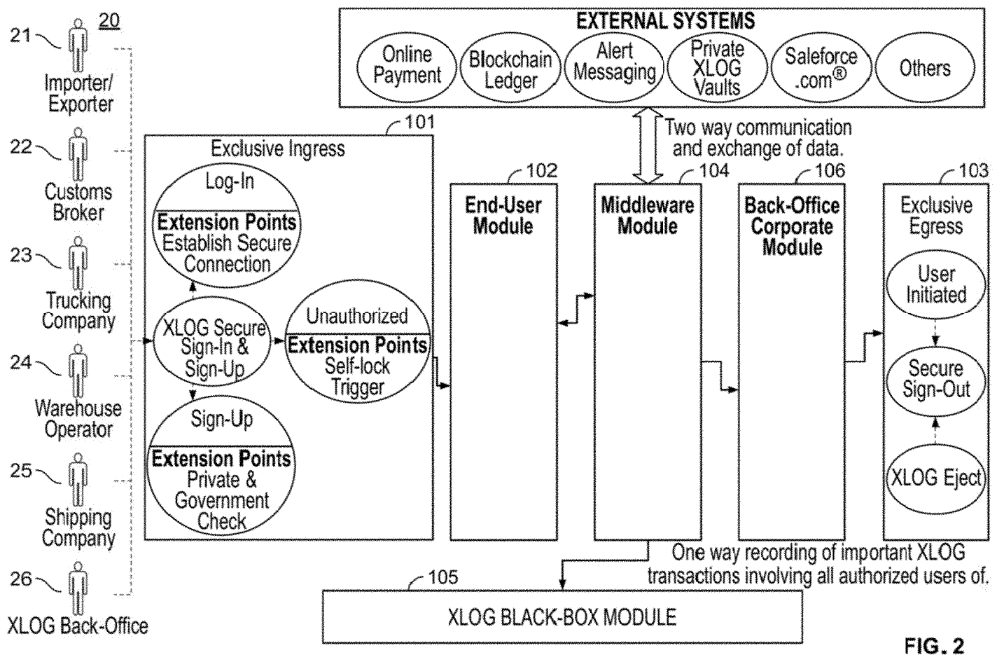

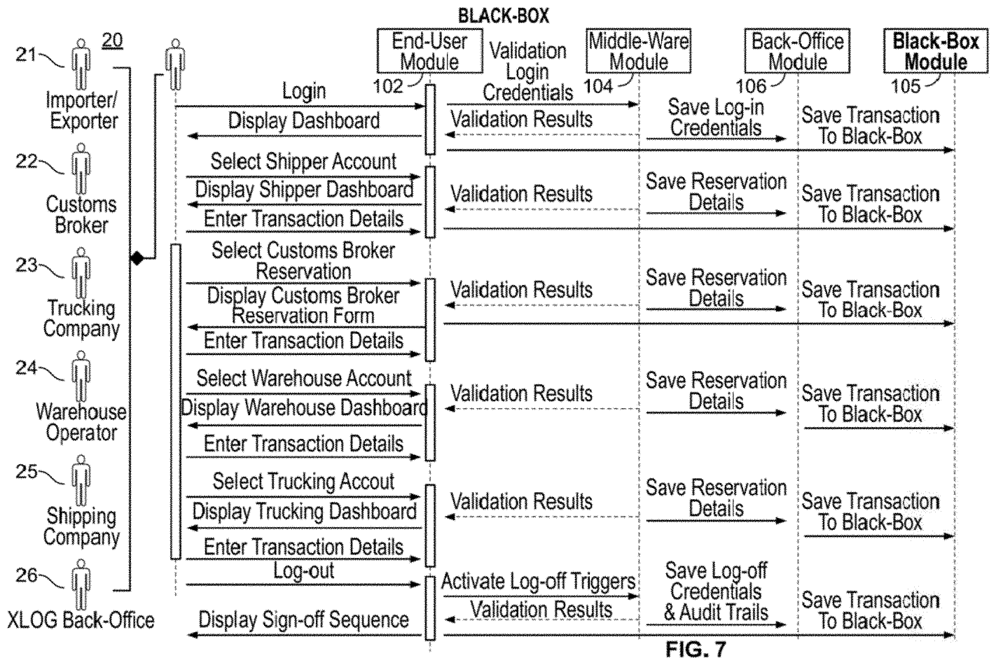

FIG. 7 shows the system 100 according to an example embodiment of the present invention illustrating how the black-box module 105 of FIG. 2 interfaces with the other modules and components of the system, particularly the end-user module 102, the middleware module 104, the back-office corporate module 106, and the various participants 20 who are participating via their devices 108, 110, 112, 114, such as importer/exporter 21, customs broker 22, trucking company 23, warehouse operator 24, shipping company 25, back-office participant 26, or others (not shown). It is of course to be understood that the participants 20 are just examples, and other parties representing other industries/etc. could be participants as well.

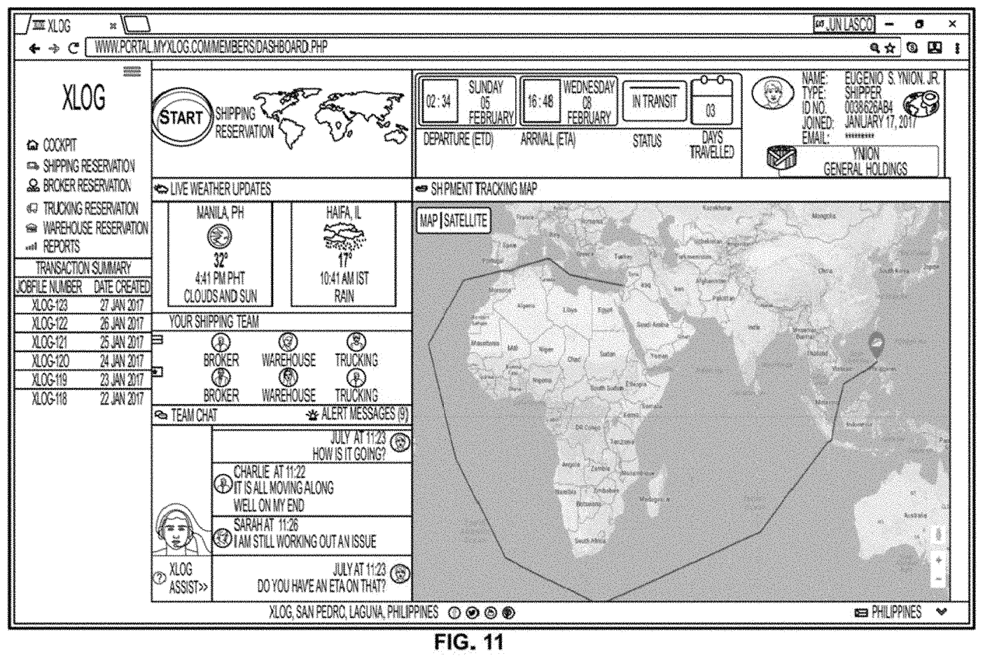

FIG. 7 shows a procedure or method of the system 100 according to an example embodiment in which transactions occurring inside the system are saved to the black-box module 105. First, the end-user module 102 carries out a login procedure after accepting a login request from one of the participants 20, e.g., an importer/exporter 21, customs broker 22, trucking company 23, warehouse operator 24, shipping company 25, back-office participant 26, or others. The back office participant 26 can have access to End-User Module 102 and Back-Office Module 106. If the end-user module 102 determines that the participant 20 requesting login has valid login credentials, a dashboard is displayed such as that shown in FIG. 11, discussed further below.

Once granted login the participant or user 20 can carry out various authorized tasks. For example, an importer/exporter 21 is enabled to carry out tasks such as selecting a shipper account, and see a shipper dashboard, and enter transaction details. A customs broker 22 is enabled to carry out tasks including selecting a customer broker reservation, and see a customer broker reservation form, and enter transaction details. A user for a trucking company 23 is enabled to carry out tasks including selecting a trucking account, see a trucking dashboard, and entering transaction details. A warehouse operator 24 is enabled to carry out tasks including selecting a warehouse account, see a warehouse dashboard, and enter transaction details. Once the user or participant 20 requests logout, a logoff procedure is activated by the middleware module 104 and a sign-off sequence is carried out by the end-user module 102.

As can be seen in FIG. 7, all items such as login credentials, reservation details, transaction details, audit trails, and logoff credentials are saved by the back-office module 106 to the black box module 105.

Accordingly, it can be seen from the description and drawings herein that the black-box module 105 is the component of the system 100 that stores all digital/electronic transactions which occur inside the system 100. All transactions of the major stakeholders and other participants or users can be stored or saved within the system's black-box module 105.

FIG. 2 shows a more detailed block diagram of the system 100 of the present invention according to an example embodiment. It is noted that the end-user module 102 is designed to be the only and main interaction component of the system 100. The end-user module 102 is not allowed to interact with any external software systems except the exclusive ingress module 101 (internal sign-in module). The end-user module 102 handles functional processes including for example, but not limited to, the following:
1. Shipping Reservation
2. Truck Reservation
3. Warehouse Reservation
4. Customs Broker Reservation
5. Employee Collaboration & Support
6. Other Authorized Users.

The middleware software module 104 comprises various micro-services or groups of independent computer programs which can act independently in collaboration with other micro-services. The middleware module 104 is also the module which interacts with third-party or external computer systems. Internally, the middleware module 104 is the central processor of all requests for transactions by the various actors or users of the system. A critical attribute of the middleware module 104 is that it is able to concurrently and instantly complete an online transaction by a system user in collaboration with other systems.

As noted above, the back-office corporate software module 106 is responsible for ensuring the integrity of all transactions. This involves a combination of automated verifications and procedure-based integrity checks through the use of back-office support staff of the company running the platform. The back-office module 106 is not allowed to interact with any other computer systems except the internal middleware module 104. The only interaction is with the exclusive egress module 103 (sign-out module) which is designed to automatically or manually log off or exit an online user.

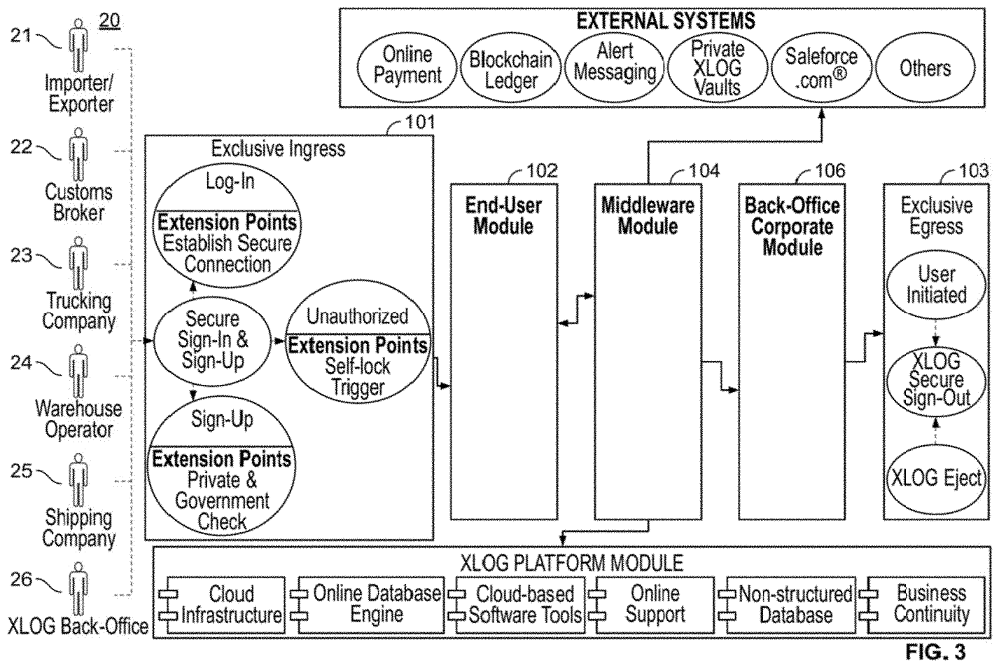

FIG. 3 shows a more detailed block diagram of the system 100 of the present invention as well, according to an example embodiment. The platform of FIG. 3 coming off the middleware module 104 includes blocks comprising Cloud Infrastructure, Online Database Engine, Cloud-based Software Tools, Online Support, Non-structured Database, and Business Continuity, which need not be specific to the middleware module 104 but may comprise the overall or total platform of XLOG to operate.

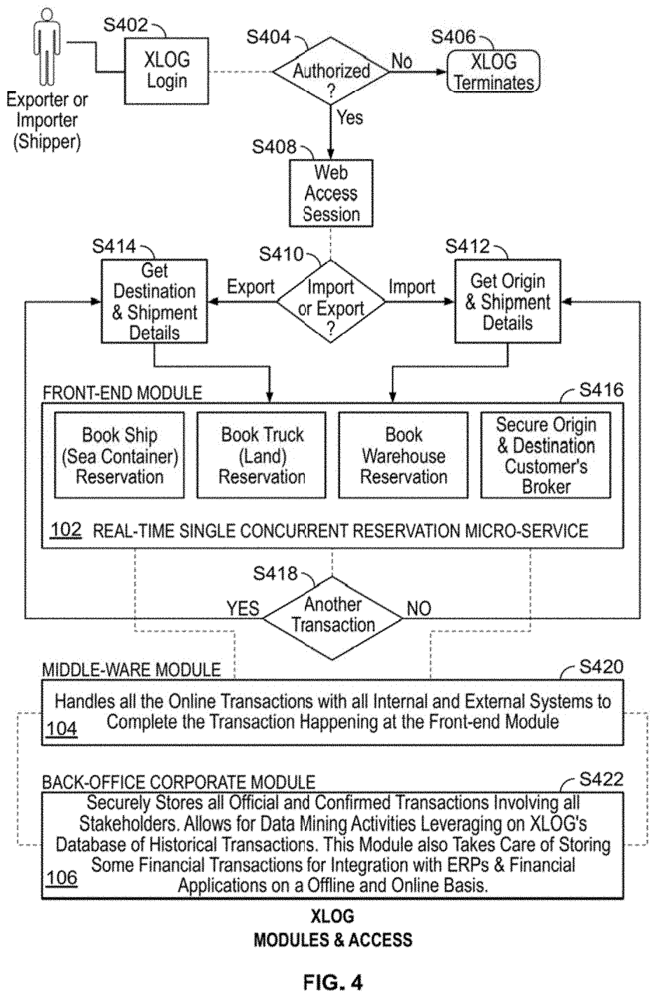

FIG. 4 is a flowchart showing a method 400 that can operate in accordance with the system 100 shown in FIGS. 1-3.

In the example method 400 shown in FIG. 4, the processes carried out by the front-end module, i.e., the end-user module 102 operating in conjunction with the exclusive ingress module 101, are as follows. In step S402 the end-user module 102 enables an exporter or importer (shipper) to login using his or her device 108, 110. The device 108, 110 may be a computer system such as a personal computer (PC), laptop, etc., or a handheld device or smartphone having a mobile app or computer program installed therein. In step S404 the end-user module 102 checks with the middleware module 104 whether the exporter or importer attempting to log in is authorized to do so. If not then in step S406 the process is terminated. If so then the method performed by the end-user module 102 proceeds to a Web Access Session in step S408, and a web access session is begun. If it is determined by the end-user module 102 in step S410 that the work is importing then the method performed by the end-user module 102 proceeds in step S412 to obtain the origin and shipment details. If on the other hand it is determined by the end-user module 102 in step S410 that the work is exporting then the method proceeds in step S414 to obtain the destination and shipment details.

In step S416 functions can be carried out as applicable such as book ship (sea carrier) reservation, book truck (land) reservation, book warehouse reservation, secure origin and destination customers broker, etc. These are performed by the front-end or end-user module 102 employing real-time single concurrent reservation micro-service. In step S418 it is determined whether another transaction is desired and if so the process goes back to step S410 and if not the process goes back to step S408.

In the meantime the middleware module 104 performs step S420 in handling all the online transactions with all internal and external systems to complete the transaction(s) happening at the end-user module 102. The back-end office corporate module 106 securely stores all official and confirmed transactions involving all stakeholders, allows for data mining activities leveraging on a database of historical transactions, and also stores financial transactions for integration with ERPs and financial applications on an offline/online basis.

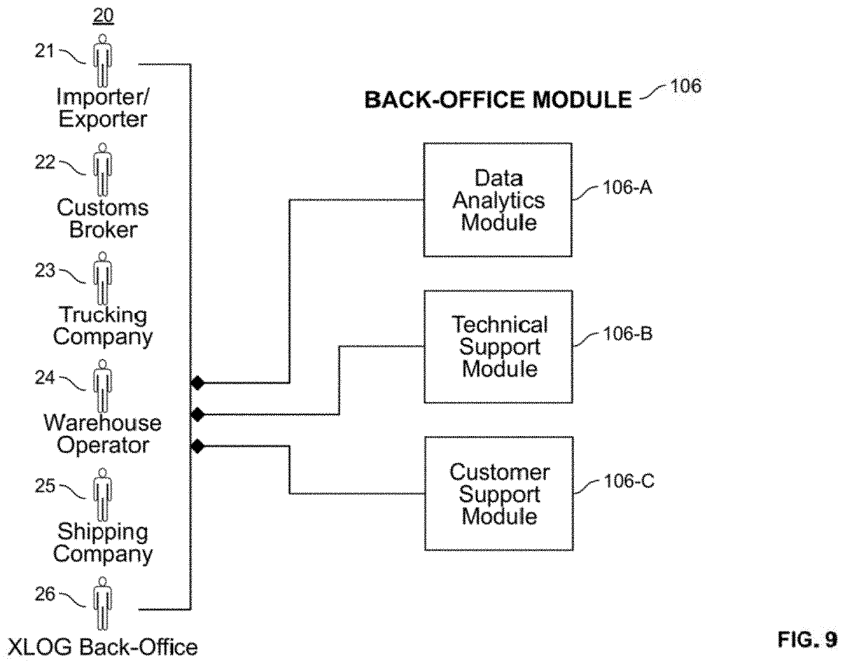

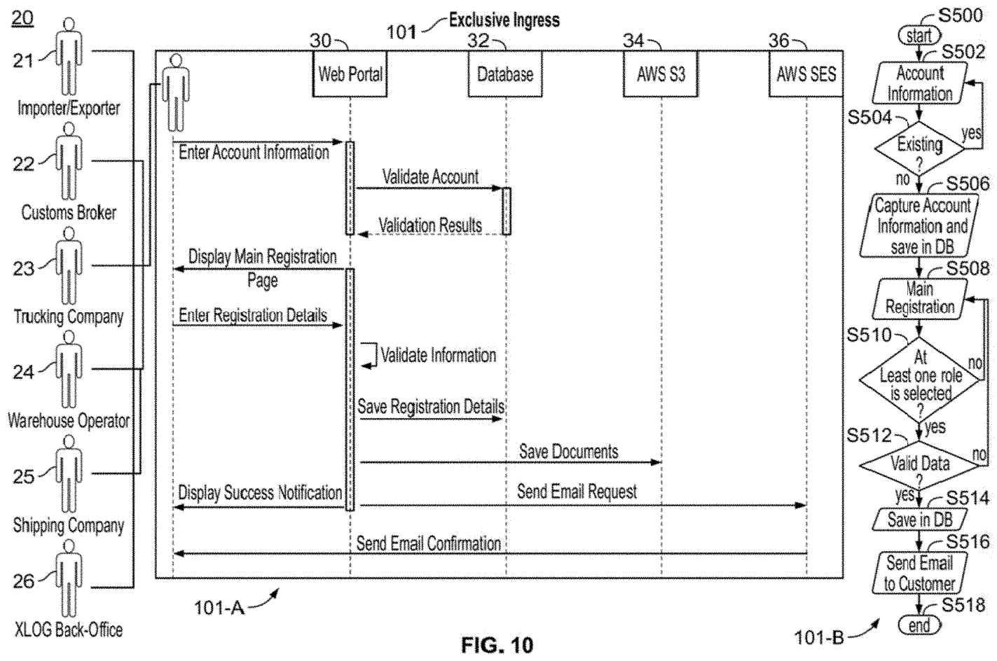

FIG. 10 shows a detailed view of the exclusive ingress module 101 shown in FIG. 2 and FIG. 3 and its processes according to an example embodiment of the present invention. Here it is noted that a conventional ingress/egress module is done by using a user-identification and typing the password; however, the present invention goes beyond such conventional method in at least one respect, by combining biometrics and a one-time password or session key by sending a user 20 of the system 100 a password or key via the mobile phone through an SMS (Simple Message System) or text message.

As shown in FIG. 10 the exclusive ingress module 101 has a login procedure for establishing a secure connection between a user 20 and the end-user module 102 and for signing in and signing up a user 20 when authorized. Element 101-A of FIG. 10 shows a web portal 30, a database 32, Amazon Web Services (AWS) S3 34, and AWS SES 36. (S3 refers to Simple Storage Service and SES refers to Simple Email Service.) Thus, the exclusive ingress module 101 may be implemented through the facility of Amazon Web Services (AWS) for third party applications, for example. The Application Program Interface (API) setup under AWS allows for a highly efficient and secure method for online/real-time integration with various systems outside of the system 100 of the present invention. A user of the system 100 does not have to worry about how the system 100 integrates with various systems that are not originally a part thereof. The API component handles this integration requirement.

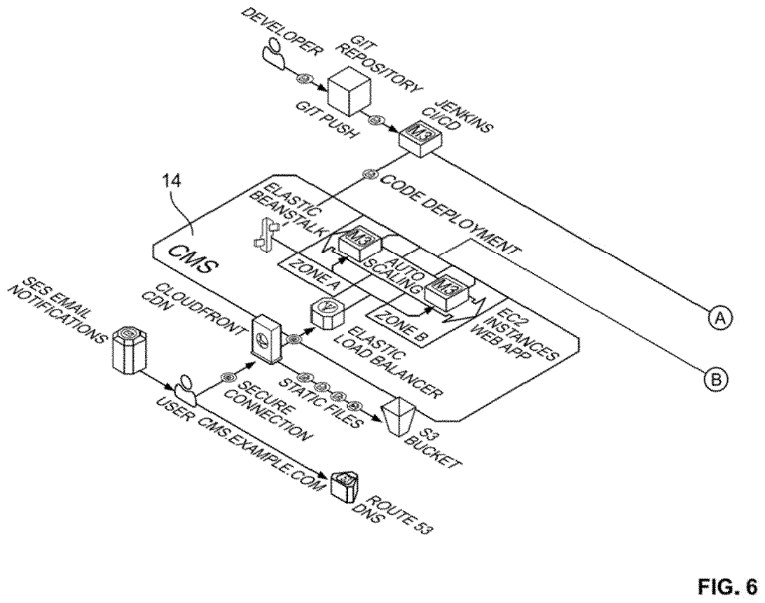

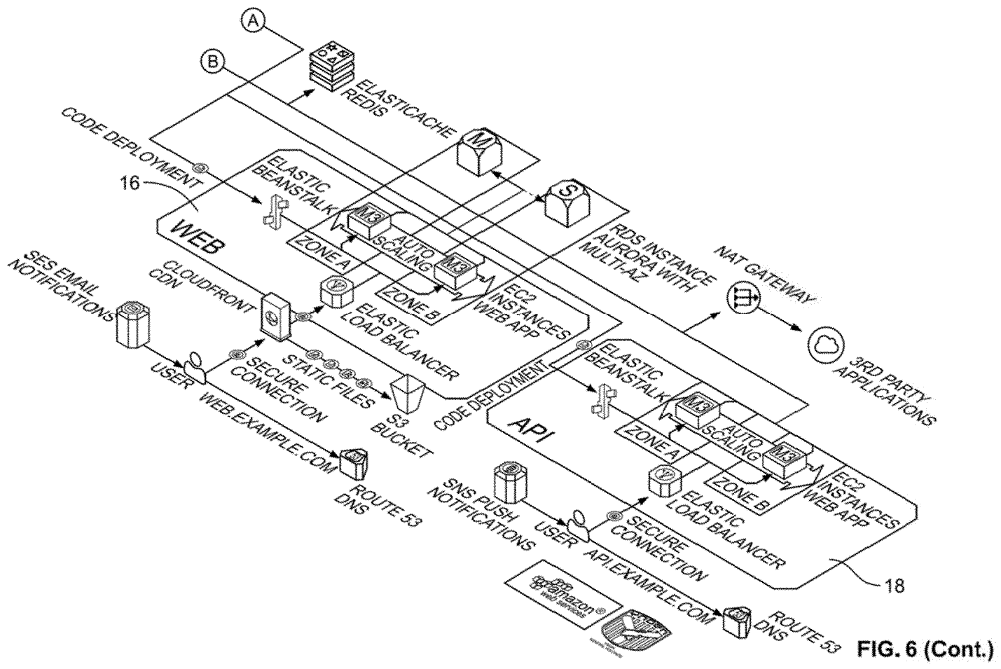

Thus, the AWS is the Amazon Web Services setup of the system 100 of the present invention. See the AWS computer server infrastructure schematic shown in FIG. 6. This is the overall hardware and software setup of the system 100 according to one example embodiment. FIG. 6 shows how the various components, hardware and software including the Content Management System (CMS) 14, web component 16, and Application Program Interface (API) 18 work together as one integrated solution.

That is, the system 100 of the present invention (XLOG) is designed to include three (3) major components. The first is the Content Management System (CMS) 14. Another is the web component 16. Another is the Application Program Interface (API) 18. The API 18 was created to handle all of the external system integration requirements which would allow the system 100 to interface with other, outside systems. API is RESTful Web services to provide interoperability between other systems, using OAuth 2 as industry standard protocol for authorization, which provides simplicity in authorization flows for web, desktop, and mobile applications. The CMS 14 is like the back-office and administration component of the system 100. In other words, CMS is a backend content management system, which provides an intuitive user interface for modifying web page content. This is where applications and transactions from the web interface is reviewed and approved.

The WEB component 16 is the main user interface for the various stakeholders of XLOG. WEB is a frontend web interface where shipper, broker, trucker, and warehouse carry out their transactions.

For the backend, Linux can be the operating system; Apache can be the web server; MySQL can be the database; and PHP can be the programming language.

For the frontend, Vue.js can be the JavaScript framework; Bulma can be CSS framework; and SASS can be the CSS Pre-processor.

“Auto scaling” is a method used in cloud computing, whereby the amount of computational resources in a server farm, typically measured in terms of the number of active servers, scales automatically based on the load on the farm. Auto Scaling helps the operator have the correct number of Amazon EC2 instances available to handle the load for your application. Zones A&B take advantage of the safety and reliability of geographic redundancy by spanning the Auto Scaling group across multiple Availability Zones within a region.

“Elastic Beanstalk” as used in FIG. 6 is an AWS tool that enables to quickly deploy and manage applications in the AWS Cloud without worrying about the infrastructure that runs those applications. The Elastic Beanstalk reduces management complexity without restricting choice or control. When an application is uploaded, the Elastic Beanstalk can automatically handle the details of capacity provisioning, load balancing, scaling, and application health monitoring. The system can be configured to deploy its application and environments by the Elastic Beanstalk, which automatically handles the details of capacity provisioning, load balancing, auto scaling and application health monitoring.

Simple Storage Service (S3) allows users to store and retrieve various sized data objects using simple API calls. S3 is designed for 99.999999999% durability and 99.99% availability. S3 does not comprise a computing element and is only a storage. An independent computing device or tool (such as EC2) can be used to compute data. The disclosed system can store all static files in S3 such as product images, pdf manuals, and videos.

Relational Database Service (RDS) is Amazon Relational Database Service (Amazon RDS) that makes it easy to set up, operate, and scale a relational database in the cloud. It provides cost-efficient and resizable capacity while managing time-consuming database administration tasks, freeing an operator up to focus on the applications and business. The XLOG deployment can use Amazon RDS MySQL with Multi-AZ Deployments. With Multi-AZ deployment, Amazon RDS automatically provisions and manages a “standby” replica in a different Availability Zone (independent infrastructure in a physically separate location). In the event of planned database maintenance, DB Instance failure, or an Availability Zone failure, Amazon RDS will automatically failover to the up-to-date standby.

Virtual Private Cloud (VPC) allows an operator to logically isolate a section of the AWS cloud and provision services inside of that isolated network. Using VPC helps provision services inside AWS and it is enabled by default for all new accounts. VPC has various configuration options for accessibility to the Internet and other AWS services. Public-facing subnets can be created in VPC, where the instances can have direct access to the public Internet gateway and other AWS services. Instances can be provisioned in private subnets as well, where their access to the Internet and other AWS services can be restricted or managed through network address translation (NAT). RDS instances can be accessed from within a VPC.

Elastic Compute Cloud (EC2) allows users to rent virtual machines of different configurations, on demand, for the time required. For this deployment, EC2 instances are the equivalent of servers that run Jenkins (continuous integration and continuous delivery toolchain). EC2 offers several different types of instances with different pricing options.

Amazon ElastiCache (Redis) automatically detects and replaces failed nodes, reducing the overhead associated with self-managed infrastructures and provides a resilient system that mitigates the risk of overloaded databases, which can slow the website and increase application load times. For XLOG deployment, Redis is used as a session store and application cache.

Amazon Simple Email Service (Amazon SES) is a cost-effective email service built on the reliable and scalable infrastructure that Amazon.com developed to serve its own customer base. With Amazon SES, one can send and receive emails with no required minimum commitments—users only pay for what the users use.

Amazon Route 53 is a highly available and scalable cloud Domain Name System (DNS) web service. All DNS request to XLOG can be handled by AWS Route 53.

Amazon CloudFront is a global content delivery network (CDN) service that accelerates delivery of websites, APIs, video content or other web assets through CDN caching.

Amazon Simple Queue Service (SQS) offers a reliable, secure, and highly-scalable hosted queuing service for storing messages in transit between computers. SQS can be used by XLOG to queue time consuming task like image resize, document processing, and sending emails. Deferring these time consuming tasks drastically speeds up web requests to the application.

AWS CodeCommit is a fully-managed source control service that makes it easy for companies to host secure and highly scalable private Git repositories. All XLOG application source code can be securely stored using CodeCommit.

For high availability and security, the present disclosure can have: multi-AZ architecture intended for high availability, isolation of instances between private/public subnets, security groups limiting access to only necessary services, network access control list (ACL) rules to filter traffic into subnets as an additional layer of network security, standard IAM policies with associated groups and roles, exercising least privilege, implementation of proper load balancing and auto scaling capabilities, and Amazon RDS database backup and encryption.

The performance of XLOG application may depend on many factor including EC2 instance type, Provisioned IOPS, and application workload. With cloud computing such as AWS, there are number of principles the present disclosure can achieve in terms of performance and efficiency. First, it is easy to deploy the system in multiple regions around the world with just a few clicks. This allows the operator to provide lower latency and a better experience for the customers at minimal cost. Second, with virtual and automatable resources, comparative testing using different types of instances, storage, or configurations can be quickly carried out. Third, with cloud computing, the operator need not guess capacity needs. He or she can use as much or as little capacity as he or she needs, and scale up and down automatically. Fourth, in the cloud, the capability to automate and test on demand lowers the risk of impact from design changes. This allows the systems to evolve over time so that businesses can take advantage of innovations as a standard practice.

With regard to networking and security, the present disclosure can use VPC and Security Groups. VPC is a logically separated section of the AWS cloud that provides complete control over the networking configuration, including the provisioning of an IP space, subnet size and scope, access control lists, and route tables. Security Groups are analogous to firewalls. Rules for EC2 instances can be defined, and allowable traffic, IP addresses, and port ranges can be defined.

XLOG can be currently run for example on 64 bit Amazon Linux 2017.03 v2.4.0 running PHP 7.0 AMI using Elastic Beanstalk. For more efficient development lifecycle, different environments, which can be easily promoted to production, can be set up. First, the development environment is where latest changes can be continuously deployed into the development server or sandbox. This is where testing is performed by the developer. Second, user acceptance testing (UAT) is the stage where interface testing can be performed. The quality assurance team can make sure that the new code will not have any impact on the existing functionality and they can test major functionalities of the system once after deploying the new code in their respective environment. Lastly, in the production stages, the system can serve end-users.

XLOG can be deployed through a cloud service (such as AWS services) to regions that are self-contained geographical locations. The regions can have their own deployment of each service. Each service within a region has its own endpoint that the operator can interact with to use the service. The regions contain availability zones, which are isolated locations within a general geographical location. Some regions can have more availability zones than others. While provisioning, the operator can choose specific availability zones or let AWS select.

The flowchart in FIG. 10 describes an exclusive ingress procedure as carried out by the exclusive ingress module 101 according to an example embodiment. In step S500 the procedure begins. In step S502 account information entered by the user 20 into the web portal 30 is received. In step S504 it is determined whether the user 20 is an existing user. If the answer to step S504 is Yes, the method returns to step S502, however, please refer to FIG. 2 (101-A) which shows that the next step is for the system to validate/verify the account information in the database for further validation and security check before the user is allowed access inside the system 100. If the answer to step S504 is No, then the web portal displays a main registration page and in step S506 the account information, which is inputted by the user 20, is captured and saved in the database 32. Then in step S508 the main registration protocol is carried out and the main registration page is displayed to the user 20, and the registration details entered by the user 20 are received.

In step S510 it is determined whether at least one role is selected. If not, the procedure returns to the main registration protocol of step S508; if so, the procedure in step S512 determines whether the data (e.g., the registration details entered by the user) is valid. If the data is valid then in step S514 the data is saved in the database 32; if not, the procedure returns to the main registration protocol of step S508. In step S516 the web portal sends an email request to a cloud email provider (here, Amazon Web Services Simple Email Service), and an email is sent to the customer or user 20 and then in step S518 the procedure ends. All documents, emails, and email requests can be saved.

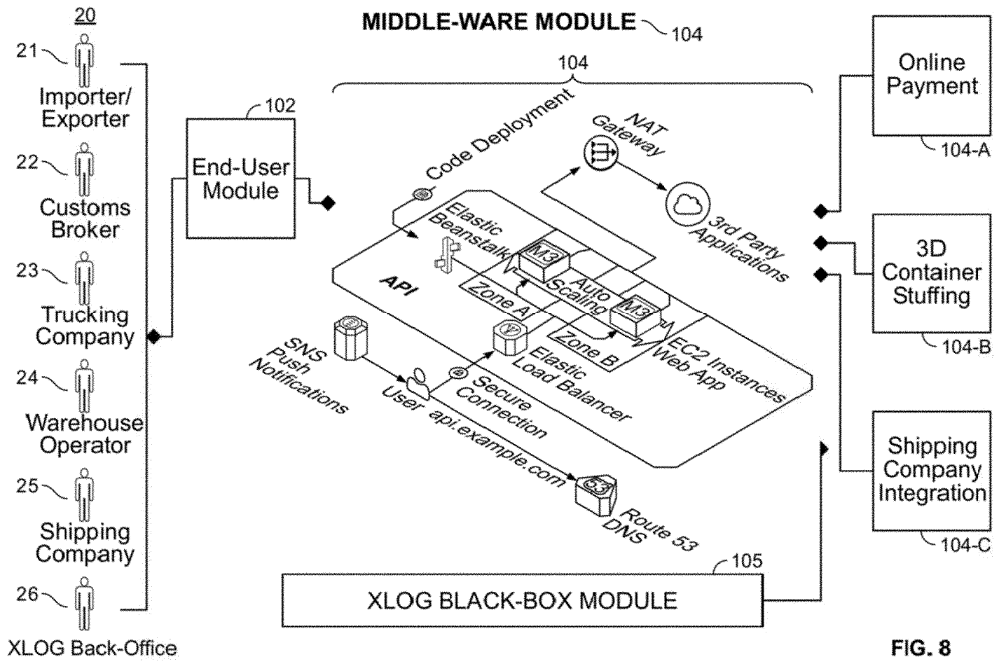

FIG. 8 shows a close-up view of the integration infrastructure of the middleware module 104 of FIGS. 1-3 according to an example embodiment of the present invention. The middleware module 104 may be implemented through the facility of Amazon Web Services (AWS) for third party applications, for example. The Application Program Interface (API) setup under AWS allows for a highly efficient and secure method for online/real-time integration with various systems outside of the system of the present invention (XLOG). A user of the system does not have to worry about how the system integrates with various systems that are not originally a part thereof. The API component handles this integration requirement. Functions such as online payment 104-A, 3D container stuffing 104-B, and shipping company integration 104-C are carried out.

FIG. 9 shows the back-office module 106 of FIGS. 1-3 according to an example embodiment of the present invention. The back-office module 106 uses all of the available, incoming and historical data inside the system to proactively manage the various real-time transactions inside the system and in collaboration with other third-party applications (software). In this way the back-office module 106 has a Data Analytics Module 106-A for communicating with the participants or users 20 with regard to data analytics, forecasting, black-box inquiry reports, performance dashboards, reporting, etc. Technical Support Module 106-B relates to technical support for internal and external users 20 of the system. Customer support module 106-C carries out a customer support/ticketing system for reported incidents from internal and external customers/users. XLOG Back-office 26 can control Back-Office Module 106 to interact with other users 21-25.

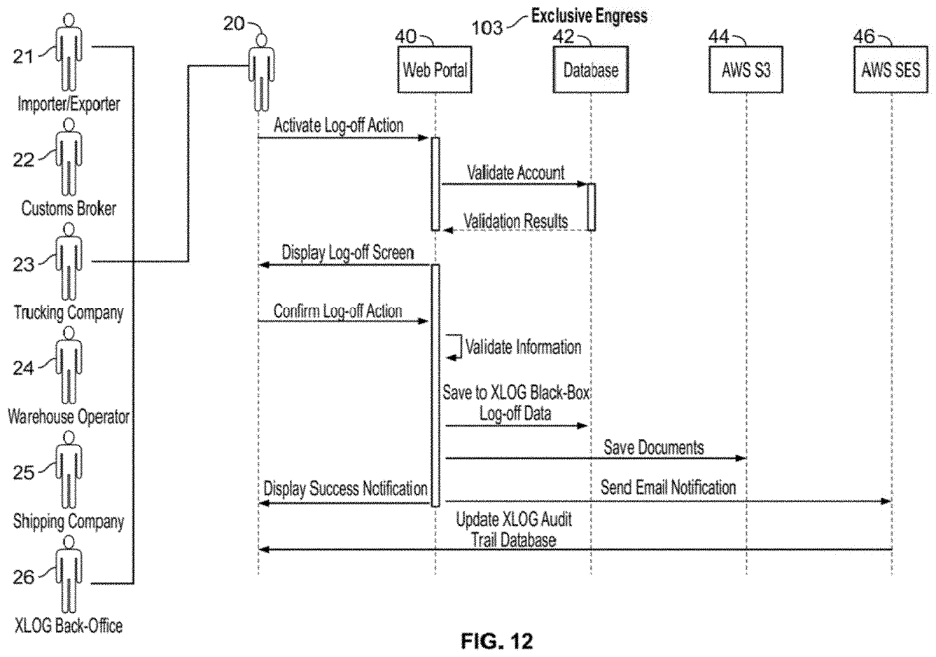

FIG. 12 shows a detailed view of the exclusive egress module 103 shown in FIG. 2 and FIG. 3 and its processes according to an example embodiment of the present invention. FIG. 12 includes a web portal 40, a database 42, a cloud storage (such as an Amazon Web Services Simple Storage Service (AWS S3)) 44, and a cloud email service (such as an Amazon Simple Email Services (AWS SES)) 46. Thus, the exclusive egress module 103 may be implemented through the facility of Amazon Web Services (AWS) for third party applications, for example. The Application Program Interface (API) setup under AWS allows for a highly efficient and secure method for online/real-time integration with various systems outside of the system of the present invention. A user of the system does not have to worry about how the system integrates with various systems that are not originally a part thereof. The API component handles this integration requirement.

In FIG. 12 the user 20 activates a log-off action through a web portal 40 and if the account is validated then database 42 stores the results. A logoff screen is then displayed to the user 20 by the web portal 40, and the web portal 40 requests that the user confirm the logoff action, at which time the data is validated and a notification of a successful logout is displayed to the user and the audit trail database is updated. All of the logoff data, documents, and email notifications/confirmations can be saved to the black-box module 105.

FIG. 11 shows a sample screenshot illustrating the home screen for a shipper or exporter/importer 21, for example. This can be referred to as the system's Cockpit.

The Cockpit contains the following major elements: (a) the name, photo, and related information about the user who is logged into the system; (b) the menu options available to the user; (c) the historical transactions related to the user; (d) the respective team the user has selected for each transaction created using the system; (e) basic shipping information such as date, time, location, and other related information per shipment or XLOG transaction; (f) the option to “START” or commence an end-to-end import or export process and communication with all parties involved; (g) a map showing the near real-time location of the shipment (land and ocean); and (h) an inside the system communication facility.

The system of the present invention can accommodate several major types of users. A user or participant 20 is a person who is registered in the system. The following list includes notable types or User Roles of the users 20, although this list is not meant to be exhaustive: shipper (importer/exporter) 21; customs broker 22; trucking company/truck owner 23; warehouse company/warehouse owner 24; shipping company or carrier 25; back-office employees of the system 26.

Each user or participant 20 has his or her own Cockpit (dashboard). A user 20 can change his or her User Roles allowed and registered into the system without the need to log out and again log in. All transactions inside the system can be stored in a “Black-Box.”This Black-Box is the storage of some or all transactions inside the system. This serves as a fully reliable reference for existing shipments/transactions and for historical shipments/transactions.

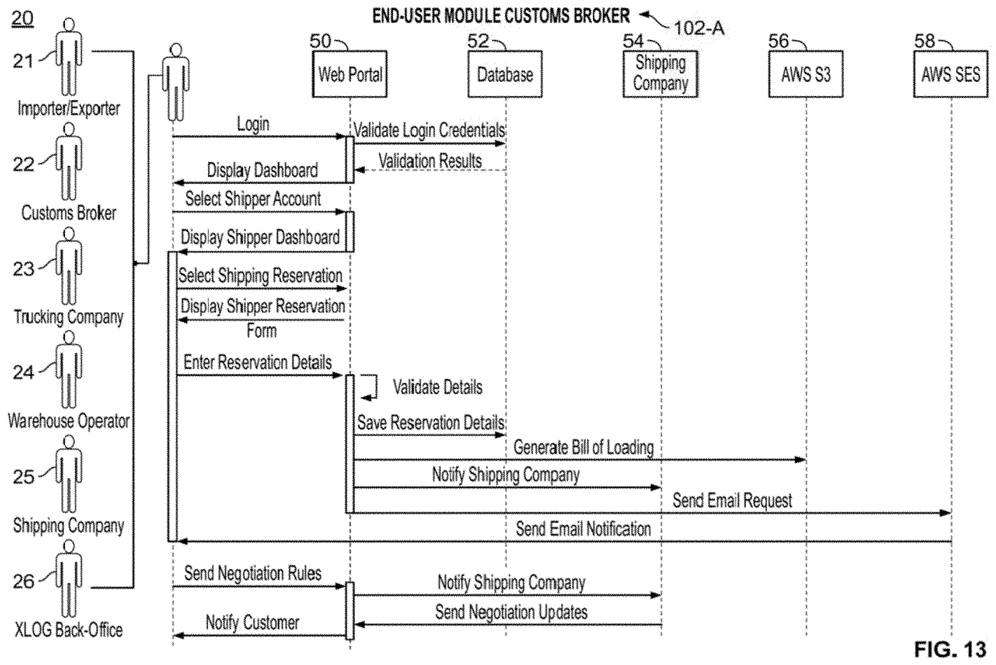

FIG. 13 shows an example of a sub-module 102-A within the end-user module 102 of FIGS. 1-3, interacting with a customs broker 22 in particular. This can be structured as a customs broker module 102-A within the end-user module 102. The customs-broker module 102-A can interact with the user 20 through a web portal 50 and communicate with a database 52, a shipping company module 54, a cloud storage (AWS S3) 56, and a cloud email service provider (AWS SES) 58. The customs-broker module 102-A allows online collaboration with all of the stakeholders in the import and export process. The initial booking or reservation is initiated and completed using the system. The customs-broker module 102-A may be implemented through the facility of Amazon Web Services (AWS) for third party applications, for example. The Application Program Interface (API) setup under AWS allows for a highly efficient and secure method for online/real-time integration with various systems outside of the system of the present invention. A user of the system does not have to worry about how the system integrates with various systems that are not originally a part thereof. The API component handles this integration requirement. AWS S3 56 is the storage of the output from the activities by the customs broker 22. Such outputs could include (but are not limited to) digital documents, drawings, scanned images, related materials, etc. AWS SES 58 is the component of the system 100 that allows the sending and management of emails to concerned parties of the system 100.

As shown in FIG. 13 the web portal 50 handles a login attempt by the customs broker 22. Login credentials are validated and stored in the database 52. Upon validation a dashboard is displayed to the customs broker 22 by the web portal 50. From the dashboard the customs broker 22 can select a shipper account to carry out a shipping reservation, after which a shipping reservation form is shown on the dashboard in which the customs broker 22 can enter the reservation details. Once the details are validated, the reservation details are saved in the database 52, a bill of lading is generated and stored in AWS S3 56, and the shipping company is notified by the shipping company module 54. The web portal 50 can receive negotiation rates sent by the customs broker 22 and notify the shipping company module 54 which can in return send negotiation updates which the web portal 50 notifies the customer of.

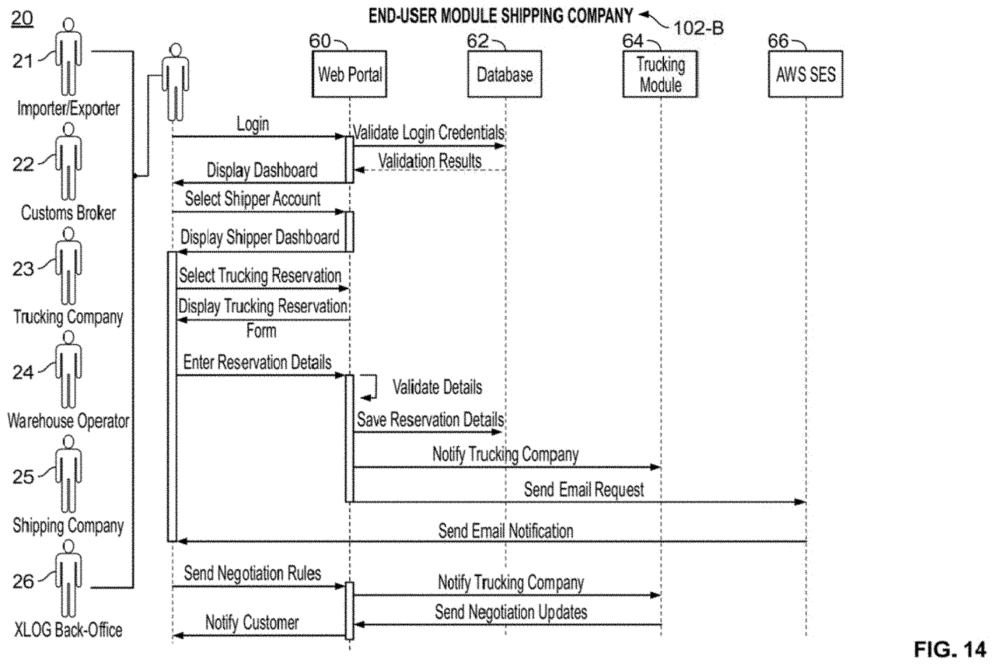

FIG. 14 shows an example of a sub-module 102-B within the end-user module 102 of FIGS. 1-3, interacting with a shipping company 25 in particular (or a representative thereof). This can be structured as a shipping company module 102-B within the end-user module 102. The shipping company module 102-B includes a web portal 60, a database 62, a trucking module 64, and an AWS SES 66. The shipping company module 102-B covers the unique online and procedural collaboration between the system of the present invention and the shipping company, after which the system handles the subsequent collaboration with the end-users 20. The shipping module 102-B may be implemented through the facility of Amazon Web Services (AWS) for third party applications, for example. The Application Program Interface (API) setup under AWS allows for a highly efficient and secure method for online/real-time integration with various systems outside of the system of the present invention. A user of the system does not have to worry about how the system integrates with various systems that are not originally a part thereof. The API component handles this integration requirement. AWS SES 66 is the email management system of the XLOG system 100, which allows the automated sending of emails to concerned parties in the system 100.

As shown in FIG. 14 the web portal 60 handles a login attempt by the shipping company 25. Login credentials are validated and stored in the database 62. Upon validation a dashboard is displayed to the shipping company 25 by the web portal 60. From the dashboard the shipping company 25 can select a shipper account and to carry out a shipping or trucking reservation, after which a shipping or trucking reservation form is shown on the dashboard in which the shipping company 25 can enter the reservation details. Once the details are validated the reservation details are saved in the database 62, and the shipping or trucking company is notified by the trucking module 64. The web portal 60 can receive negotiation rates sent by the shipping company 25 and notify the shipping or trucking company module 64 which can in return send negotiation updates which the web portal 60 notifies the customer of.

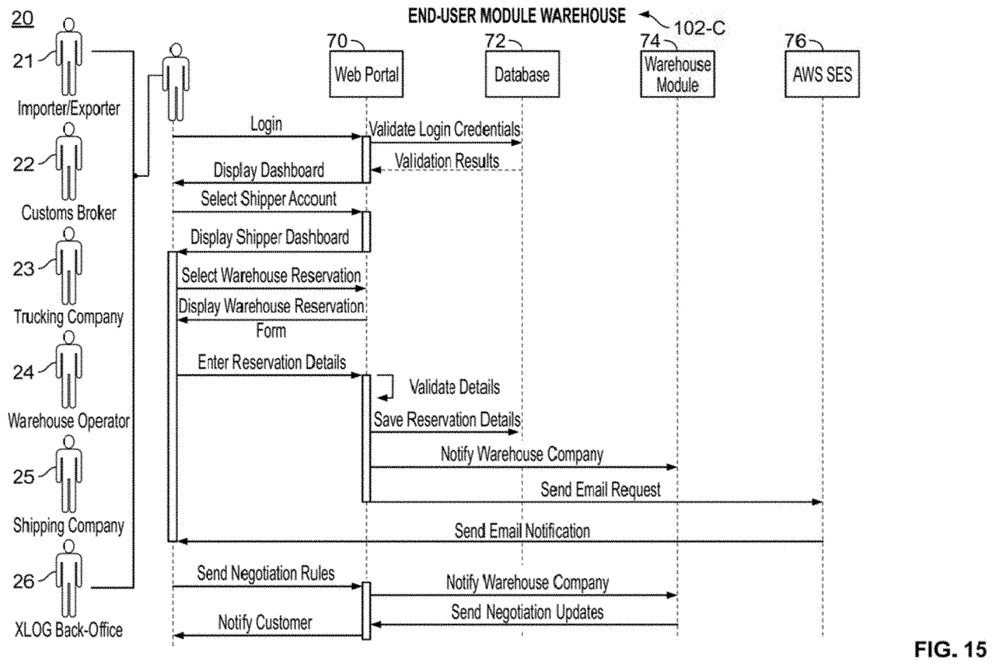

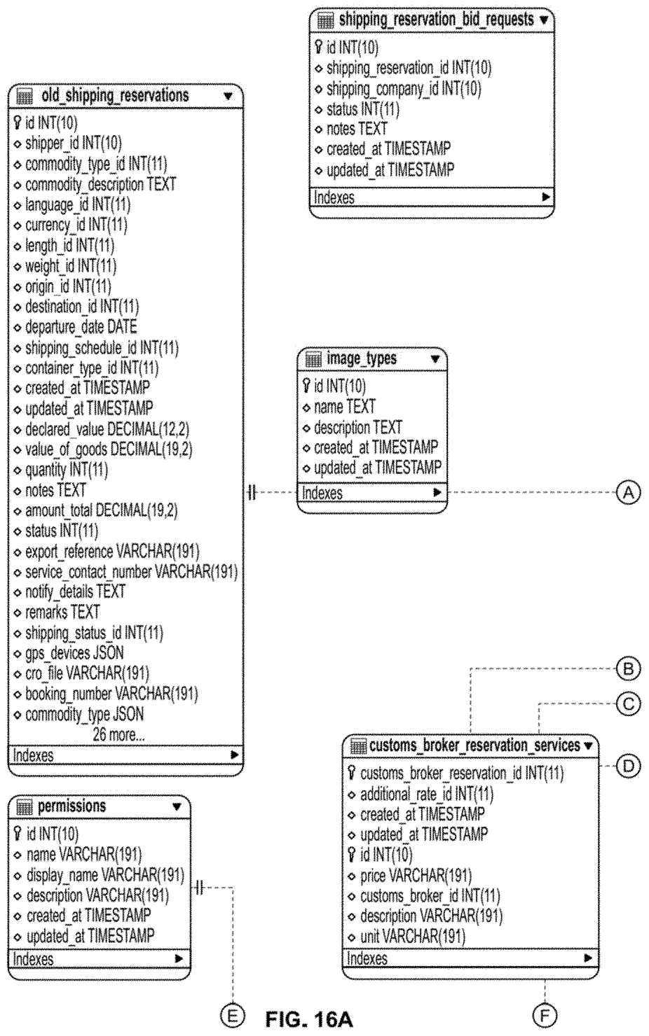

FIG. 15 shows an example of a sub-module 102-C within the end-user module 102 of FIGS. 1-3, interacting with a warehouse operator 24 in particular. This can be structured as a warehouse operator module 102-C within the end-user module 102. The warehouse operator module 102-C can interact with the user through a web portal 70 and communicate with a database 72, a warehouse module 74, and an AWS SES 76. The warehouse operator module 102-C handles the storage of shipments at the origin and destination sides when and if needed. The warehouse operator module 102-C enables online reservation and online payments for every stakeholder's ease of transaction with the system of the present invention. The warehouse operator module 102-C may be implemented through the facility of Amazon Web Services (AWS) for third party applications, for example. The Application Program Interface (API) setup under AWS allows for a highly efficient and secure method for online/real-time integration with various systems outside of the system of the present invention. A user of the system 100 does not have to worry about how the system 100 integrates with various systems that are not originally a part thereof. The API component handles this integration requirement. The AWS SES 76 is the email management system of the XLOG system 100; it is part of Amazon Web Services (AMS).

As shown in FIG. 15 the web portal 70 handles a login attempt by the warehouse operator 24. Login credentials are validated and stored in the database 72. Upon validation a dashboard is displayed to the warehouse operator 24 by the web portal 70. From the dashboard the warehouse operator 24 can select a shipper account and to carry out a warehouse reservation, after which a warehouse reservation form is shown on the dashboard in which the warehouse operator 24 can enter the reservation details. Once the details are validated the reservation details are saved in the database 72, and the warehouse company is notified by the warehouse module 64. The web portal 70 can receive negotiation rates sent by the warehouse operator 24 and notify the warehouse module 74 which can in return send negotiation updates which the web portal 70 notifies the customer of.

It is noted that specific modules for importer/exporter 21, trucking company 23, back-office 26, and others are not described herein but these would be similar in many relevant respects to those described above in connection with sub-modules 102-A, 102-B, and 102-C of FIGS. 13, 14, and 15, respectively. Thus, it is of course to be understood that while FIGS. 13, 14, and 15 provide examples of sub-modules 102-A, 102-B, and 102-C, respectively, for customs broker 22, shipping company 25, and warehouse operator 24, the present invention is not limited to these examples and of course other examples of other participants in other industries and for other applications are readily envisioned.

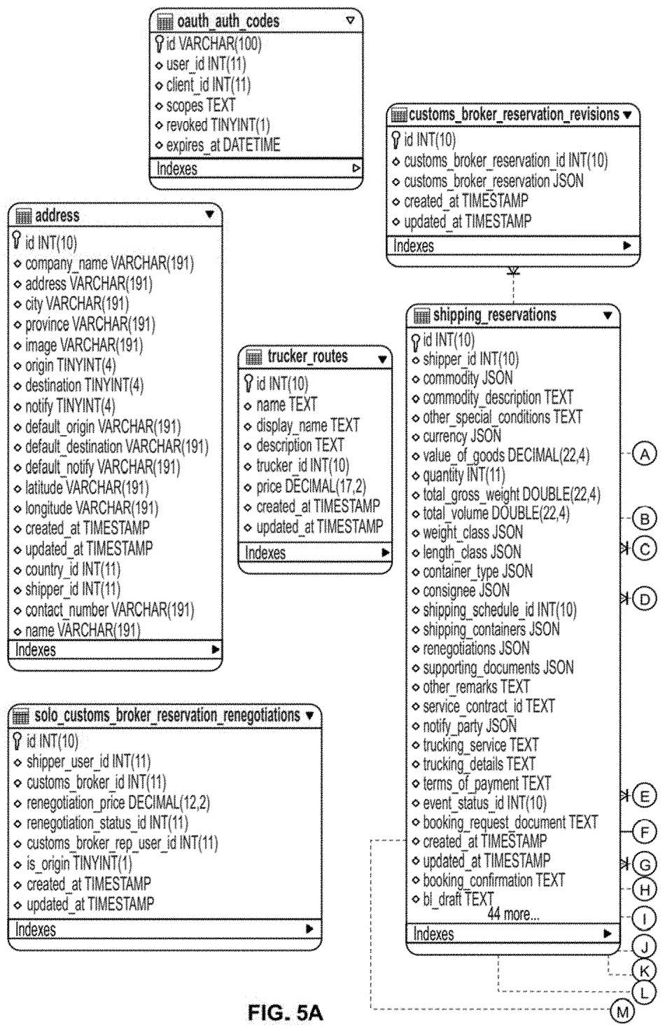

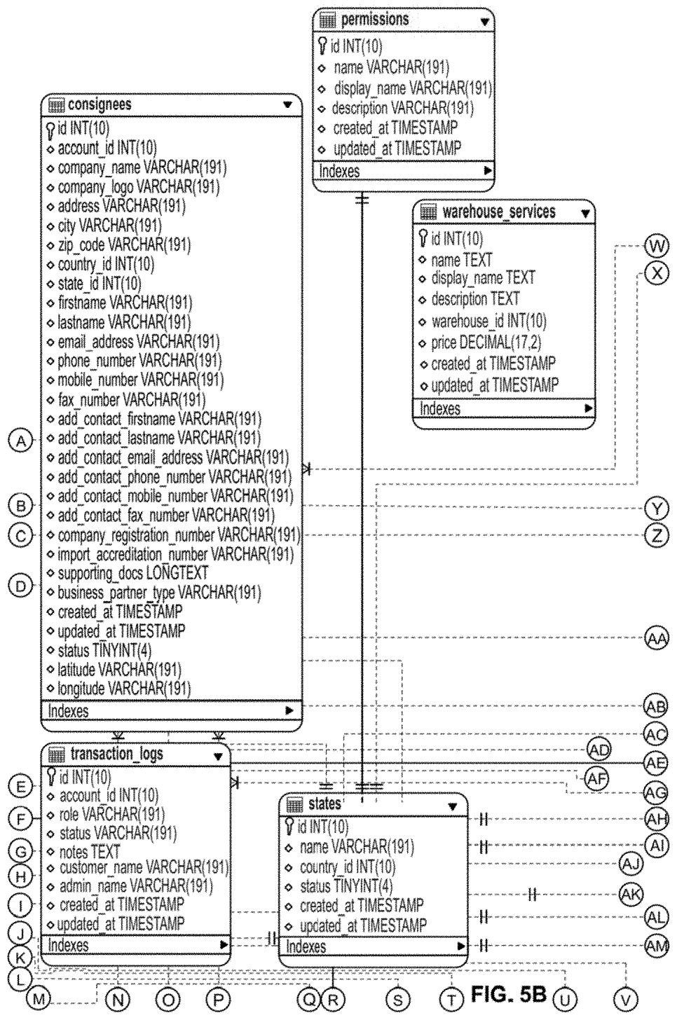

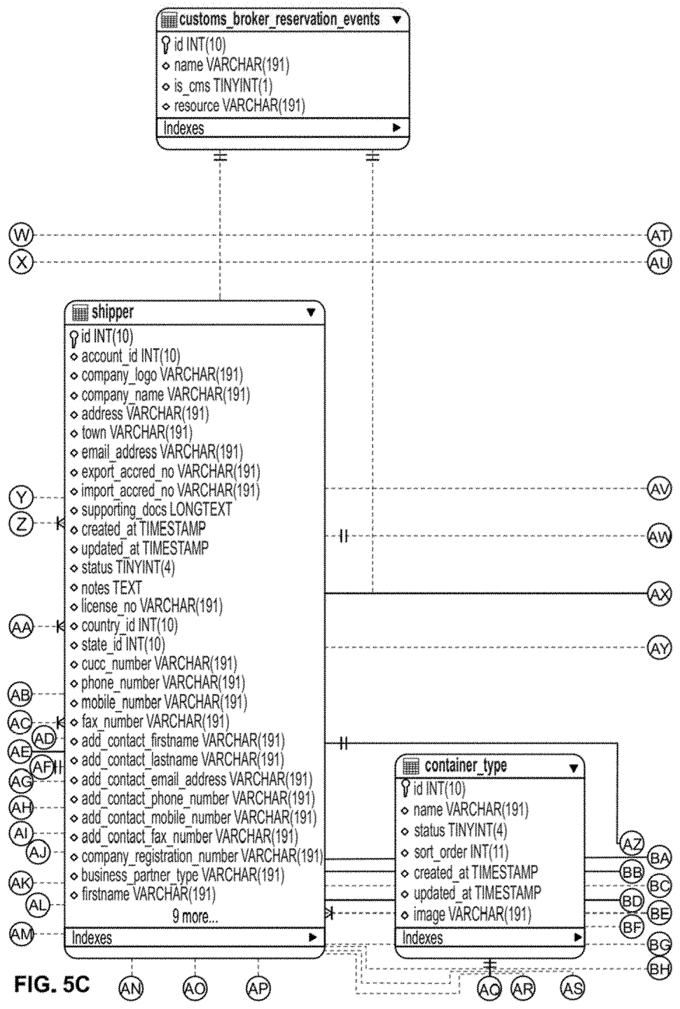

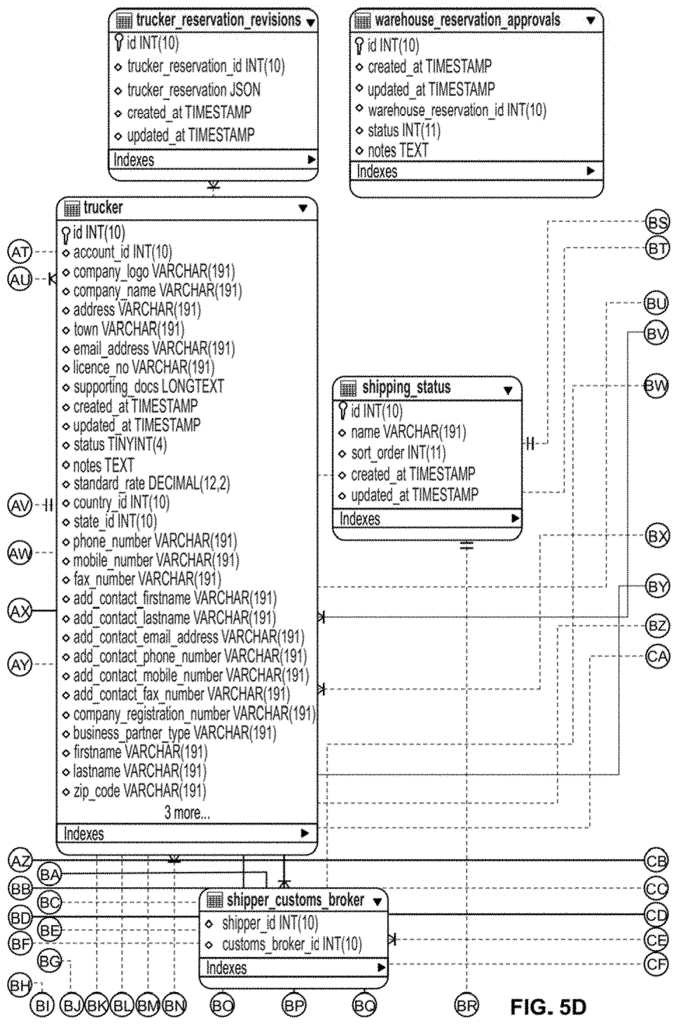

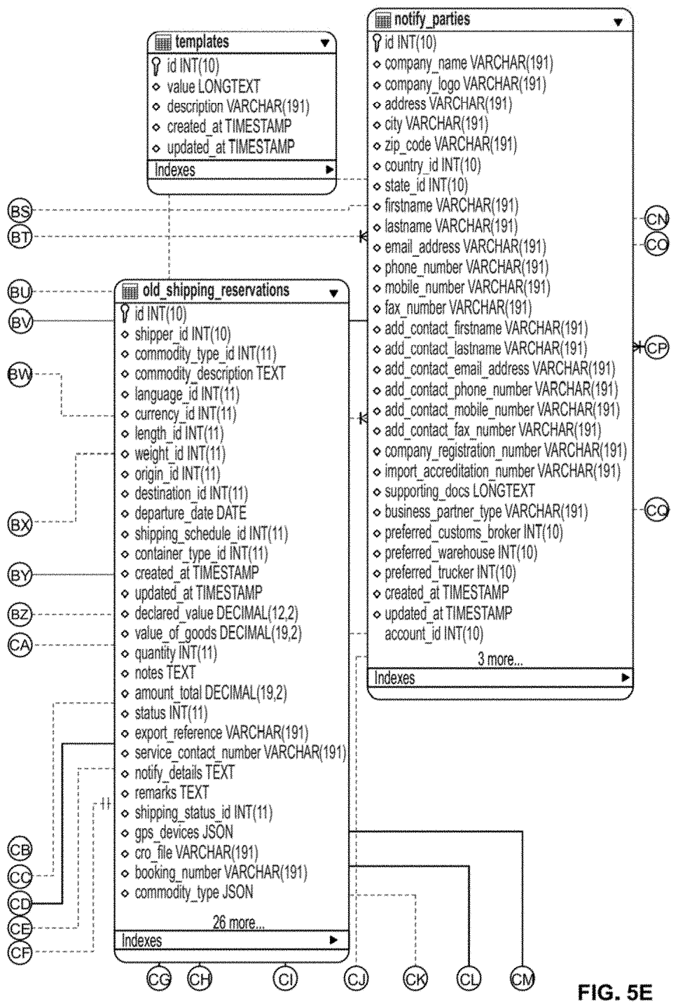

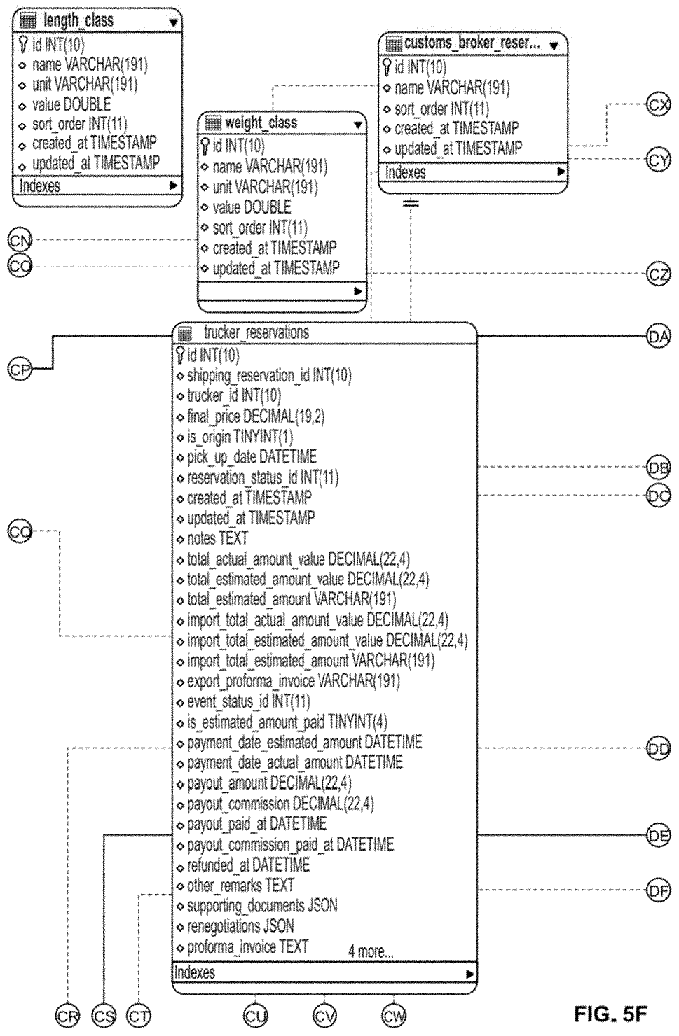

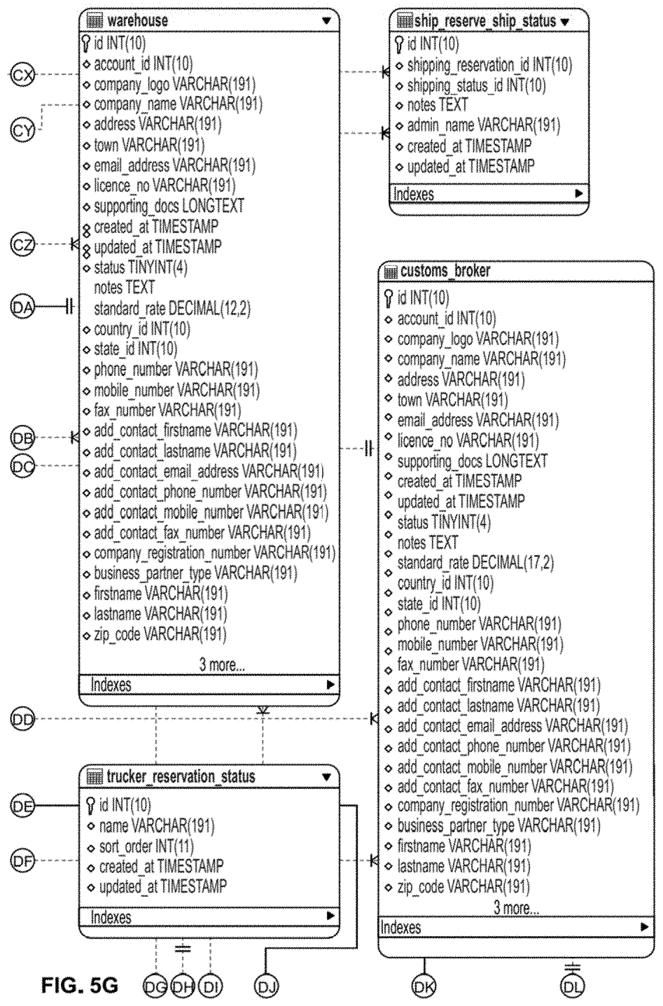

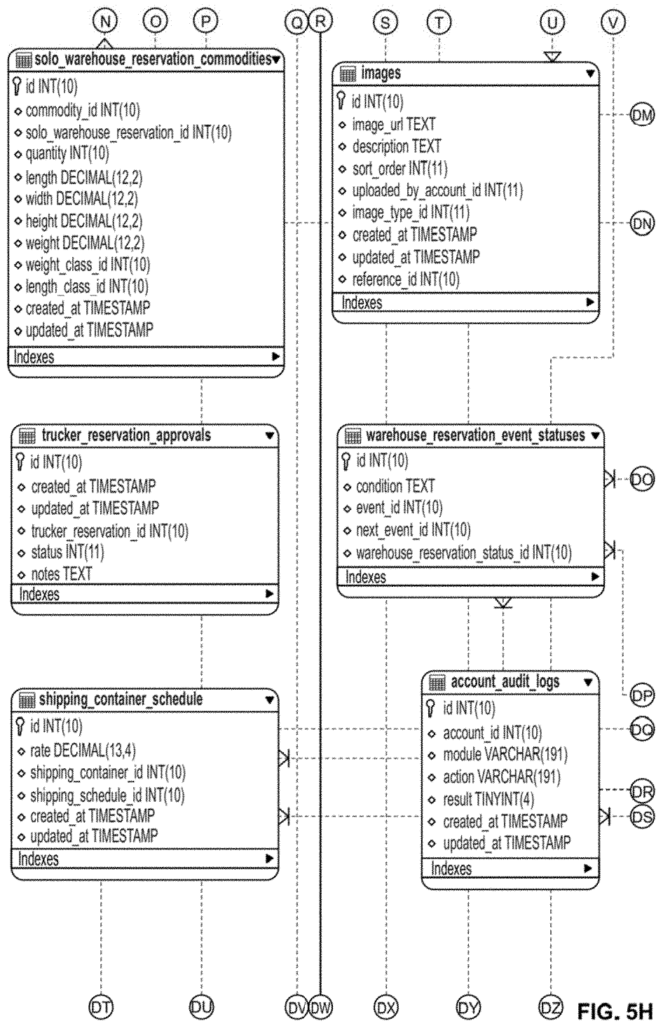

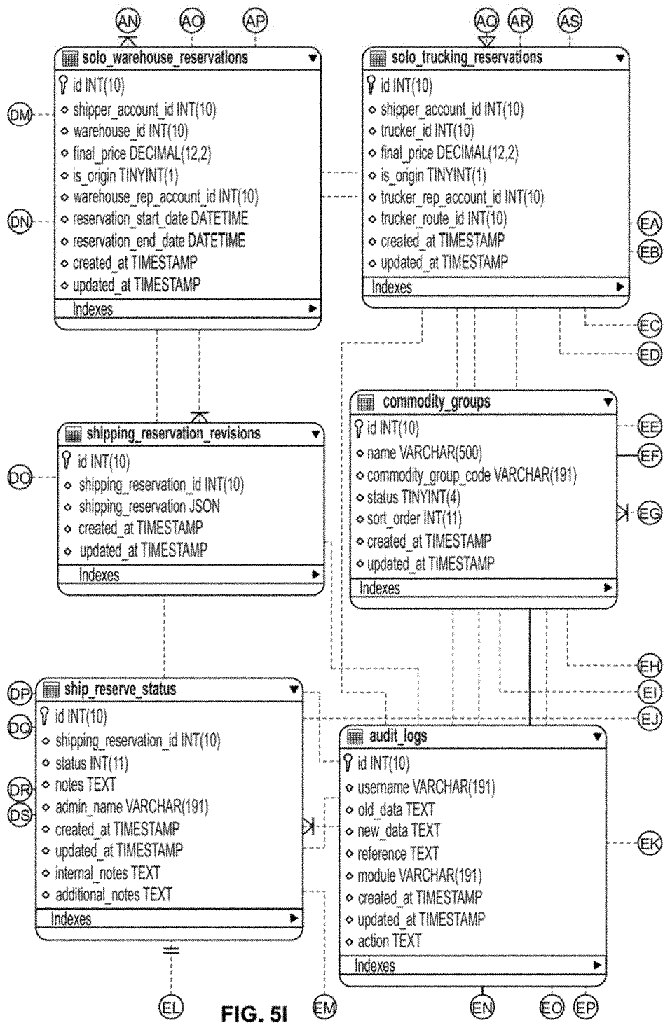

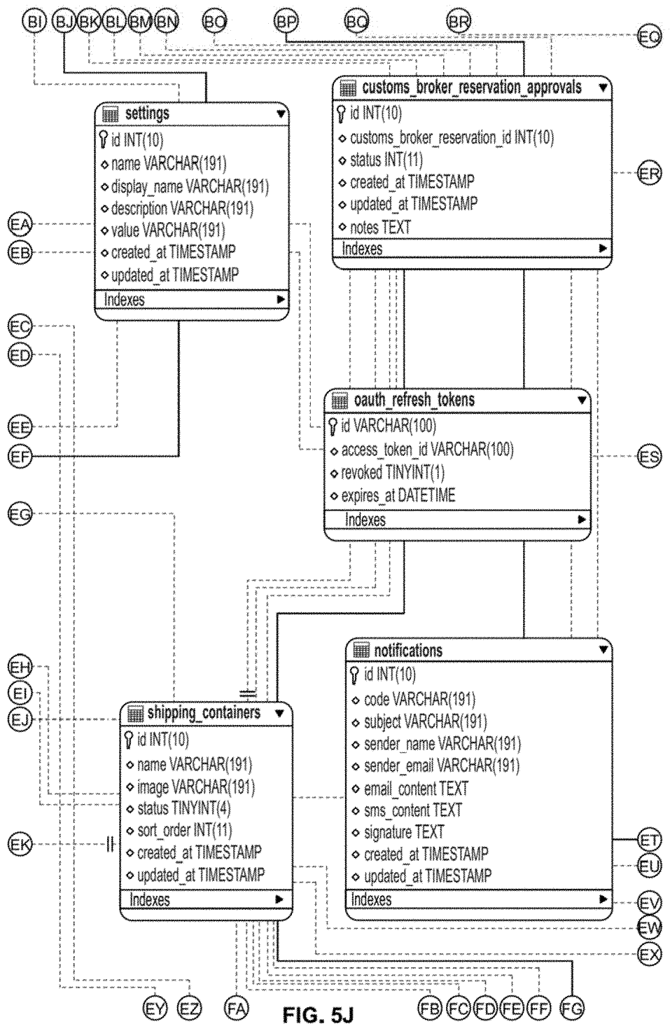

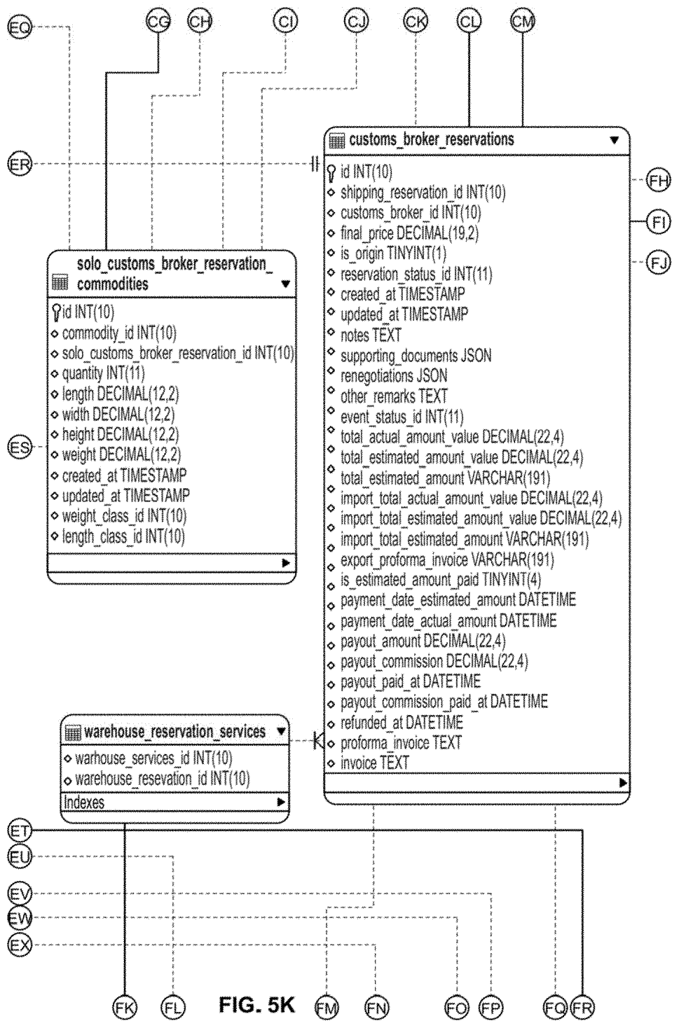

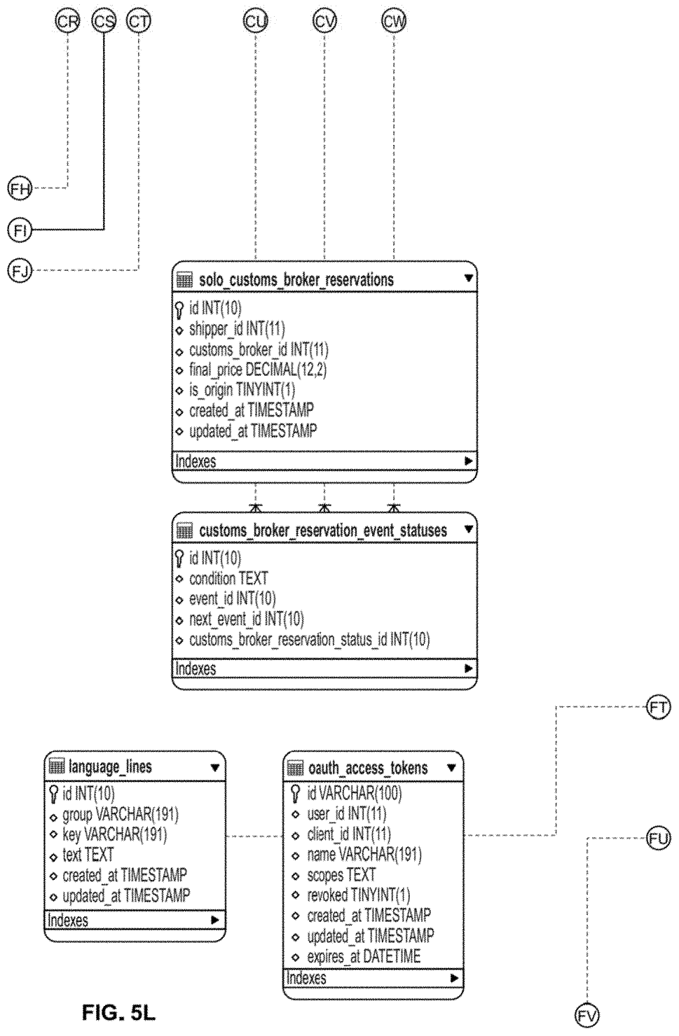

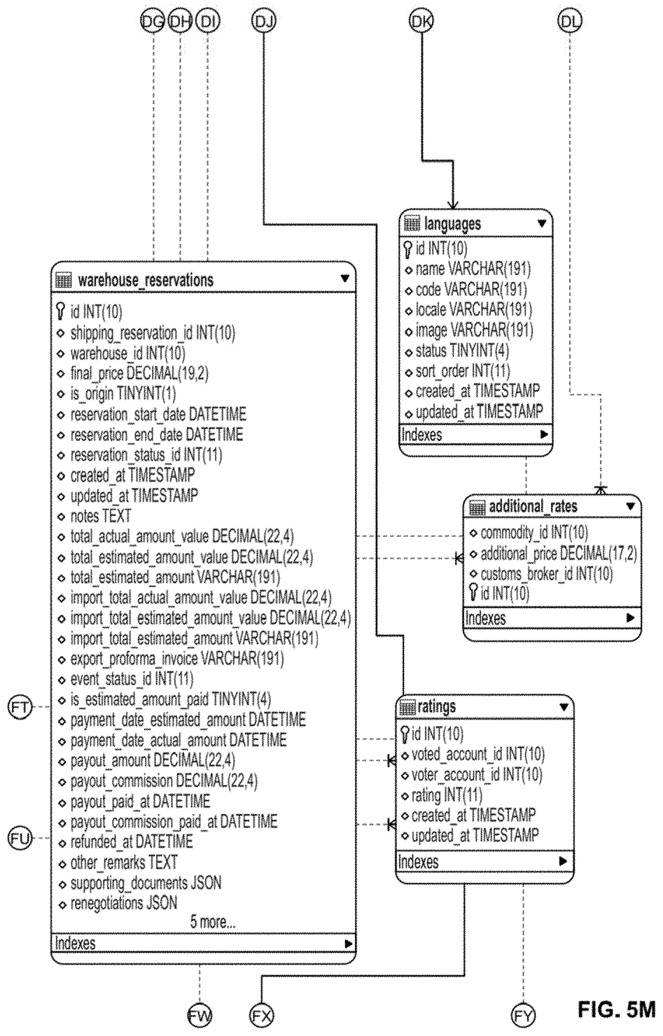

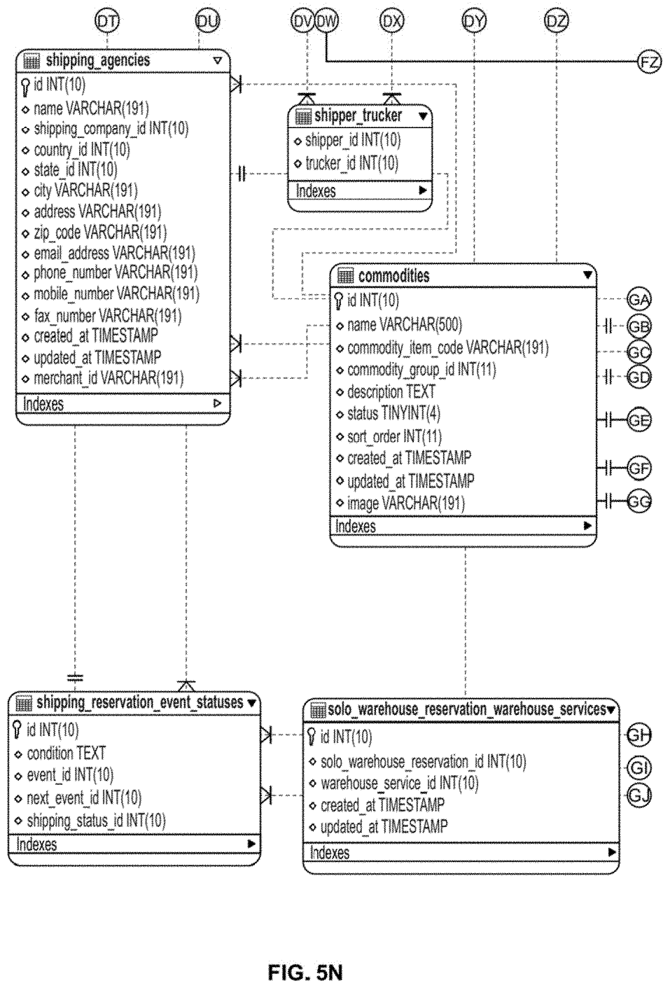

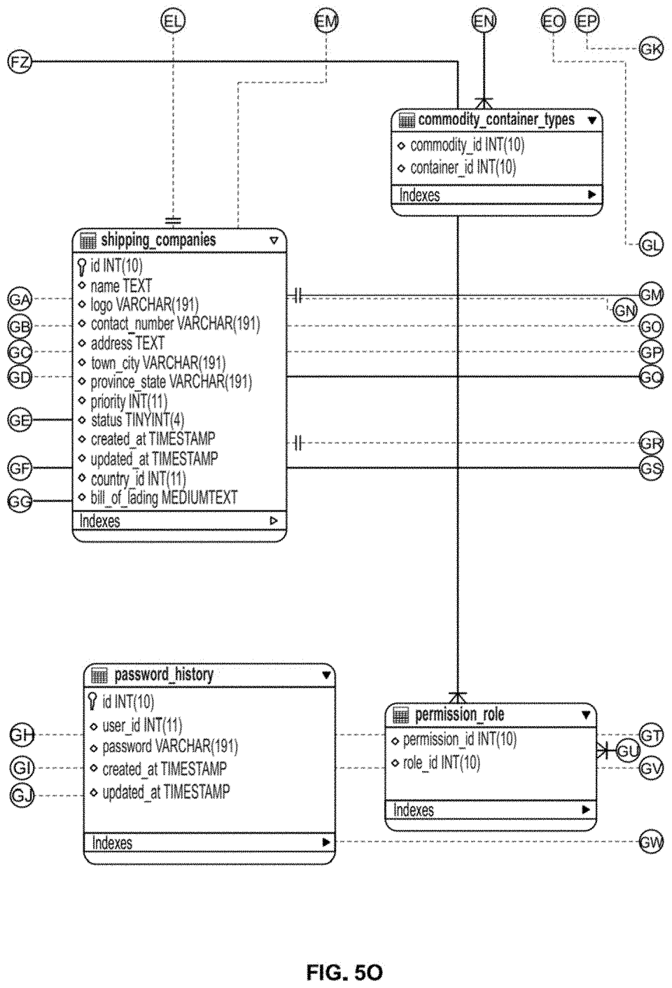

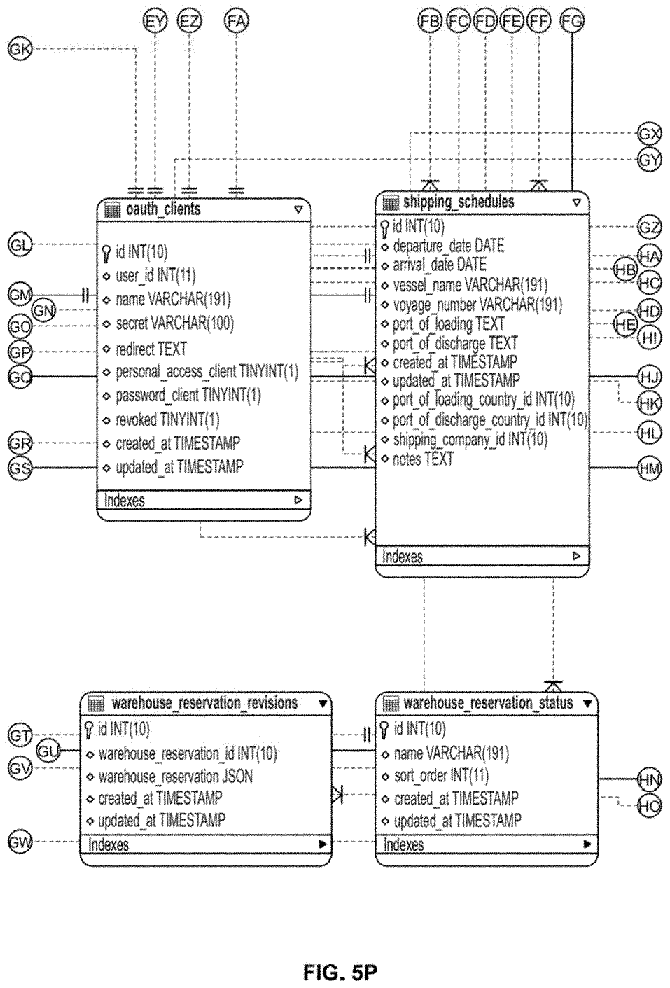

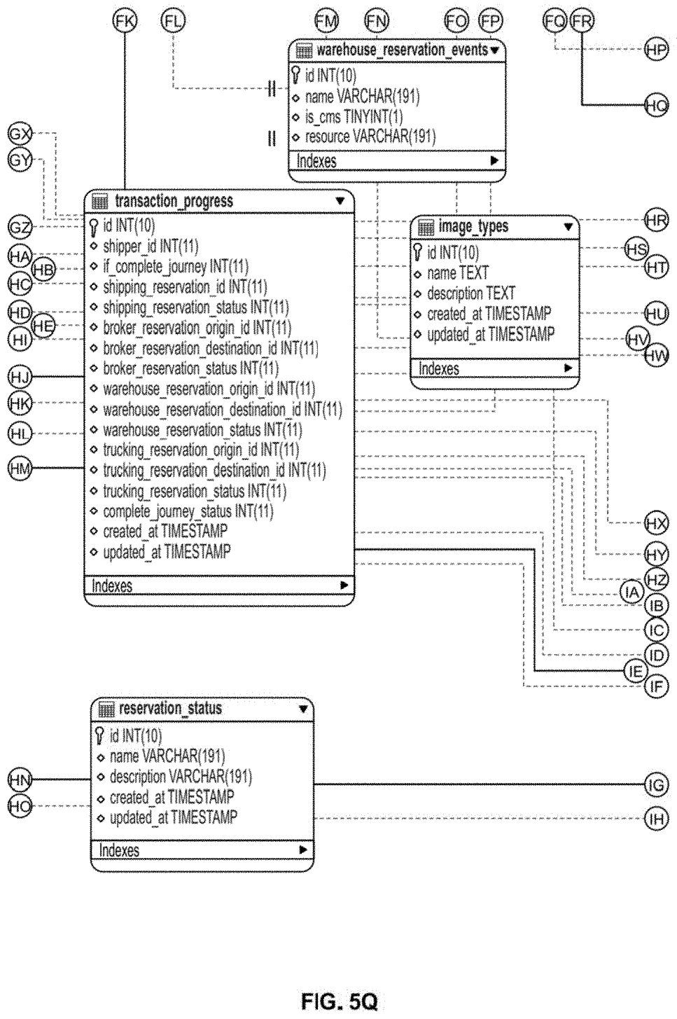

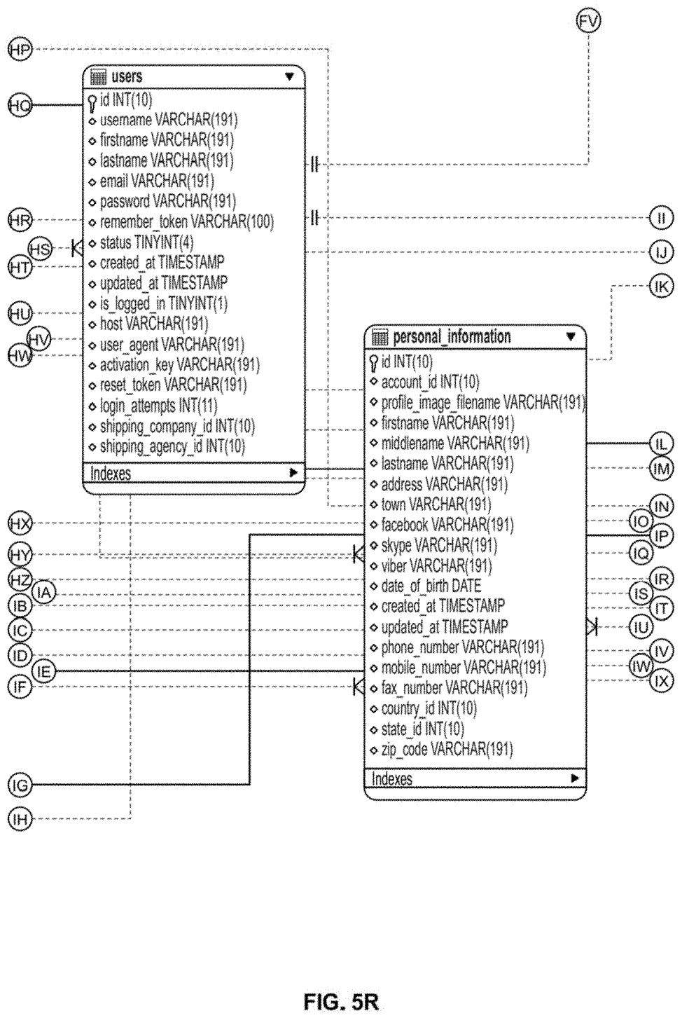

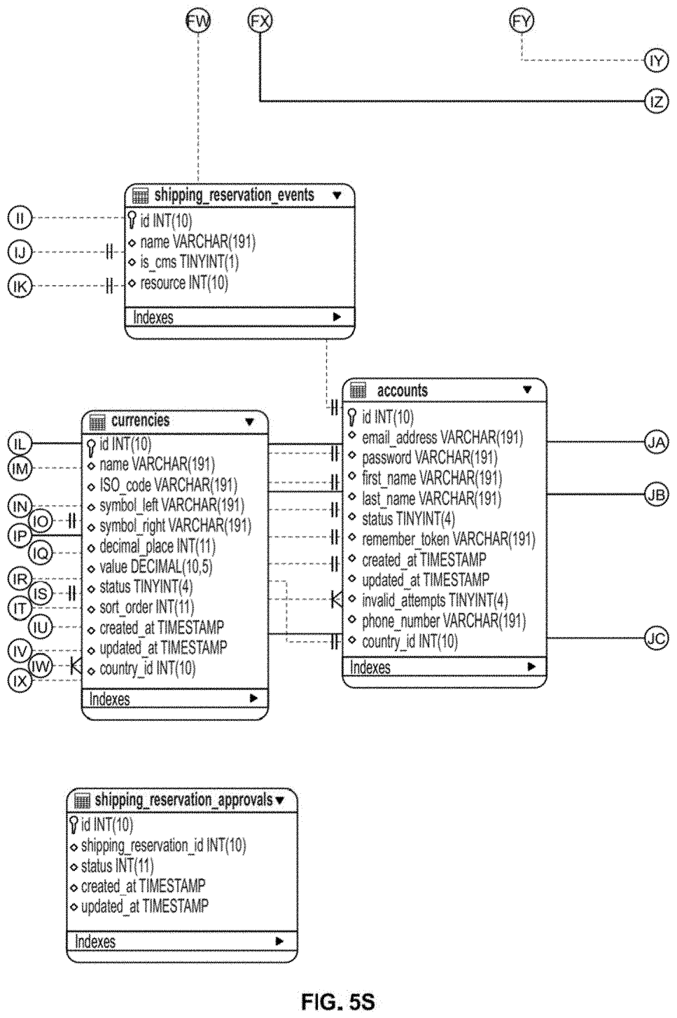

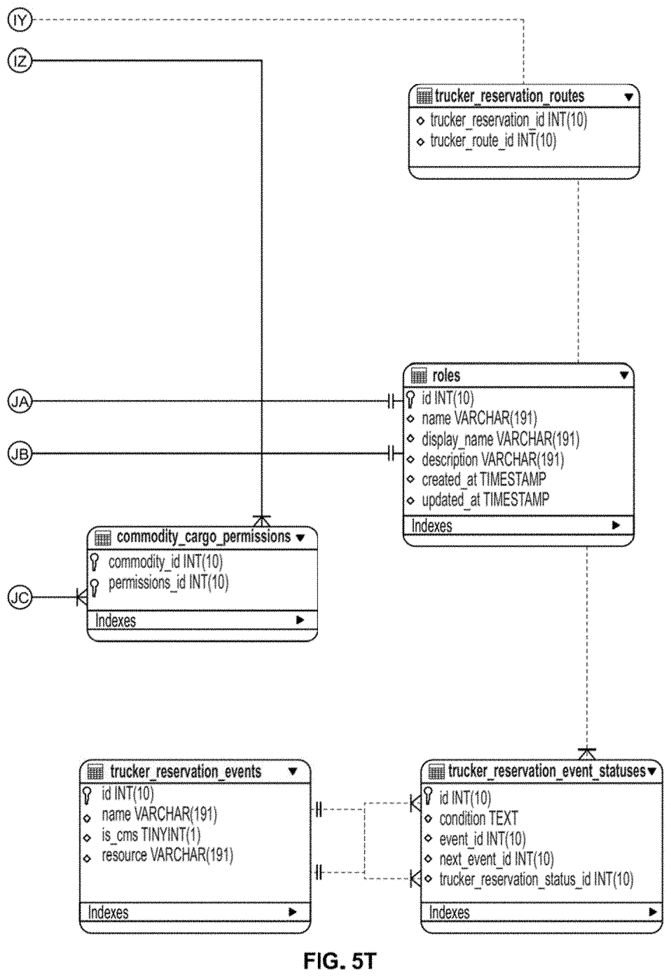

FIG. 5 shows the database design in an Entity Relationship Diagram (ERD), according to the present invention. FIG. 5 shows the overall ERD on a single sheet and FIGS. 5A-D show the identical ERD on separate sheets.

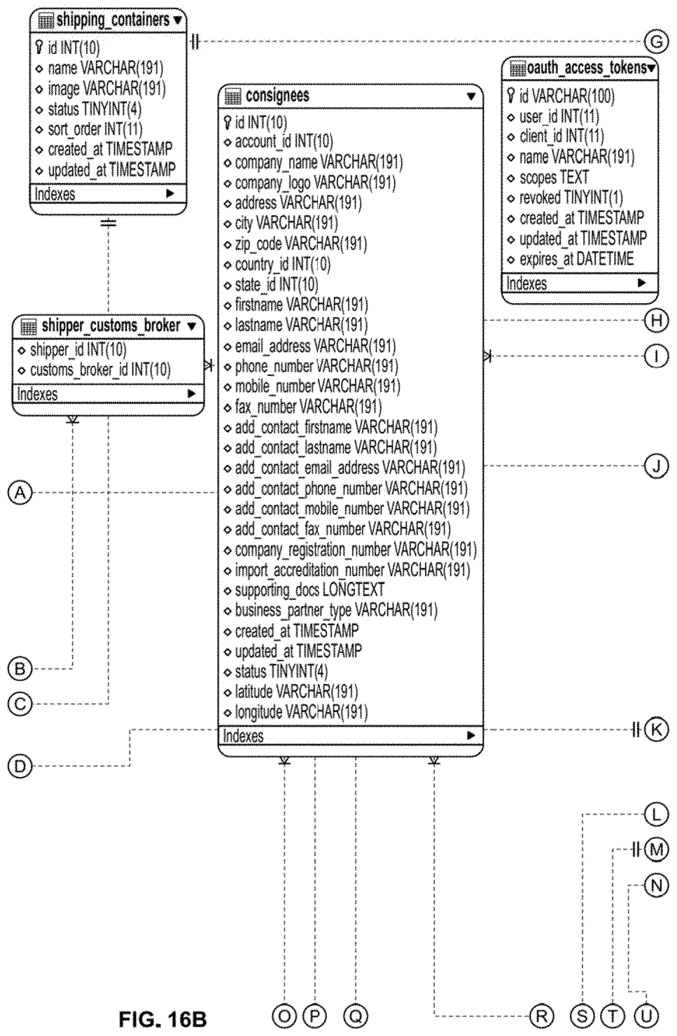

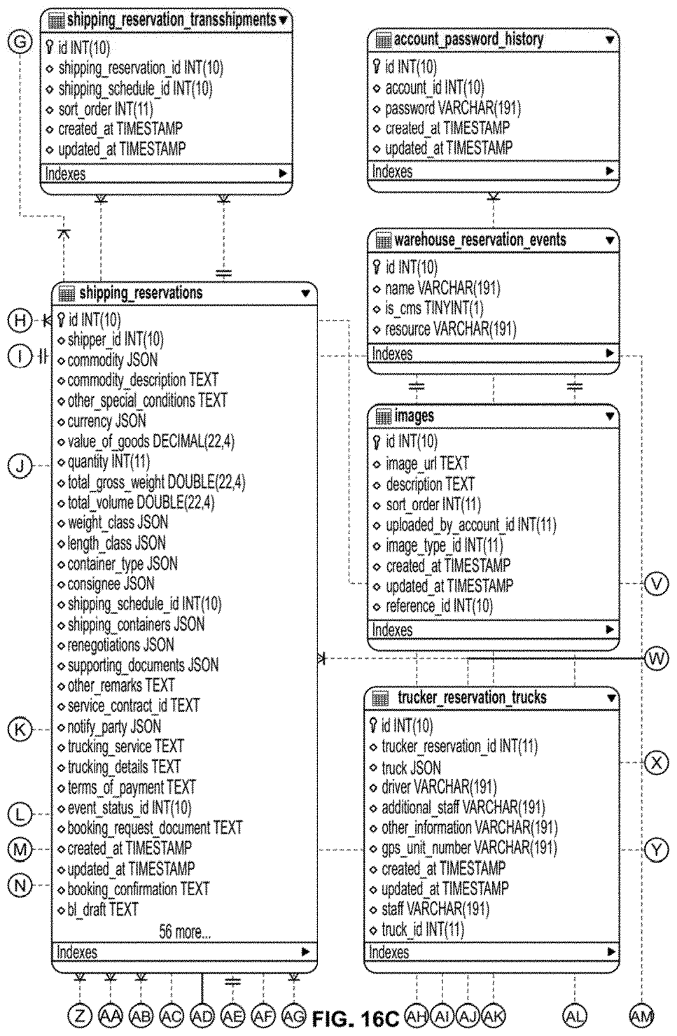

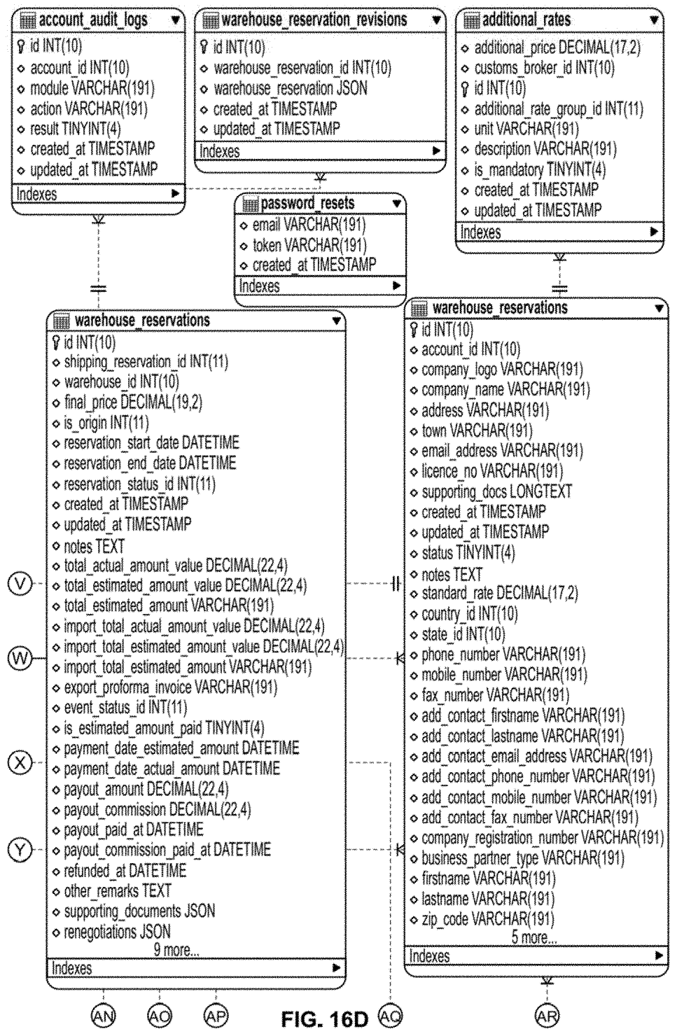

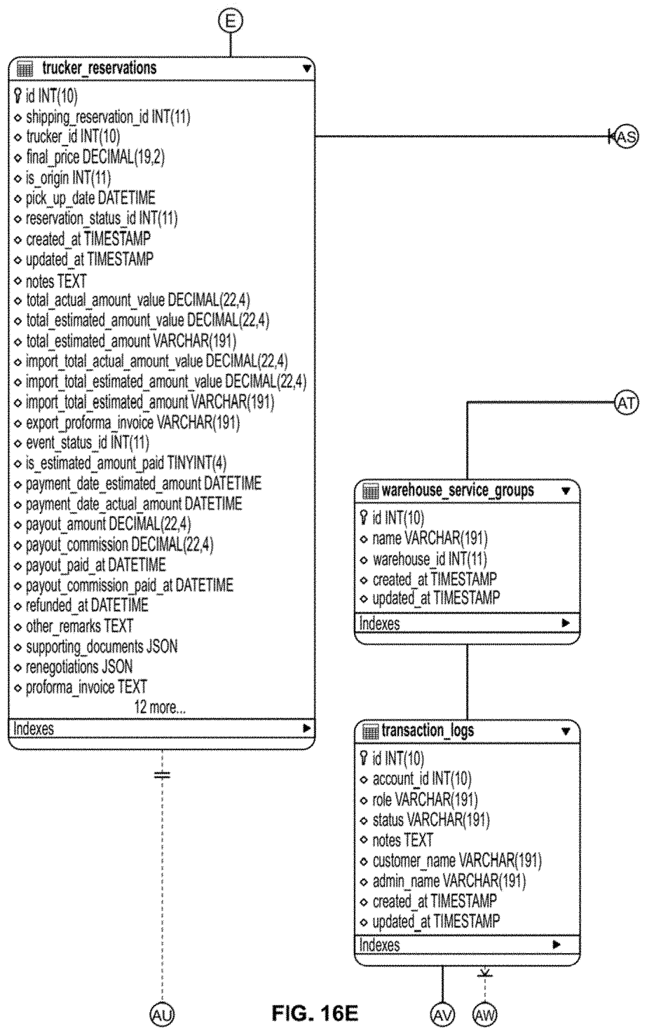

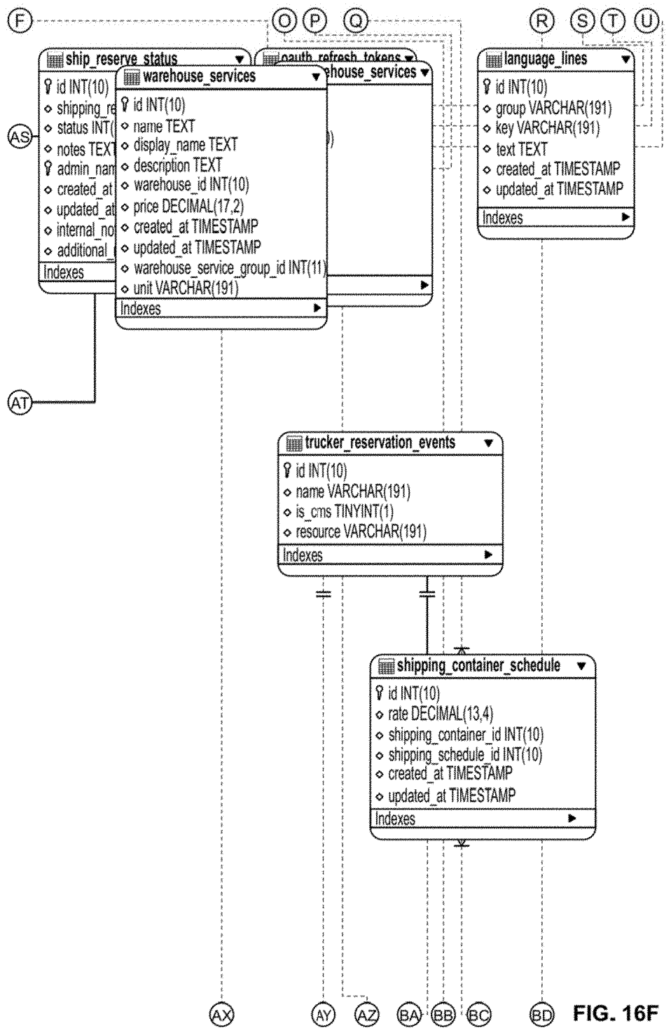

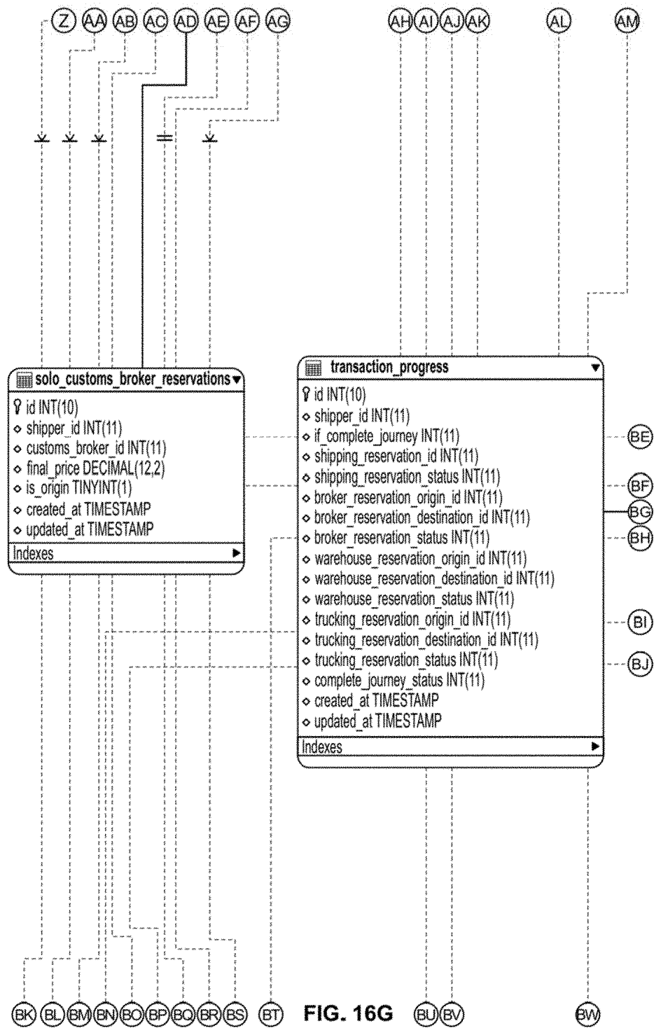

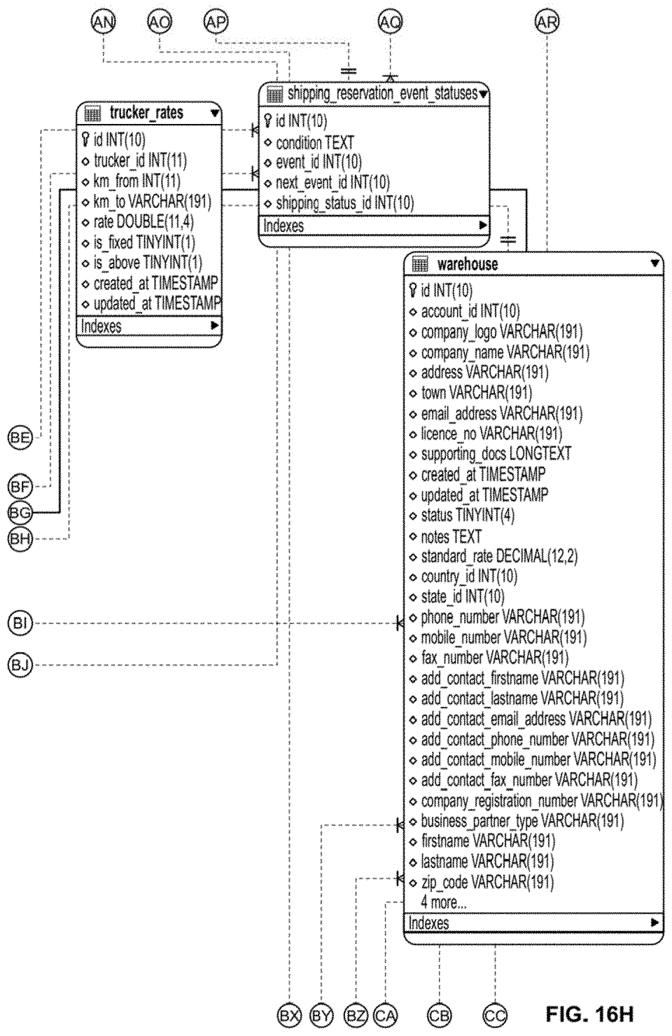

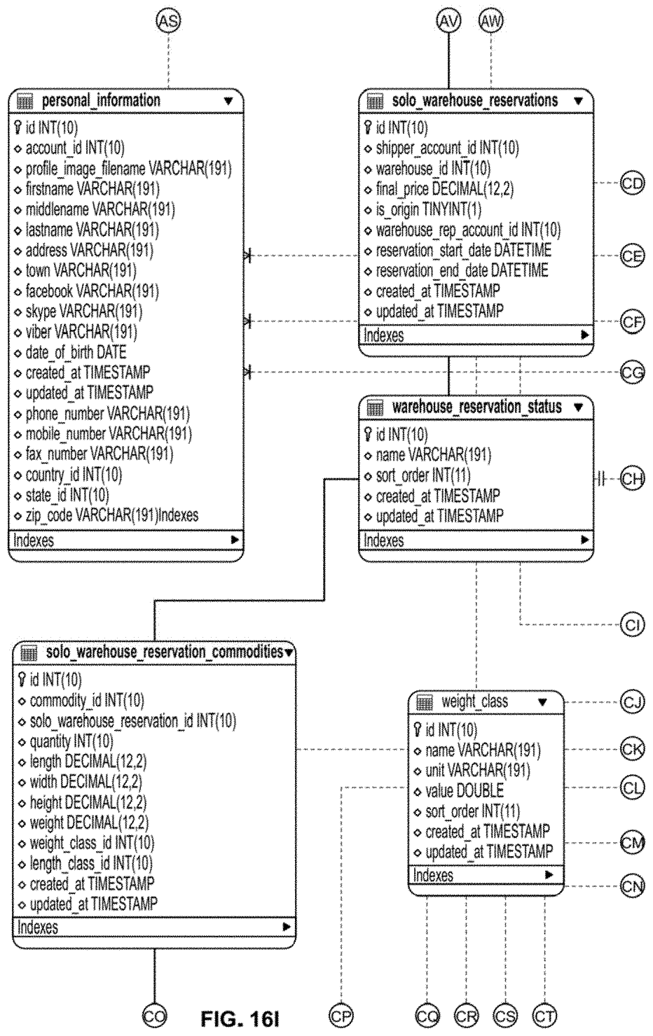

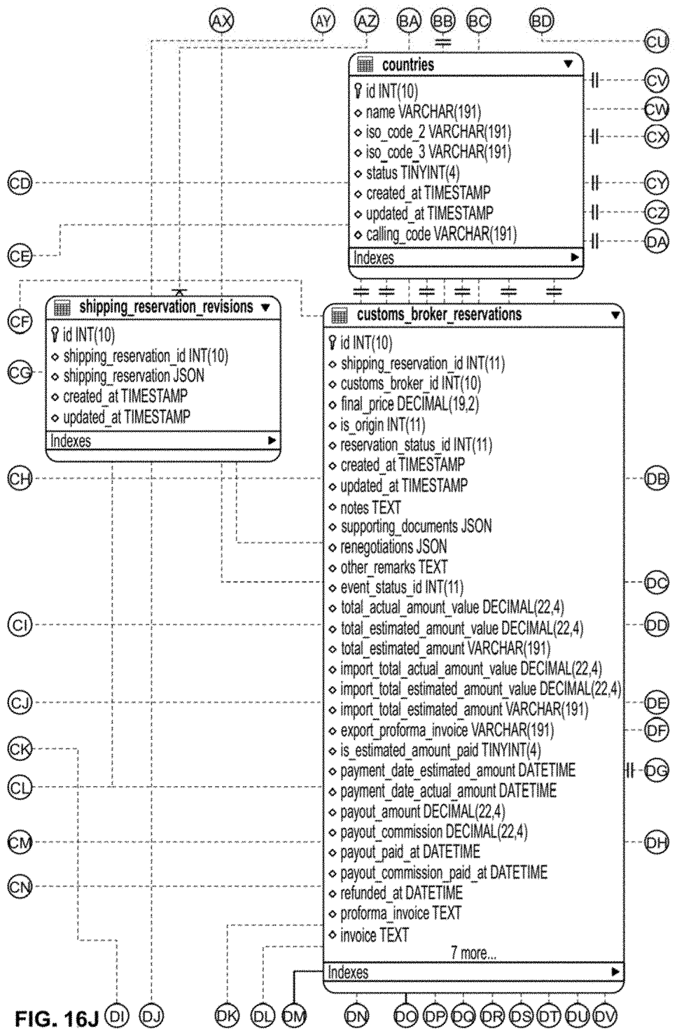

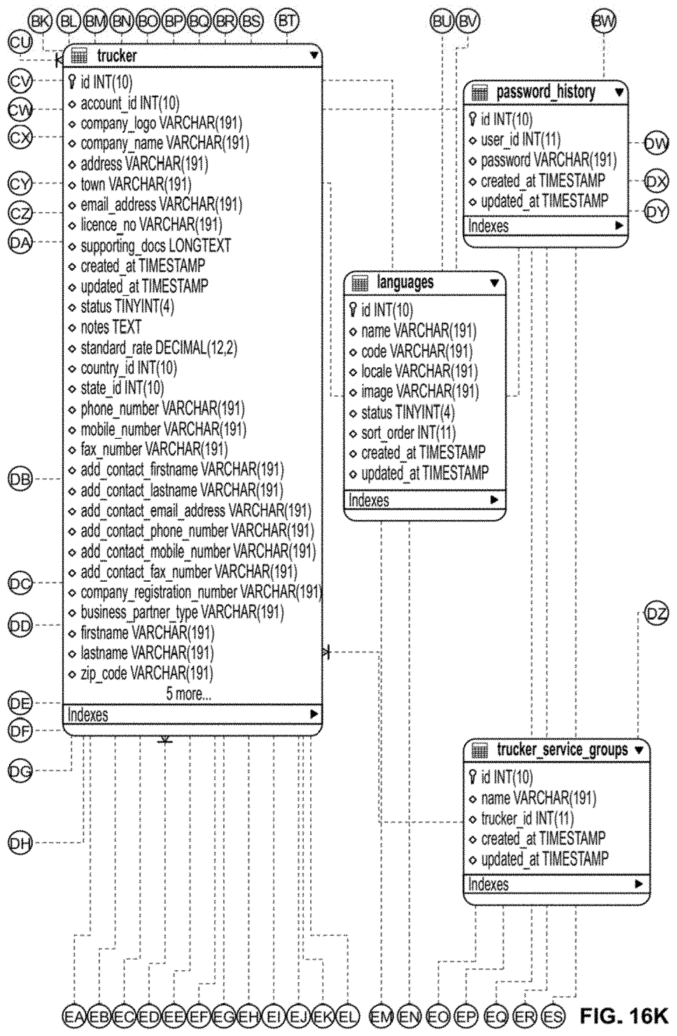

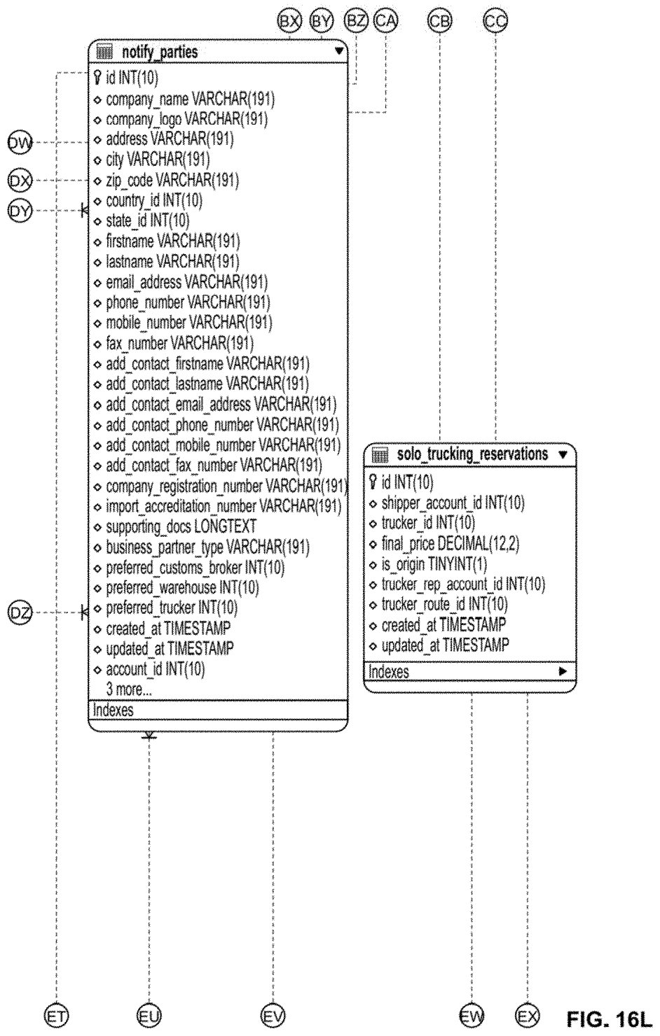

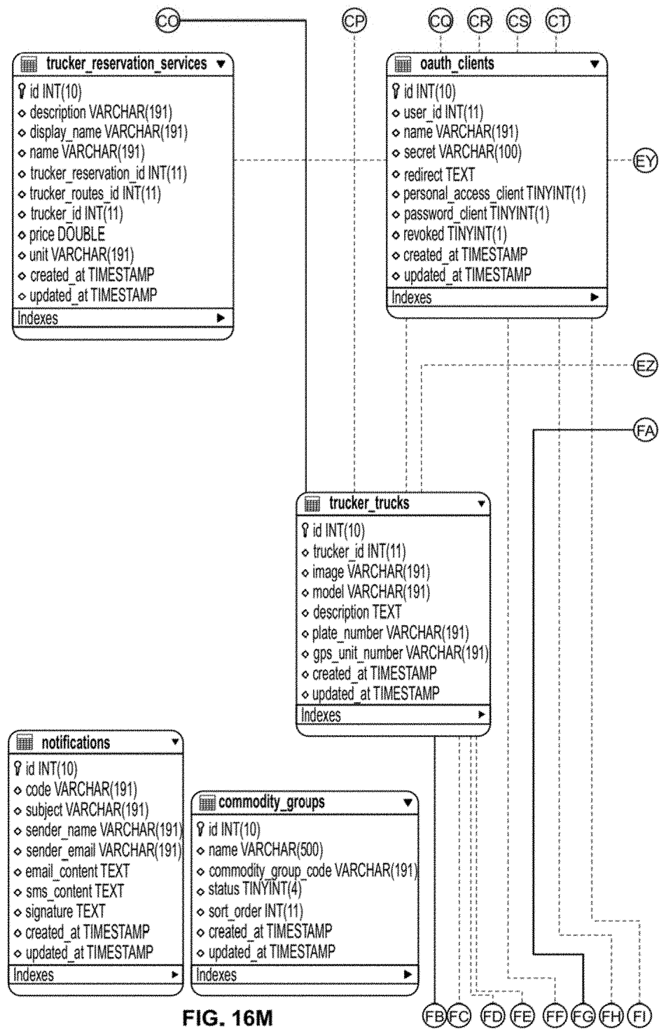

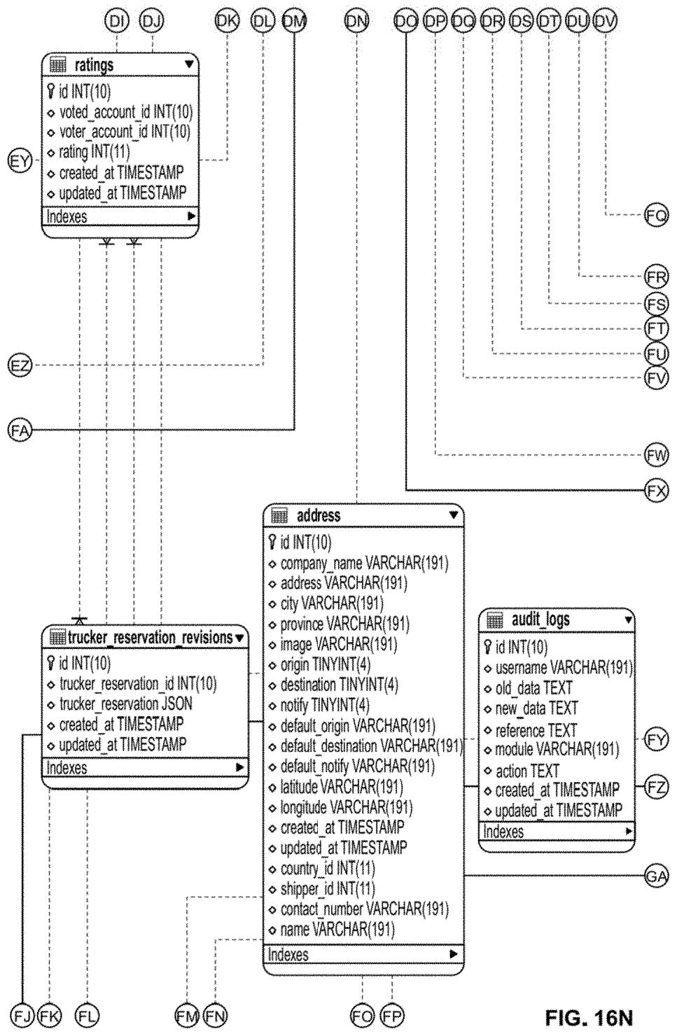

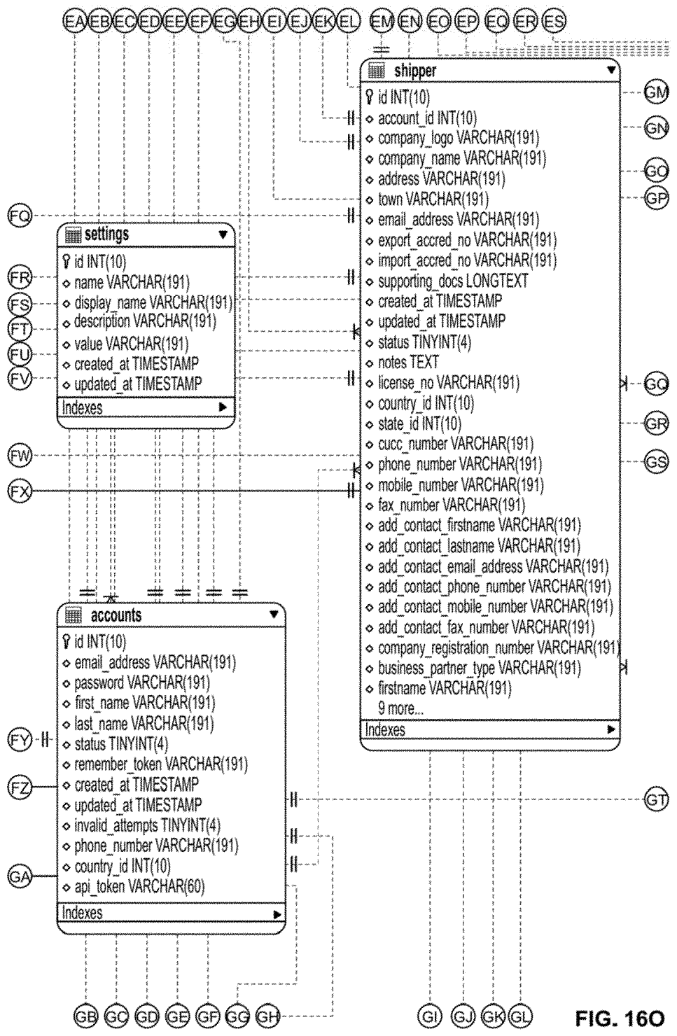

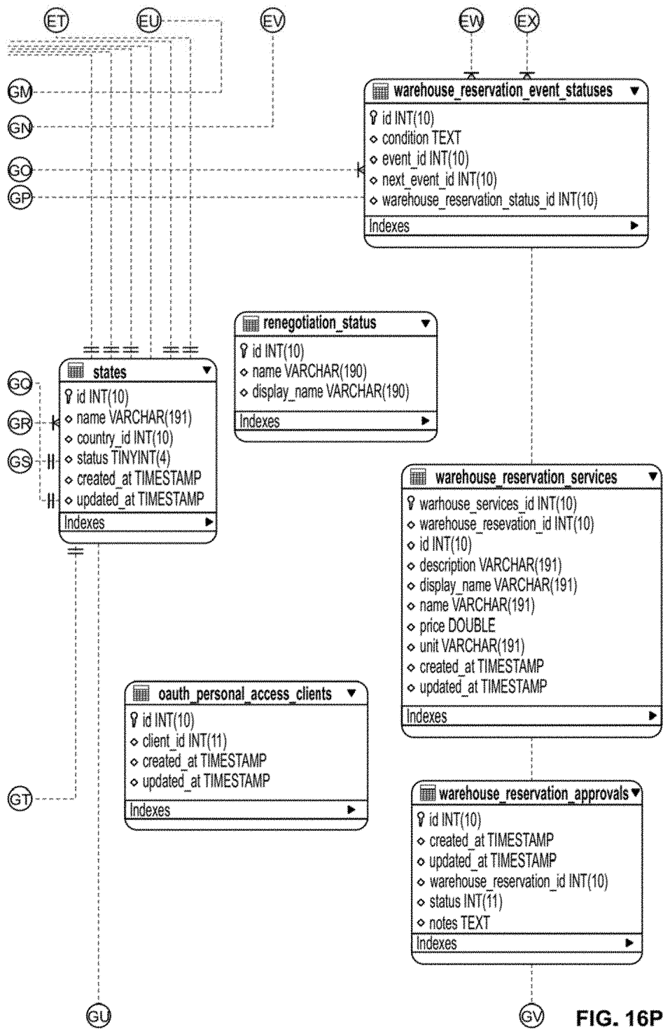

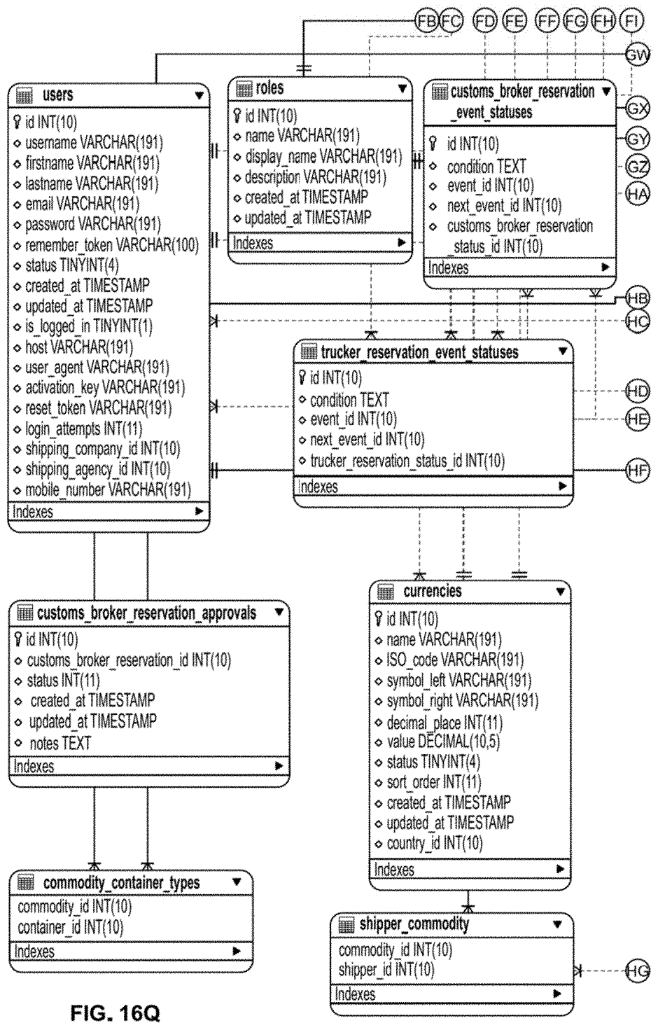

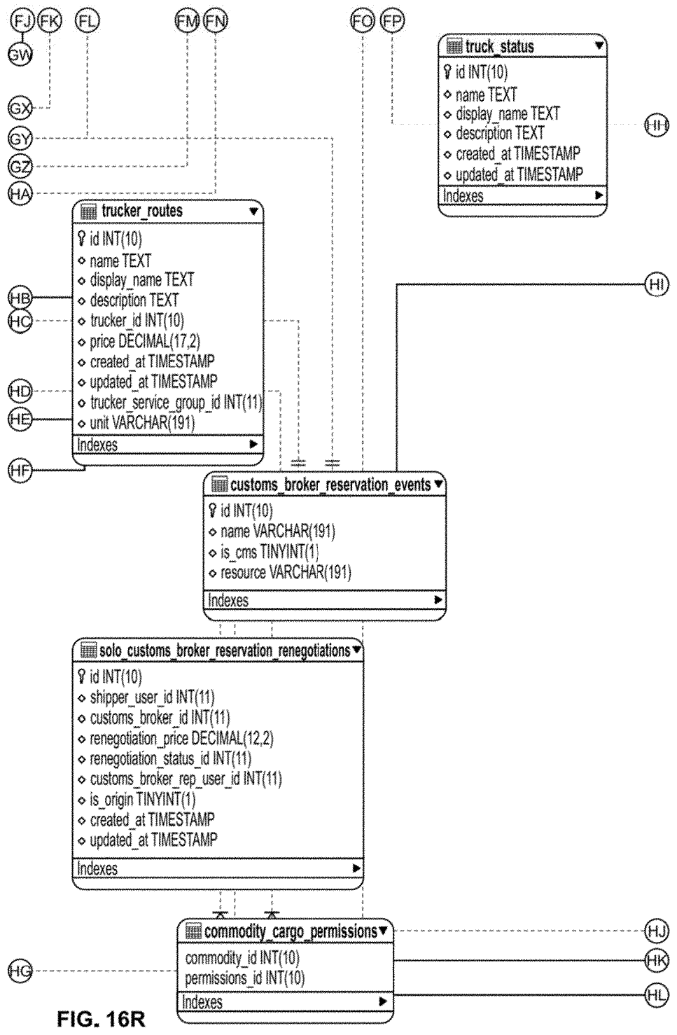

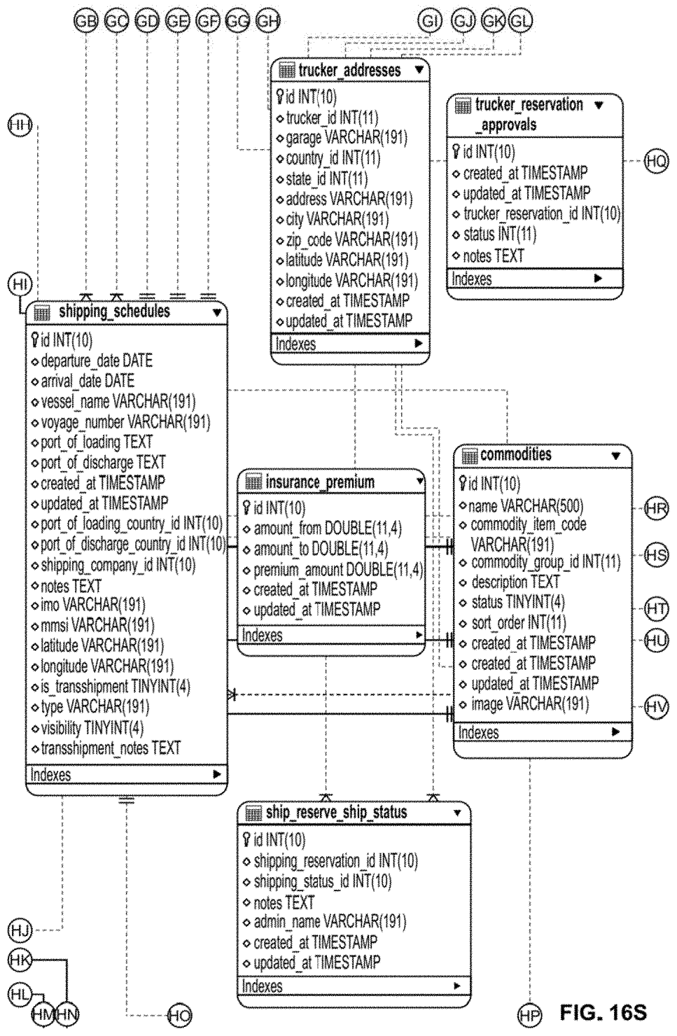

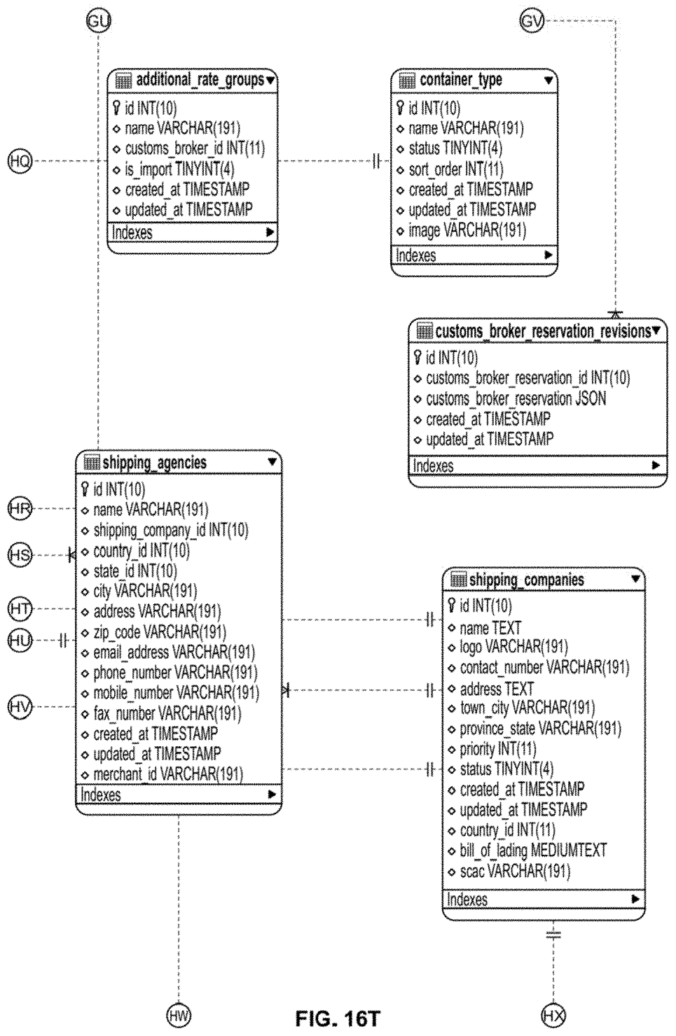

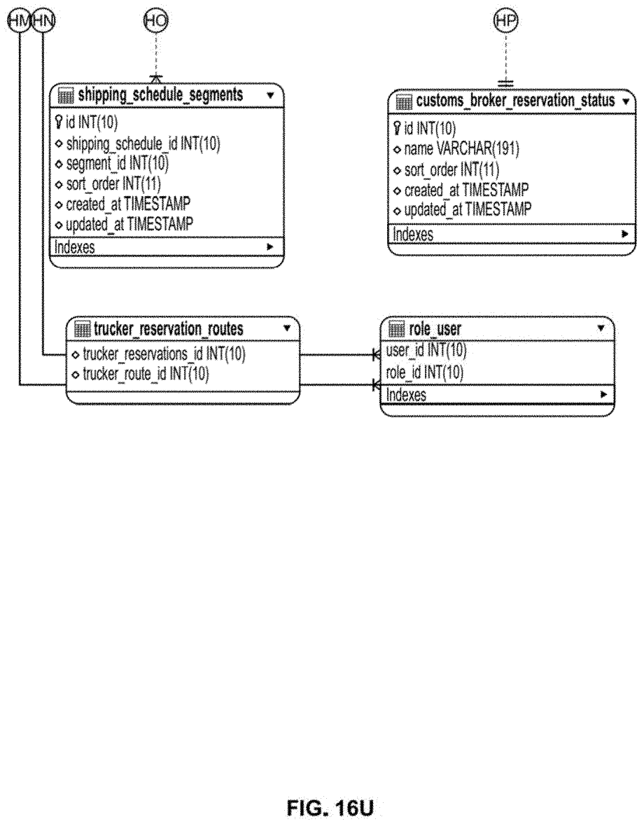

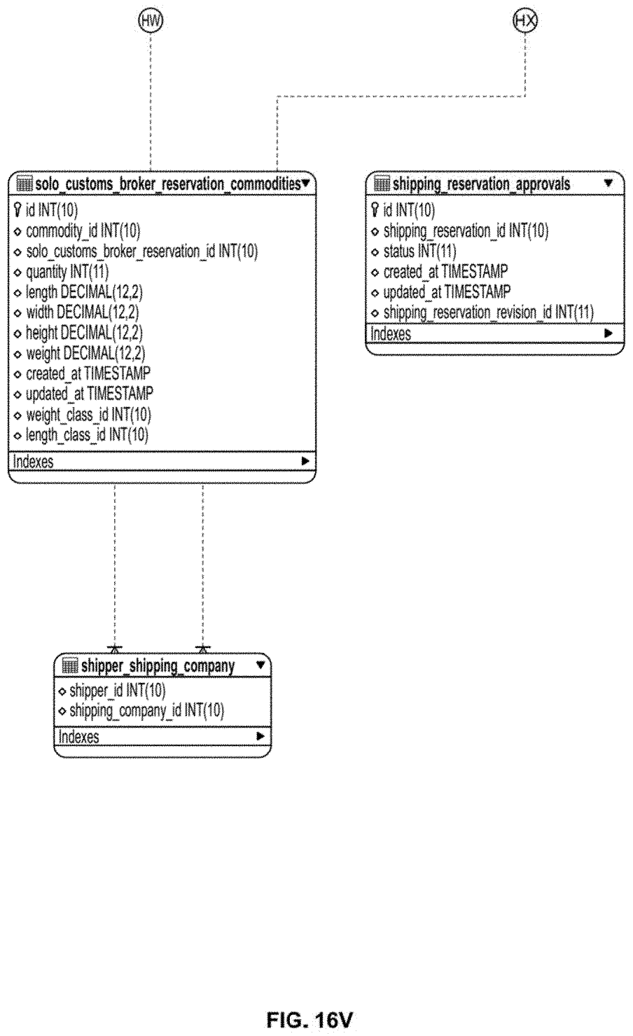

FIG. 16 shows the database design in an Entity Relationship Diagram (ERD), according to another example embodiment of the present invention. FIG. 16 shows the overall ERD on a single sheet and FIGS. 16A-O show the identical ERD on separate sheets.

The Entity Relationship Diagram illustrates the structure of how the data is stored inside the system 100 of the present invention. The importance of the Entity Relationship Diagram is that the information and data stored inside the computer is organized and stored in an easily retrievable manner. By virtue of this entity relationship, information, or data is also not easily corrupted and can be kept secure.

The Entity Relationship Diagram (ERD) is the design of the main storage of information/data of the system 100 of the present invention. The ERD is implemented into a physical database which contains all the information/data about the XLOG system 100 and also contains the information stored inside the black-box. The ERD can be implemented in the black box module.

The ERD is a way of creating a storage for all the data being collected by the system 100. The ERD can be designed in any suitable way.

The ERD reflects a novel and unique idea behind the unique concept of the system of the present invention. The ERD is a back-end implementation of a unique and novel concept.

Categories of entities can be designed to allow the operator to securely store and efficiently retrieve desired data. According to one example embodiment, the categories of entities may include, without limitation: account audit logs, account password history, accounts, additional rate groups, additional rates, address, audit logs, cargo permissions, clients, commodities, commodity cargo permissions, commodity groups, consignee shipper, consignees, container type, countries, currencies, customs broker, customs broker reservation approvals, customs broker reservation event statuses, customs broker reservation events, customs broker reservation revisions, customs broker reservation services, customs broker reservation status, customs broker reservations, forex, image types, images, insurance premium, language lines, languages, length class, migrations, notifications, notify parties, notify party shipper, oauth access tokens, oauth auth codes, oauth personal access clients, oauth refresh tokens, old shipping reservations, password history, password resets, permission role, permissions, personal information, ratings, renegotiation status, reservation status, reservations, role user, roles, settings, ship reserve ship status, ship reserve status, shipper, shipper commodity, shipper customs broker, shipper shipping company, shipper trucker, shipper warehouse, shipping agencies, shipping companies, shipping container reservation, shipping container schedule, shipping containers, shipping reservation approvals, shipping reservation bid requests, shipping reservation event statuses, shipping reservation events, shipping reservation revisions, shipping reservation transshipments, shipping schedule segments, shipping schedules, shipping status, solo customs broker reservation commodities, solo customs broker reservation renegotiations, solo customs broker reservations, solo trucking reservations, solo warehouse reservation commodities, solo warehouse reservation warehouse services, solo warehouse reservations, states, templates, transaction logs, transaction progress, truck status, trucker, trucker addresses, trucker rates, trucker reservation approvals, trucker reservation event statuses, trucker reservation events, trucker reservation revisions, trucker reservation routes, trucker reservation status, trucker reservation trucks, trucker reservations, trucker routes, trucker service groups, trucker trucks, users, warehouse, warehouse reservation approvals, warehouse reservation event statuses, warehouse reservation events, warehouse reservation revisions, warehouse reservation services, warehouse reservation status, warehouse reservations, warehouse service groups, warehouse services, and weight class. Each entity can be configured to include elements that are related to the name of it. Each entity can be linked with at least one other entities so that information or data can be readily retrieved, is not easily corrupted, and can be kept secure. Each entity may have various elements with various data types. An entity can include a primary key (PK) and zero or more foreign keys (FK).

For example, the entity named “trucker” may have: id INT(10), account_id INT(10), company_logo VARCHAR(191), company_name VARCHAR(191), address VARCHAR(191), town VARCHAR(191), email_address VARCHAR(191), licence_no VARCHAR(191), supporting_docs LONGTEXT, created_at TIMESTAMP, updated_at TIMESTAMP, status TINYINT(4), notes TEXT, standard_rate DECIMAL(12.2), country_id INT(10), state_id INT(10), phone_number VARCHAR(191), mobile_number VARCHAR(191), fax_number VARCHAR(191), add_contact_firstname VARCHAR(191), add_contact_lastname VARCHAR(191), add_contact_email_address VARCHAR(191), add_contact_phone_number VARCHAR(191), add_contact_mobile_number VARCHAR(191), add_contact_fax_number VARCHAR(191), company_registration_number VARCHAR(191), business_partner type VARCHAR(191), firstname VARCHAR(191), lastname VARCHAR(191), and zip_code VARCHAR(191). The entity named “warehouse_reservations” may have: id INT(10), shipping_reservation_id INT(11), warehouse_id INT(10), final_price DECIMAL(19.2), is_origin INT(11), reservation_start_date DATETIME, reservation_end_date DATETIME, reservation_status_id INT(11), created_at TIMES TAMP, updated_at TIMESTAMP, notes TEXT, total_actual_amount_value DECIMAL(22.4), total_estimated_amount_value DECIMAL(22.4), total_estimated_amount VARCHAR(191), import total_actual_amount_value DECIMAL(22.4), import total_estimated_amount_value DECIMAL(22.4), import_total_estimated_amount VARCHAR(191), export_proforma_invoice VARCHAR(191), event_status_id INT(11), is_estimated_amount_paid TINYINT(4), payment_date_estimated_amount DATETIME, payment_date_actual_amount DATETIME, payout_amount DECIMAL(22.4), payout commission DECIMAL(22.4), payout_paid_at DATETIME, payout commission_paid_at DATETIME, refunded_at DATETIME, other_remarks TEXT, supporting_documents JSON, and renegotiations JSON.

The entity named “trucker_reservation_approvals” may have: created_at TIMESTAMP, updated_at TIMESTAMP, trucker_reservation_id INT(10), status INT(11), and notes TEXT.

The entity named “ship_reserve_ship_status” may have: shipping_reservation_id INT(10), shipping_status_id INT(10), notes TEXT, admin_name VARCHAR(191), created_at TIMESTAMP, and updated_at TIMESTAMP.

The entity named “shipping_schedules” may have: id INT(10), departure_date DATE, arrival_date DATE, vessel_name VARCHAR(191), voyage_number VARCHAR(191), port_of loading TEXT, port of discharge TEXT, created_at TIMESTAMP, updated_at TIMESTAMP, port of loading_countryid INT(10), port_of discharge_countryid INT(10), shipping_company_id INT(10), notes TEXT, imo VARCHAR(191), mmsi VARCHAR(191), latitude VARCHAR(191), longitude VARCHAR(191), is transshipment TINYINT(4), type VARCHAR(191), visibility TINYINT(4), and transshipment_notes TEXT.

The entity named “notifications” may have: id INT(10), code VARCHAR(191), subject VARCHAR(191), sender_name VARCHAR(191), sender_email VARCHAR(191), email_content TEXT, sms_content TEXT, signature TEXT, created_at TIMESTAMP, and updated_at TIMESTAMP.

The entity named “transaction_logs” may have: id INT(10), account_id INT(10), role VARCHAR(191), status VARCHAR(191), notes TEXT, customer_name VARCHAR(191), admin_name VARCHAR(191), created_at TIMESTAMP, and updated_at TIMESTAMP.

The entity named “trucker_reservation_events” may have: id INT(10), name VARCHAR(191), is_cms TINYINT(1), and resource VARCHAR(191).

The entity named “customs_broker_reservation_services” may have: customs_broker_reservation_id INT(11), additional rate id INT(11), created_at TIMESTAMP, updated_at TIMESTAMP, id INT(10), price VARCHAR(191), customs_broker_id INT(11), description VARCHAR(191), and unit VARCHAR(191).

The entity named: “solo_customs_broker_reservation_renegotiations” may have: id INT(10), shipper user_id INT(11), customs_broker_id INT(11), renegotiation_price DECIMAL(12.2), renegotiation_status_id INT(11), customs_broker_rep_user_id INT(11), is_origin TINYINT(1), created_at TIMESTAMP, and updated_at TIMESTAMP.

The entity named “commodities” may have: id INT(10), name VARCHAR(500), commodity_item_code VARCHAR(191), commodity_group_id INT(11), description TEXT, status TINYINT(4), sort_order INT(11), created_at TIMESTAMP, updated_at TIMESTAMP, and image VARCHAR(191).

The entity named “solo_customs_broker_reservation_commodities” may have: id INT(10), commodity_id INT(10), solo_customs_broker_reservation_id INT(10), quantity INT(11), length DECIMAL(12.2), width DECIMAL(12.2), height DECIMAL(12.2), weight DECIMAL(12.2), created_at TIMESTAMP, updated_at TIMESTAMP, weight_class_id INT(10), and length_class_id INT(10).

The entity named “customs_broker_reservation_revisions” may have: id INT(10), customs_broker_reservation_id INT(10), customs_broker_reservation JSON, created_at TIMESTAMP, and updated_at TIMESTAMP.

The entity named “shipping_reservation_approvals” may have: id INT(10), shipping_reservation_id INT(10), status INT(11), created_at TIMESTAMP, updated_at TIMESTAMP, and shipping_reservation_revision_id INT(11).

The entity named “shipping_reservation_event_statutses” may have: id INT(10), condition TEXT, event_id INT(10), next_event_id INT(10), and shipping_status_id INT(10).

The entity named “additional_rates” may have: additional_price DECIMAL(17.2), customs_broker_id INT(10), id INT(10), additional_rate_group id INT(11), unit VARCHAR(191), description VARCHAR(191), is_mandatory TINYINT(4), created_at TIMESTAMP, and updated_at TIMESTAMP.

The entity named “account_audit_logs” may have: id INT(10), account_id INT(10), module VARCHAR(191), action VARCHAR(191), result TINYINT(4), created_at TIMESTAMP, and updated_at TIMESTAMP.

Other data or information can be stored in other entities as shown in FIGS. 5 and 16, having a relational database structure.

By storing data this way, the information and data stored inside the database can easily be retrieved, cannot easily be corrupted, and can be kept secure. It is noted that the ERDs shown in FIGS. 5 and 16 are merely one example of implementing the present disclosure and that other relational database structure can be used to implement the present disclosure.

The present invention according to one aspect is a unique system due to the combined automated and procedural (manual) method of creating a shipping booking (reservation), including the must have service providers, in a way that is much simpler, more efficient, faster, more secure, less expensive, and more convenient manner for main system users such as, e.g., the Shipper (exporter/importer).

Example service providers include, but are not limited to, the Customs Broker, Warehouse owner, Trucking company, and of course the Shipping company. Others are contemplated. The goods being moved around or shipped is the Container in an example embodiment.

The present invention in one aspect is a unique digital platform for the shipping industry. Its end-to-end processing is a much simpler and more effective way of creating a shipping reservation. An end-to-end delivery of goods from the factory of origin to the destinations address—in any country.

Its User Interface is also quite unique. Its database design as reflected in the ERD is also unique. Its combined manual and automated processing is also unique. The needed information collected to achieve a successful shipping reservation is also very unique—others will require around 800 data elements while the present invention in one example aspects only needs around 50 data elements to achieve the same.

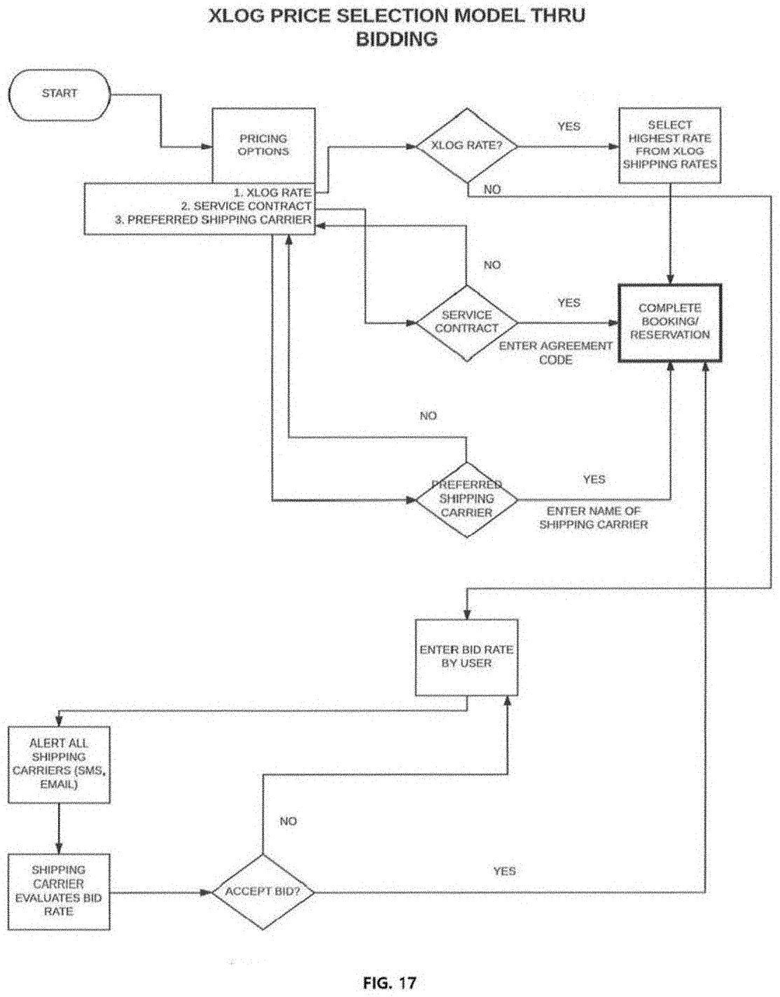

FIG. 17 is a flowchart illustrating a method in which the system of the present invention implements a bidding process (rate) selection for a user given the various rates available from the different shipping carriers, according to an example embodiment of the present invention. FIG. 17 thus illustrates a price selection model of the system through bidding. The method of FIG. 17 can be performed by one of the modules of the present invention such as the middleware module 104 or the end-user module 102 or others.

When a user starts a bidding, the user can choose any one of pricing options including (1) XLOG Rate, (2) Service Contract, and (3) Preferred Shipping Carrier. If the user chooses (1) XLOG Rate, the system determines whether there is a XLOG rate for the bidding. If yes, then the system selects the highest rate from XLOG shipping rates, and the booking/reservation is complete. If no, then the user enters a desired bid rate. The system then alerts all shipping carriers through texts or emails. Shipping carriers then evaluate the bid rate. If at least one shipping carriers accepts the bid rate, then the booking/reservation is complete. If no, shipping carriers accepts the bid rate, then the user enters a new bid rate.

If the user chooses (2) Service Contract, the system determines if there is a service contract. If yes, then the user enters a name of an agreement code, and the booking/reservation is complete. If no, then the queue returns back to “Pricing Options,” where the user can again select any one of options 1-3 as shown in FIG. 17.

If the user chooses (3) Preferred Shipping Carrier, the system determines whether there is a preferred shipping carrier. If yes, then the user enters the name of the shipping carrier, and the booking/reservation is complete. If no, then the queue returns back to “Pricing Options.

Technical challenges addressed by the present invention include the following. Stakeholders (e.g., truckers, warehouse operators, brokers, ship owners, etc.) use a combination of manual, legacy, and modern computer systems combined, and this varies per country. Conventionally the practice is to mainly perform the transactions serially or semi-concurrent with a mixture of manual and automated systems. Given this scenario, conventional solutions cannot create an integrated solution that cuts across these various industries to create a fully integrated solution. A unique solution of the present invention addressing this problem is that the present invention in an example embodiment includes a computer software solution which allows it to simultaneously and on a 24/7 mode establish valid and legal agreements with all of the project stakeholders on a verifiable and Internet-based online recording system. This is accomplished through the utilization of various technology and communication platforms which allows no single point of failure in its workflow. The solution of the present invention is a one-stop-shop for exporters and importers of goods across the globe. This is concurrent, real-time, and 24/7 through computer software maintained by a corporation or entity operating the software. In the international industry, these activities are normally done separately for each of the mentioned stakeholders. The present invention revolutionizes how exporting and importing of goods is done by making it significantly simpler and more efficient and fast. Notably, the present invention can dramatically decrease the cost for an exporter and importer.

### Platform for Real-Time and Online Freight Management

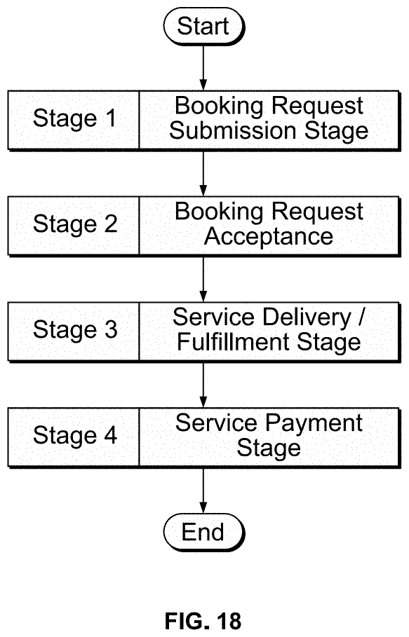

Referring to FIG. 18, there is seen a high-level process of workflow of the present invention according to one embodiment. The present invention can be a software or hardware platform containing a process flow comprising four distinctive stages as described below. The platform, and the steps and elements shown in FIGS. 18-22, can be implemented in one or more of components 101, 102, 103, 104, and 105 of FIGS. 1-3, for example, although the invention is not limited to this. The first stage is a booking request submission stage (stage 1). The second stage is a booking request acceptance stage (stage 2). The third stage is a service delivery/fulfillment stage (stage 3). The fourth stage is a service payment stage (stage 3).

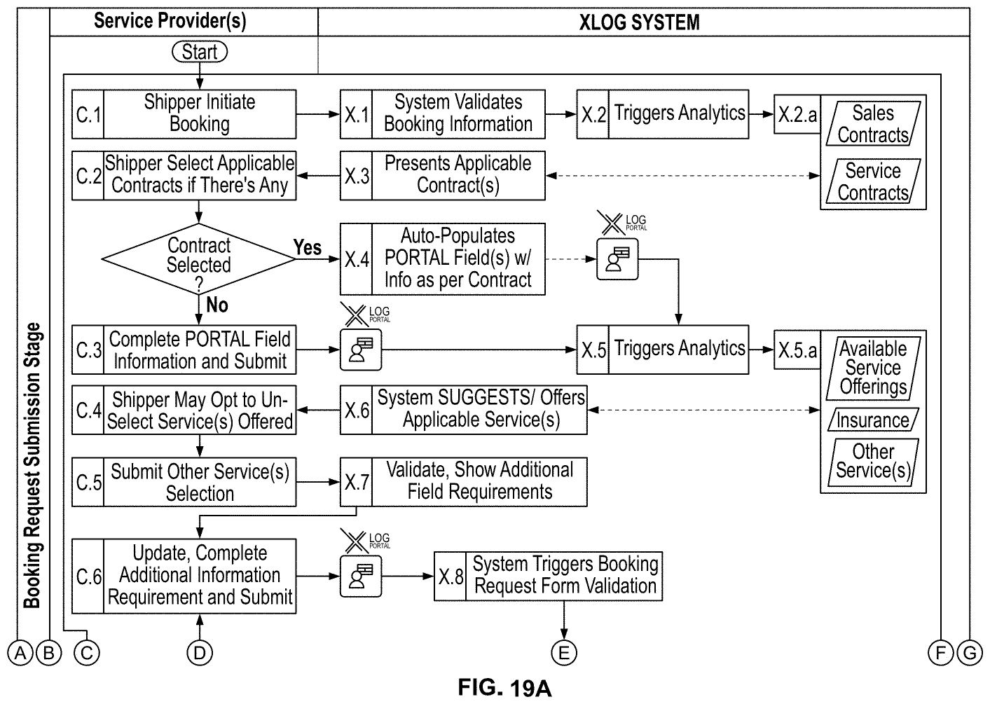

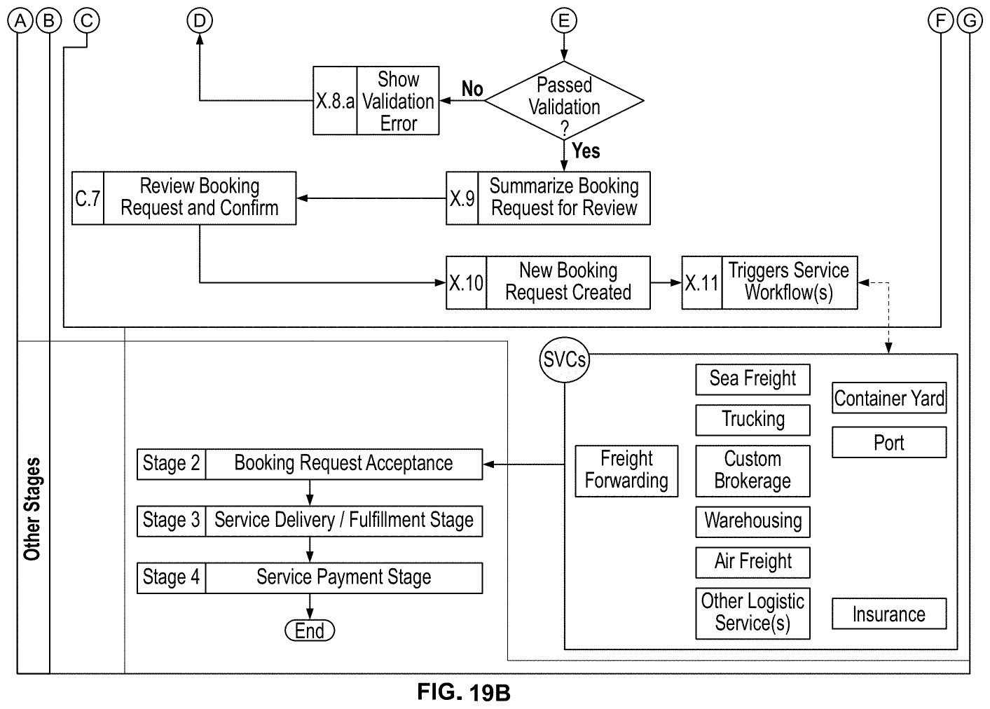

Referring to FIGS. 19A-B, there is seen a workflow of the booking request submission stage (stage 1). This is the initial stage of the overall workflow. Shippers (for example the Buyer/Consignee or Seller, Importer or Exporter) initiate a booking request via the platform (step C.1). Meanwhile, service providers (i.e., shipping lines, truckers, customs brokers, etc.) are the parties/companies offering their services to deliver/execute the bookings of the shippers on the platform. The platform is provided for both shippers and service providers. As platform users, they can initiate a booking request through any booking channel (e.g., various systems that are directly or indirectly connected or integrated via the platform, which may be, but are not limited to, a website, a web application, a mobile application, a whitelisted application, etc.) which will trigger booking or allow a user to book their shipments and have the shipments moved or transported from their designated pick-up and delivery location points.

The platform validates booking information (step X.1) and triggers Analytics (step X.2). The platform presents applicable contracts to the service provider with regard to the booking request (steps X.3 and C.2). If a contract is selected by the service provider, the platform auto-populates Portal fields with information as per the selected contract (step X.4). If a contract is not selected by the service provider, the service provider is given an option to fill out Portal field information and submit this information through a Portal (step C.3). The Portal then triggers analytics (step X.5). The platform suggests or offers available services (step X.6). The service provider may opt to un-select or de-select services offered (step C.4) and submit other service selections (step C.5). The platform validates and shows additional field requirements (step X.7). The service provider updates additional information requirement and submits this to the Portal (step C.6). The platform triggers booking request form validation (step X.8) If validation fails, the platform displays a validation error to the service provider (step X.8.a). If validation passes, the platform summarizes the booking request for review and sends it to the service provider (step X.9). The service provider reviews the booking request and confirms (step C.7). The platform creates a new booking request based on the information submitted (step X.10) and triggers service workflow(s) (step X.11). The new booking request and related information are sent to SVCs (service(s) available in XLOG). SVCs include sea freight, container yard, trucking, port, custom brokerage, freight forwarding, warehousing, air freight, insurance, and other logistic service(s).

The platform offers a smart and intelligent solution through its portal-based booking platform connected to different services that are independently unique, robust but streamlined workflows (e.g., various key logistic services such as but not limited to sea freight, custom brokerage, warehousing, trucking, inland move, air freight, freight forwarding, port operation, depot, container yard management and operation, fleet management) encapsulating also other indirect services that are key to ensuring traceability, risk management and other key business requirements in order to ensure that shipment will be shipped, transported, paid and received by the buyer and involved parties. Thus, it is important that such indirect services are factored-in and integrated within the platform (such as but not limited to, Sales and Service Contract management, Insurance, Payment Management, Financing, etc.). Maximizing the full potential of integrated solution and services being offered in the platform, it utilizes information and makes use of Analytics to identify applicable contracts and even suggests and offers applicable services that are available in the platforms such as an insurance to manage risk while in transit (e.g., Marine insurance for sea freight, Air Cargo insurance for air freight, Transportation insurance, Freight Insurance, and the like). Based on the selected contracts and services to be availed, it automatically prepopulates pre-defined information which improves the user experience. Also, by using a Booking Portal, users no longer need to fill up redundant information across all service forms; thus, this is a true streamlined booking process.

In addition, the platform may include an option for the users to access a Support Channels such as Sales or request for demo, etc., if they want to know more about the platform.

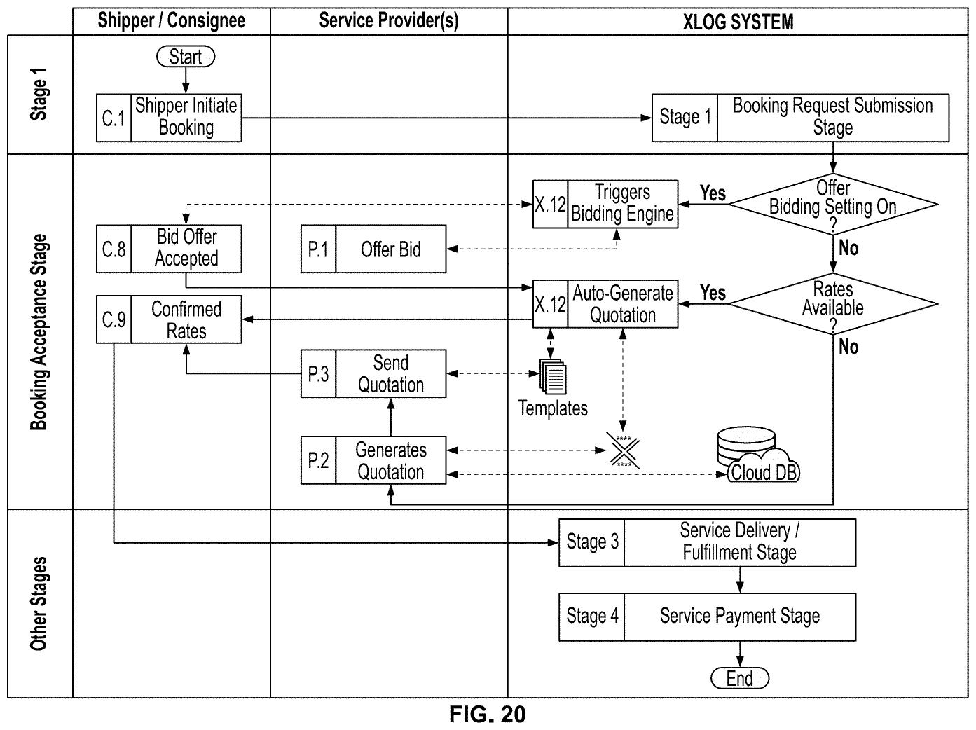

Referring to FIG. 20, there is seen a workflow of booking request acceptance stage. Following the shipper's submission of the booking request, service providers offering their services can review and confirm the request from the shipper, followed by the ability to generate service quotations or participate in the platform's auto-rate generation through the bidding engine.

The shipper initiates a booking request (step C.1) that is received by the platform. The booking request can go through the booking request submission stage (stage 1) as explained above. The planform then determines whether an offer bidding setting is on. If yes, the platform triggers a bidding engine (step X.12). A service provider provides a bid offer (step P.1). The shipper accepts the bid offer (step C.8. The platform then auto-generates a quotation and stores it in a blockchain. Using templates, the service provider sends the quotation (step P.3). The shipper receives this quotation and confirms rates (step C.9) as received by the platform.

If the platform determines that an offer bidding setting is off after step C.1, the platform determines whether rates are available. If yes, the process goes to step X.12. If no, then the service provider generates a quotation (step P.2).

Through the service provider's account access, users will receive booking request tickets that will contain all information provided by the shipper during the initial stage (stage 1). The platform's engine will then determine whether the request is for a specific service provider or the request is for bidding to multiple service providers. If the latter, this will trigger the bidding engine to multiple service providers in the platform. Once an offer is accepted by both parties, the platform enables service providers to generate rate quotation documents.

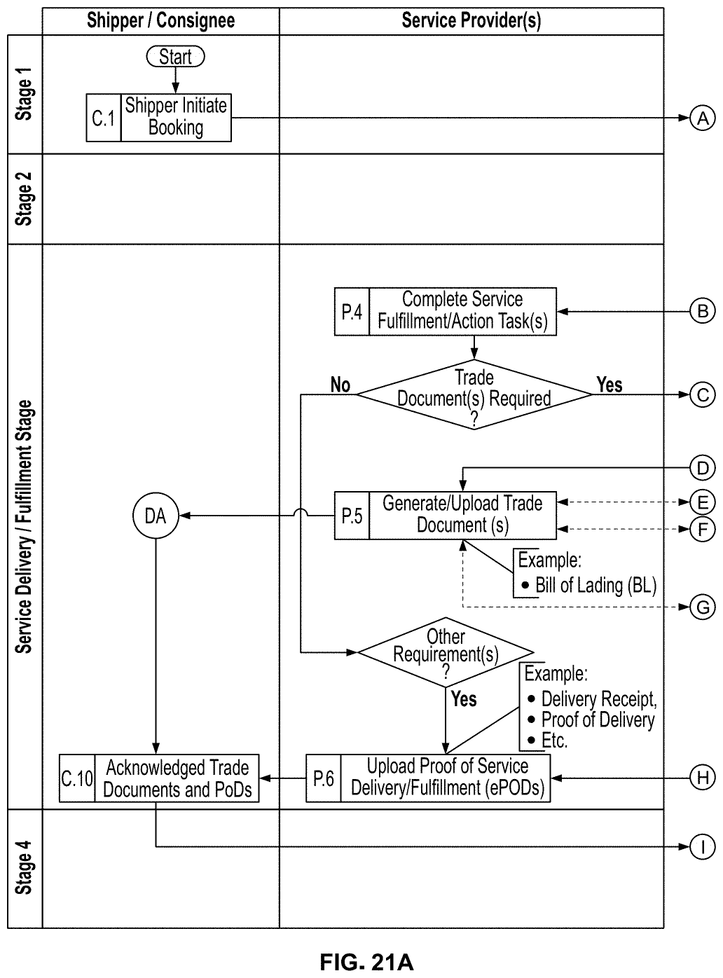

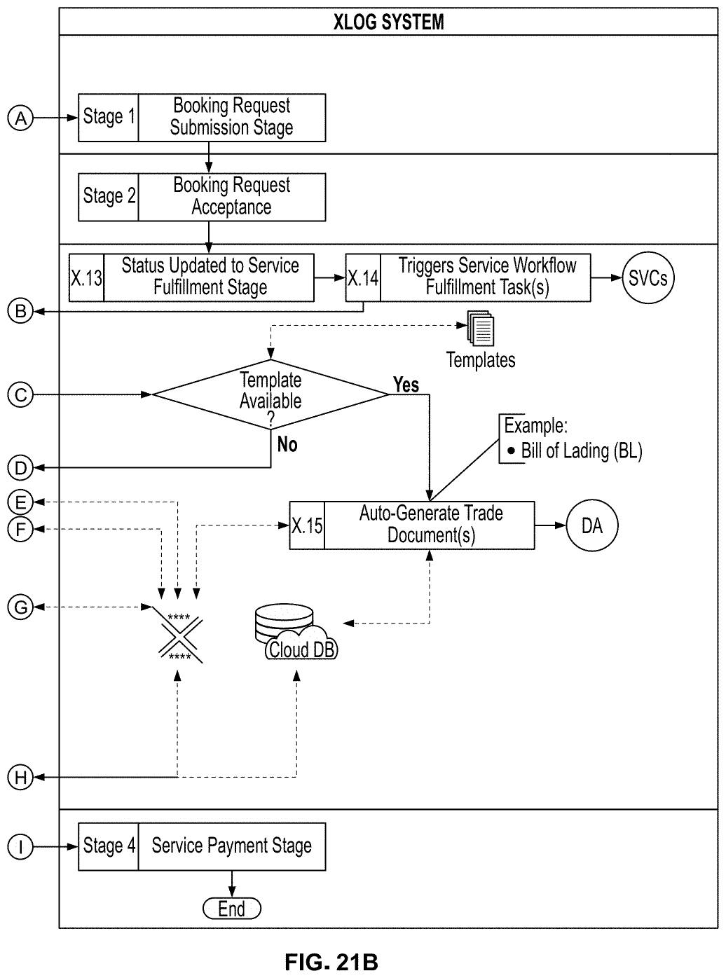

Referring to FIGS. 21A-B, there is seen a workflow of the service delivery fulfillment stage. The platform does not end with just the booking alone; it continues to the actual fulfillment of service as well. The platform enables service providers to update and shippers to be updated through the platform in real time. The platform is also able to auto-generate documents involving important milestones in the end-to-end journey of one's shipment.

After rate and booking acceptance, the service provider now proceeds to the service fulfillment stage. The platform then calls the service workflow depending on the service portal(s) selected during the booking stage.

During the service fulfillment stage, shippers and service providers must accomplish certain milestones/activities designated to each party like providing information for shipping instructions, BL Drafts, Loading Confirmation, etc. Certain stages of the workflow will also trigger the auto-generation of trade documents (i.e., Container Release Order, Bill of Lading, Invoice, Proof of delivery, Delivery Receipts, etc.). The platform also allows service providers to issue templates that will be used to generate documents on their behalf. Auto-generated documents or digital documents will be used by the platform to provide smart suggestions to users and predict the following steps needed to provide a more seamless and faster process of managing their reservations.

Such documents will be used by the platform to determine authenticity of information through blockchain technology. The same trade documents will also be required and provided to the bank or other lending engines to determine credit scoring and enable transactions to be viable for receivable financing.

In the service delivery/fulfillment stage, the status is updated to service fulfillment stage (step X.13). The platform then triggers service workflow fulfillment task(s) (step X.14) and send information to the SVCs. The service provider completes service fulfillment/action task(s) (step P.4). The service provider determines whether trade document(s) is required. If yes, the platform determines whether a template is available. If there are an available template, then the platform auto-generates trade document(s) and send information to DA (trade and supporting document acceptance) (step X.15). The platform stores the trade document(s) in the blockchain and a cloud database.

If it is determined that there is no template available after the service provider determined that trade document(s) is required, then the service provider generates trade document(s) and uploads them to the blockchain (step P.5). The service provider also sends the trade document(s) to DA (step P.5).

If it is determined that trade document(s) is not required after step P.4, then the service provider determines whether there is any other requirement. If yes, then the system uploads proof of service delivery/fulfillment (ePoDs) to the blockchain and the cloud database (step P.6). The shipper acknowledges trade documents and PoDs (step C.10).

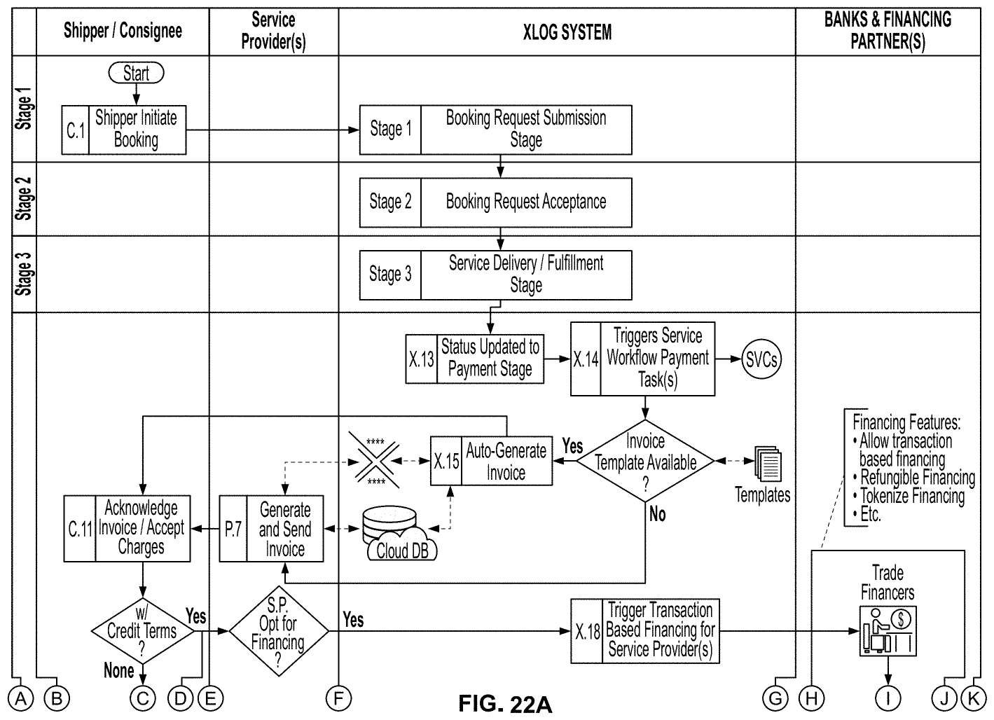

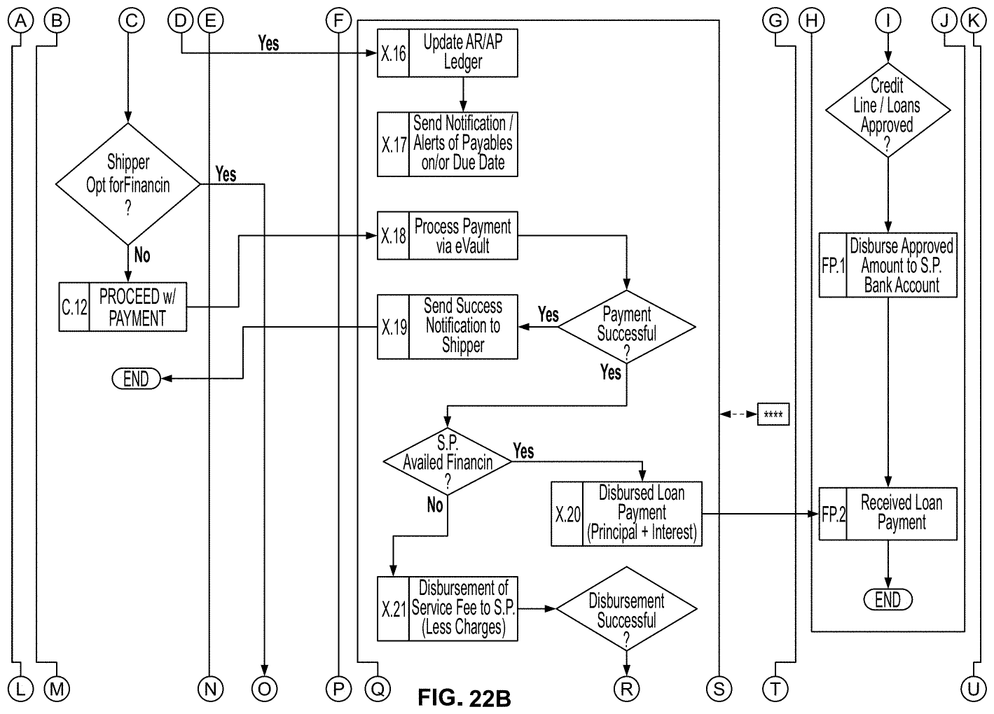

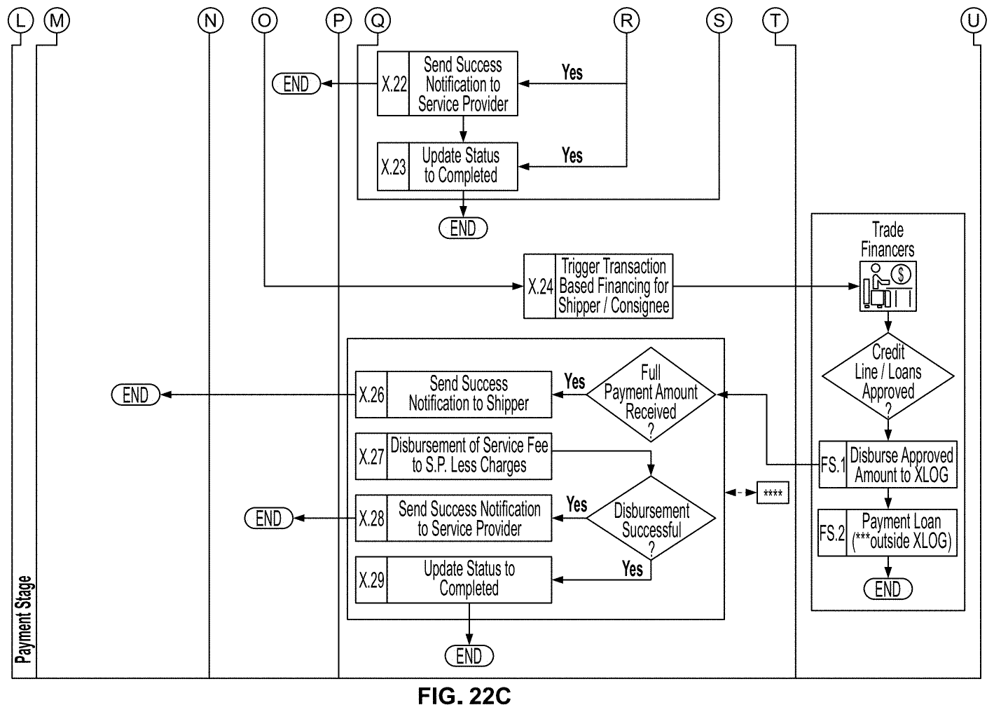

Referring to FIGS. 22A-C, there is seen a workflow of the service payment stage. Once services have been rendered/delivered, the platform enables parties to issue/receive invoices and to process payments online through the platform's eVault engine. The platform also enables parties to access back-to-back receivables financing from the platform's partner banks.

After the fulfillment of the service, service providers (SPs) can now proceed to request payment from shippers. The platform enables SPs to generate invoices whether through auto-generated documents (depending on the availability of template in the system) or through manually uploading of invoice documents. The shipper will then receive the invoice for acknowledgement and acceptance. This then triggers the platform to determine the payment term whether it is tagged as credit term or prepaid. If with credit term, the platform calls on the loans engine of the bank and provides details of the invoice and related trade documents. This enables the bank to throw a credit score for the shipper/service provider. The platform then displays the receivables that are valid for financing for the confirmation of the service provider/shipper. Once accepted the bank partner will automatically disburse the amount to the designated bank account of the service provider/shipper. This will trigger the platform to update the AR/AP ledger (account receivable/account payable ledger) of the parties involved in the transaction. Simultaneously, the platform is tracking the days of the credit term starting from the acknowledgement of the invoice. The platform will send push notifications to the shipper to on/before the due date of the invoice. Once the payment has been done via the platform's eVault ledger, the amount will then be distributed to the respective parties. The bank will receive the principal and interest, the platform will receive its platform fee, and the remaining balance will be credited to the account of the service provider. If the payment term is prepaid, it will proceed to the payment of the shipper via the platform's payment solution. Once proper payments are done, the transaction will be tagged as paid/completed.

In the service payment stage, the platform updates the status to service payment stage (step X.13). The platform then triggers service workflow payment task(s) and sends information to the SVCs (step X.14). The platform determines whether an invoice template is available. If yes, the platform auto-generates an invoice and stores it in the blockchain and the cloud database (step X.15). The service provider then generates an invoice and sends it to the shipper (step P.7). The shipper acknowledges the invoice and accepts charges (step C. 11). If the platform determines that an invoice template is not available, then the process goes to step P.7.

After step C.11, it is determined whether the shipper is with credit terms. If no, then it is determined whether the shipper opted for financing. If no, the shipper is proceeded with payment (step C.12) and the process goes to step X.18, which will be explained below. If it is determined that the shipper did not opt for financing, then the platform triggers transaction based financing for shipper (step X.24). The platform then sends information to a bank partner, who will determine whether the credit line/loans are approved. The bank partner disburses an approved amount to the platform operator (step FS.1). Loans can be paid outside the platform (step FS.2) The platform determines whether the full payment amount was received. If yes, then the platform sends a success notification to the shipper (step X.26). The platform then disburses a service fee to the service provider (step X.27). The platform next determines whether the disbursement was successful. If yes, the platform sends a success notification to the service provider (step X.28). The platform then updates status to “Completed” (step X.29).

If it is determined that the shipper is with credit terms after step C.11, the it is determined whether the service provider opted for financing. If yes, the platform triggers transaction based financing for service providers(s) (step X.18). The platform then sends information to the bank partner, who will determine whether the credit line/loans are approved. The bank partner disburses an approved amount to the service provider's bank account (step FP. 1).

The platform updates an AR/AP ledger (account receivable/account payable ledger) after it is determined that the shipper is with credit terms (step X.16). The platform sends notification alerts of payables on/or a due date (step X.17). When the platform receives a message from the shipper after step C.12, the platform processes the payment via a general ledger platform (or “eVault”) (step X.18). It is then determined whether the payment was successful. If yes, then the platform sends a success notification to the shipper and determines whether the service provider availed financing.

If yes, then the platform disburses a loan payment (the principal plus interests) (step X.20). If it is determined that the service provider did not avail financing, then the platform disburses a service fee to the service provider (step X.21). It is then determined whether the disbursement was successful. If yes, then the platform sends a success notification to the service provider (step X.22) and updates the status to “Completed” (step X.23).

Steps X.16-23 and steps X.26-28 can be recorded in the eVault.

As an example, if the shipper has agreed credit terms with the service provider, the latter can opt for financing from the platform's bank/financing partner(s). The platform then checks if the service provider has a credit score with the bank/financing partner(s). The platform provides the service provider eligible receivables for financing. If service providers accept receivables for financing, the bank disburses the amount to a designated bank account of the service provider. After the agreed credit terms/days, the platform will notify the shipper on or before the due date to pay invoice amount via the platform. The platform will disburse the amount due to the bank/financing partner (principal plus interest); platform fee (if applicable) and the remaining balance due to service provider.

As another example, if the shipper has no agreed credit terms with the service provider, the shipper can opt for financing from the platform's bank/financing partner(s). The platform then checks if the shipper has an available credit score. If yes, the platform provides the shipper eligible payables for financing. If the shipper accepts payables for financing, the bank disburses the amount payable to designated bank accounts of the service provider and XLOG for the platform commission (if applicable). After the agreed credit terms/days, the platform will notify the shipper on or before the due date to pay the principal plus interest to the bank/financing partner.

If the shipper opts for prepaid payment, once an invoice from the service provider is received and accepted by the shipper, the shipper must pay the invoice amount via the platform. The amount due to the service provider is then credited to their designated bank accounts minus the platform commission (if applicable).

Platform commissions can depend on the commission settings of XLOG to the transaction.

The present platform can work with a ledger platform such as eVault, which is the general ledger platform fully integrated with the present invention (or XLOG) and external or third party financial, payment gateways, platforms, or solution which processes and receives credits and debits for XLOG eWallets, direct payments, disbursements, withdrawals, etc. Furthermore, it is the single point of reference for ledger movements related to XLOG transactional records regardless but not limited to payment but anything on financials.

### Container Depot System

In a preferred embodiment, the system further comprises a container depot system. Container depots are an essential part of the logistics chain. These depots are the assigned collection point for empty containers. At the depots, importers can leave their empty containers while exporters can pick-up empty containers for shipment purposes. Apart from being empty container storages, depots also provide container-related services including sales, inspection, cleaning, repairs, and maintenance.

Preferably, the container depot system is a microsite of XLOG for container depot companies and its depot operators. Through this microsite, container depots will have a forecasted number of containers, empty or loaded, going in and out of their port. The container depot system can be managed by three user roles, the processing team for the service contracts, the operations team for the container management and the reports, and the accounting team for the billing management.

In one embodiment, the container depot system includes the service contract management, the container management, the container depot reports, and the billing management. The service contract management will cover the container depot service and rates inquiry up to the contract agreement. The container management will let the container depot operators track, manage, and tag containers from inventory up to its release. The container depot reports are to be generated as well based on the container management system. Lastly, the separate billing management is to be implemented as well basing on the agreements made from the service contract management.

The main objectives of the container depot system are as follows:

A. To let container depot companies register in the system and offer their container-related services;

B. To provide depot operators a real-time inventory of containers, empty or loaded, going in and out of depot;

C. To handle inquiries and contract agreements on depot services between the principal and the depot operators;

D. To manage container-related services, from inspection to cleaning and repair;

E. To generate required updates and reports based from the container management for reference; and

F. To give depot operators a way of managing billing and invoicing of the depot services availed by the principal.

It is noted that “container” as used herein refers to a large metal box in which goods are stuffed and handled as one unit. The standard sizes of the container are 20 ft.×8 ft.; 40 ft.×8 ft.; or 45 ft.×8 ft.

It is noted that “container terminal” as used herein refers to an area designated for the handling, storage, and possibly loading or unloading of cargo into or out of containers, and where containers can be picked up, dropped off, maintained, stored, or loaded or unloaded from one mode of transport to another (that is, vessel, truck, barge, or rail).

It is noted that “cut-off time” as used herein refers to the latest time a container may be delivered within the terminal for loading or other container services.

It is noted that “depot” as used herein refers to a freight station for containers where empty containers can be picked up or dropped off.

It is noted that “empty repo” as used herein refers to the movement of empty containers.

It is noted that “Equipment Interchange Receipt (EIR)” as used herein refers to “a document transferring a container from one carrier to another or to/from a terminal.

It is noted that “gate in” as used herein refers to the date and time the transaction or interchange of containers between the depot operator and the carrier has occurred.

It is noted that “gate out” as used herein refers to transaction or interchange date and time a container leaves the depot.

It is noted that “open top container” as used herein refers to fitted container with a solid removable roof so the container can be loaded or unloaded from the top.

It is noted that “reefer” as used herein refers to a container or vessel for transporting refrigerated or frozen cargos.

It is noted that “stuffing” and “unstuffing” as used herein refer to loading and unloading of containers.

It is noted that “yard” as used herein refers to a classification storage or switching area.

In one embodiment, the container depot system comprises a container depot company and agent registration module, client directory management module, service contract management module, container management module, reports management module, and billing management module.

Preferably, a container depot company and agent registration can be done in the CMS (Content Management System). The CMS admin can register the container depot company and the agents through this module, provided the company and user details to access the Port Services microsite.

The client directory management module provides the container depot operators with a client directory, including the shipping lines and the other principals for the container master listing.

The service contract management module allows the container depot operators to process the inquiry system between the depot operators and the principals and allows the depot operators to declare service contracts after the two parties has come to an agreement.

The container management allows the container depot operators to handle all the container-related services, starting from setting up the container masterlist, the container admission, inspection and services, up to the container release. The container depot operators can manage an inventory listing of all the containers in and out of the depot. The listing would contain all the container details and status. This inventory listing will serve as the master data of all the containers. The depot operators can easily pull-up container data through the inventory listing, tag statuses, assign services, add notes, and manage billings.

The reports management module allows the container depot operators to generate required templated reports base from the movements of containers in and out the depot.

The billing management module allows the container depot operators to consolidate a billing statement to the principal, based from the service contracts and from the services availed by the company per specific container, per transaction.

In one embodiment, there are two types or users for the container depot system: the container depot operator and the shipping lines/principal. In another embodiment, the users can be the container depot operator, the shipping lines/principal, the shipper, and the consignee. The container depot operator manages container depot operations from handling, storage, and possibly stuffing and unstuffing of containers, provides container-related services from inspection, cleaning, repairs, up to the releasing, handles container gate ins and gate outs, and sends required reports to principals. The shipping lines/principal initiates service contract agreements with container depots for container services, provides required documents for container entry and release, confirms services to be done unto containers, and handles payment processes for container services.

In a preferred embodiment, the proposed system for the container depot will cover the following major areas:

| Item | Portal | Module |
|---|---|---|
| 1 | CMS - Main | Container Depot Registration - Company |
| 2 | CMS - Main | Container Depot Registration - Agent |
| 3 | CMS - Main | Container Depot Payout Management |
| 4 | CMS - Main | Container Status Management |
| 5 | CMS - Main | Container Depot Status Management |
| 6 | CMS - Main | Container Depot Events Management |
| 1 | CMS - Depot | Company Account Activation |
| 2 | CMS - Depot | Agent Account Activation |
| 3 | CMS - Depot | Login Module |
| 4 | CMS - Depot | Company Account Management |
| 5 | CMS - Depot | Agent Account Management |
| 6 | CMS - Depot | Client Directory Management |
| 7 | CMS - Depot | Container Depot Dashboard |
| 8 | CMS - Depot | Service Contract Management |
| 9 | CMS - Depot | Container Inventory Management |
| 10 | CMS - Depot | Container Admission Management |
| 11 | CMS - Depot | Container Inspection Management |
| 12 | CMS - Depot | Container Services Management |
| 13 | CMS - Depot | Container Release Management |
| 14 | CMS - Depot | Daily Inventory Report |
| 15 | CMS - Depot | Status Aging Report |
| 16 | CMS - Depot | Gate-out Report |
| 17 | CMS - Depot | Container Depot Billing Management |
| 1 | CMS | Service Contract Management |
| 2 | CMS | Container Admission Management |
| 3 | CMS | Container Inspection Management |
| 4 | CMS | Container Release Management |
| 5 | CMS | Container Depot Payout Management |

In a preferred embodiment, the system is deployed to a cloud infrastructure through Amazon Web Services (AWS).

A process flow of service contract management in accordance with an example embodiment is as follows. First, the principal selects a container depot for service rates and quotations. The principal will be redirected to an inquiry page for container depot operators to come up with a rate and validity quotation. Once submitted, the container depot operators are notified of a submitted inquiry form. The depot operators review these inquiries then upload a service rate quotation. If the principal wishes to renegotiate with the quoted service rates, the container depot operators upload another service rate quotation. If the principal confirms and accepts the quoted rates, the container depot operators draft a service contract. The container depot operators send a service contract to finalize the agreement between the two parties.

In another embodiment, the principal selects a container depot for service quotations. Upon selection of the container depot, the principal then submits an inquiry for service quotations from the depot. The container depot operator offers services to the principal with its rates. The depot operator also offers additional container services to the principal. The principal confirms the offered services and its rates from the depot operator. If the principal wishes for a renegotiation, he may do so, then the depot operator uploads another quotation until rates are confirmed. Once rates are confirmed, the container operator can then confirm and submit a service contract to the principal.

A process flow of container management in accordance with an example embodiment is as follows. First, the container depot operator sets up a master list of the containers per company for easy inventory purposes. The principal sends a pre-advise for the containers going inside to utilize the port. The depot operator views the pre-advise and checks if the container is in the masterlist. If the container is not yet in the master list, the depot operator then adds the container details in the masterlist and waits for the actual container entry. Upon the container's admission, the depot operator counter-checks the inventory if container is in the masterlist. If the container is not in the masterlist, the container is rejected and is returned. If the container is in the masterlist, the container is accepted and proceeds to inspection. During the inspection phase, the containers are classified. After classification, the container depot operator assesses which services are needed per container then generates an estimate report for principal's approval. During the review of the estimate report, the principal can either accept the services, remove some of the services, or request for additional services. The depot operator then proceeds to the services. Once done, the containers are then reclassified and are tagged as available. If the principal will be sending surveyors to inspect and select a container, the depot operator is notified. Once surveyors have selected which containers to use, the containers are tagged as “Reserved” in the container inventory. On the actual pick-up date, the principal uploads a container release order for the depot operator to release the empty containers. The containers are now tagged as “Released.”

Preferably, container depot registration for companies can be done in CMS by the back office. The container depot operator companies will have to provide their company details to be able to register as depot operators in the system (XLOG) by filing form fields.

Container depot operator companies will have to register their agents as well. Registration can be done in CMS by the back office. The depot operator agents will have to provide their profile and contact details to be able to register and for them to set their login credentials.

A diagram flow of container depot registration in accordance with an example embodiment is as follows. First, container depot companies provide their required company details for registration. The XLOG back office then processes these details for registration. Once company is already within XLOG, the back office then sets up the agent accounts for the depot operating company. The company provides the required details for their agent's registration. Once agents are registered for the company, they will be receiving notifications on the contact details they have provided. Notifications will contain the link for the agents to be able to set their login credentials.

The service contract management module allows the container depot operators to process the inquiry system between the depot operators and the principals. This also allows the depot operators to declare service contracts after the two parties have come to an agreement.

A diagram flow of service contract management in accordance with an example embodiment is as follows. First, the principal selects a container depot for rates quotations. The principal then sends an inquiry to the selected container depot. Once the inquiry was reviewed, the depot operator then sends a rate quotations to the principal. Rates are then confirmed to draft the service contract. The container depot operator sends a service contract to finalize the agreement between the two parties.

In another embodiment, the principal first selects a container depot for service quotations. Upon selection of the container depot, the principal then submits an inquiry for service quotations from the depot. The container depot operator offers services to the principal with its rates. The depot operator also offers additional container services to the principal. The principal confirms the offered services and its rates from the depot operator. If the principal wishes for a renegotiation, he may do so, then depot operator uploads another quotation until rates are confirmed. Once rates are confirmed, the container operator can then confirm and submit a service contract to the principal. The container management module allows the container depot operators to handle all the container-related services, starting from setting up the container masterlist, the container admission, inspection and services, up to the container release.

The container inventory management module allows the container depot operators to maintain a master list of all the containers going in and out of the container depot. Each container is assigned to principals.

The container admission management module allows the container depot operators to check if containers going inside are assigned to the depot. This also allows the depot operators to add container details from the pre-advise.

In a preferred embodiment, the container depot operators can manage an inventory listing of all the containers in and out of the depot. The listing would contain all the container details and status. This inventory listing will serve as the master data of all the containers. The depot operators can easily pull-up container data through the inventory listing, tag statuses, assign services, add notes, and manage billings. The container depot operators can manage the registration of containers in the container inventory system. The containers are registered per company. This registration will add to the master data for container depot operators for ease in populating report (e.g. Equipment Interchange Report)

A diagram flow of container management (admission) in accordance with an example embodiment is as follows. First, the principals send a list of containers to the container depot operator. The depot operator then verifies if the containers are assigned to the depot. If the container is not in the masterlist of containers, the container is rejected and is returned. If the container is in the masterlist, the container proceeds to inspection.

In another embodiment, the container depot operator receives a pre-advice if containers are to be admitted in the container depot. The pre-advice contains the container specifics (i.e. number, type, size). The depot operator then verifies the containers using the details from the pre-advice and from the Equipment Interchange Receipt (EIR). If container is not assigned to the container depot, or discrepancies with details are observed, the container is rejected and is not admitted to the depot. If the container is verified to be assigned to the depot, the container is accepted and is admitted. The container then proceeds to inspection.

Through the container inspection management module, the depot operators can update the container inventory of the container's classification. Also, the depot operators can declare which container-related services are needed are then sent to the principal via estimate reports.

A diagram flow of container management (inspection) in accordance with an example embodiment is as follows. First, the depot operator inspects the container for dents, holes, and other damages. The containers are then classified based from the inspection done. The depot operator selects which services are needed for the container to mend damages. These services are declared in a generated estimate report which is sent to the principal for approval.

In another embodiment, the container depot operator first proceeds with the inspection after admission of the containers. The depot operator assesses the container then classifies the container. After classification, the depot operator selects the services needed to be done to the containers. The depot operator then generates an estimate report to the principal of the services needed to be done to the containers. The principal then reviews the generated estimate report. The principal confirms what services are approved to done to the containers.

A diagram flow of container management (services) in accordance with an example embodiment is as follows. Once the principal has confirmed the services needed to be done to the containers, the depot operator processes these services. After processing the services to the containers, the depot operator then classifies the containers again. The container depot operator now tags the status of these containers as “Available.”

In a preferred embodiment, there are three types of report: (1) daily inventory report, (2) status aging report, and (3) gate-out report.

The daily inventory report is daily containers quantity summary status report. Statuses of the daily inventory report include the following: (a) Ready/Available, (b) Pending Approval, (c) On-going Repair, (d) Reserved, (e) Released, (f) On Repo, and (g) Abandoned. Container depot operator can note in this report which containers are reserved and which are released.

The status aging report is the container depot's running balance report. The status aging report is per container type and size. Status aging report contains the following: (a) EIR Number, (b) Container Number, (c) Container Type, (d) Container Size, (e) Status, (f) Time In, (g) Date In, (h) Classification, (i) Number of Days, (j) Manufacturing Date, and (k) Remarks.

Once the container is released from the depot, the container is reflected on the gate-out report. The gate-out report contains the following: (a) Booking Number, (b) EIR Number, (c) Container Number, (d) Container Type, (e) Container Size, (f) Status, (g) Time In, (h) Date In, (i) Classification, (j) Number of Days, (k) Manufacturing Date, and (l) Remarks.

The container services management module allows the container depot operator to reclassify the containers after execution of container-related services.

Prior to container releasings, container depot operators will be needing documents prior to releasing. Through the container releasing management module, document exchanged will be catered. Container reservations can also be done through this system.

Diagram flows of container management for releasing (the upper one) and container management for releasing—reserved (the lower one) are in accordance with an example embodiment.

For container management (releasing), principal attaches a Container Release Order for the depot operator's viewing and reference. Prior to the container's release, the trucker should present a CRO for the principal to be checked by the container depot operator. The depot operator releases the containers then tags the status of the containers as “Released.”

For other instances (releasing—reserved), the principal assigns surveyors to inspect and select containers to use for shipments. Once surveyor has selected a container, the container depot operator reserves the container for the principal. The principal attaches a Container Release Order for the depot operator's viewing and reference. Prior to the container's release, the trucker should present a CRO for the principal to be checked by the container depot operator.

Depot operator releases the containers then tags the status of the containers as “Released.”

The billing management module allows the container depot operators to generate a billing statement based on the services done per containers, per transaction. Rates declared in the generated billing are from the service contract agreement established between the two parties.

Preferably, the container depot operator can easily generate a billing to the principal. Generated billings will be based on a selected billing period. Generated billings will contain all the accumulated transactions of the principal. Each transaction will be per container. Generated billing will provide a total billing together with the breakdown of the services done by the container depot operator.

In one embodiment, the timeline of the container depot system is as follows:

1. Container Depot Registration

2. Service Contract Management

3. Container Management
a. Container Inventory
b. Container Admission
c. Container Inspection
d. Container Services
e. Container Releasing

4. Reports
a. Daily Inventory Report
b. Status Aging Report
c. Gate—Out Report

5. Billing Management
a. Period Billing

6. Payment Processing
a. VMoney Integration

7. Payment Validation/Invoicing

### Freight Coordinator System

In a preferred embodiment, the system further comprises a freight coordinator system.

Freight Forwarding is a business arrangement wherein a third-party company handles the storage and shipping of commodities and goods in behalf of a shipper or a manufacturer. Freight Forwarders serve as an intermediary between the shipper and the service providers, including the shipping lines, trucking services, and customs brokerage.

With the current implementation of XLOG, shippers can book reservations directly to these service providers. For shippers that doesn't want to go through all these, and just wants rely with a single vendor, they can use the services of a freight forwarder through an XLOG Coordinator.

In one embodiment, the XLOG coordinator will have access to the freight forwarding system within XLOG. The XLOG coordinator will handle and manage all the booking reservations in behalf of the shipper. The XLOG coordinator and the shipper will also have a separate milestone to track the overall progress of the booking and shipping process.

The main objectives of the freight coordinator system are:

A. To provide the shippers an option to use the services of a freight forwarder through XLOG coordinators;

B. To manage booking inquiries and quotations between the shippers and the XLOG coordinators;

C. To let the XLOG coordinators manage all reservations in behalf of the shipper;

D. To track the XLOG coordinator's overall progress on booking reservations and shipping process on a separate milestone; and

E. To facilitate a separate documentation and billing module for the XLOG coordinator.

Preferably, the freight coordinator system has the following modules: (1) a company and agent registration module for XLOG coordinators, (2) a client directory management module, (3) an inquiry management module, (4) a booking and billing management module for shippers, and (4) a booking and billing management module for XLOG coordinators.

Preferably, a company and agent registration for XLOG coordinators is to be done in the Content Management System (CMS). The CMS admin will register the company and the agents, provided the company and user details, as XLOG Coordinators.

Through the client directory management module, the XLOG coordinator will have a client directory, including its shipper and their consignees. If the shipper does not wish to share his/her consignee directory, the XLOG coordinator has a local guest consignee directory.

Through the inquiry management module, the shipper can now inquire for booking rates and schedule availability through XLOG. Using the inquiry management module, the shippers can easily send inquiries, to which the XLOG coordinators can provide immediate quotations based from the provided inquiry details.

Through the booking and billing management module for shippers, the shipper can manage documentations to and from the XLOG coordinator, and track his/her shipping and booking processes. The shipper is also able to process payment to the XLOG coordinator within XLOG, be it prepaid, credit lines, or promissory notes.

For the XLOG coordinators, they can manage updates and documentation to and from the shipper through the booking and billing management module for XLOG coordinators. The XLOG Coordinators also have a separate billing module for them to consolidate billing statements for the shippers.

In one embodiment, there are six user roles in the system: (1) shipper, (2) freight forwarder, (3) consignee, (4) shipping lines, (5) customs brokers, and (6) trucking companies. The shipper initiates the booking and shipping process as an exporter, employs the services of a freight forwarder for his/her storage and shipping needs, provides the initial booking and shipping details to the freight forwarder, and manages the terms of payments.

The freight forwarder is an intermediary between shipper and service providers who handles booking and shipping processes in behalf of shipper, assumes liabilities with acting as carriers, and manages booking and shipping documentations.

The consignee receives the shipment as the importer, assigned as the primary notify party upon shipment's arrival at the destination port, and manages the terms of payments.

The shipping Lines manage shipping schedules, issue the release of containers, and provide bill of lading, and handles carrying of shipments and cargos at ports and harbors.

The customs brokers prepare customs documentation, ensure shipments meet laws to facilitate the import and export of goods, determine duties and taxes payable, and process duties and taxes in behalf of client.

The trucking companies plan and organize shipment pick-up and delivery, are knowledgeable of loading and unloading procedures, secure the loading and unloading of freights, and keep pick-up and carry papers for inspections.

In one embodiment, the freight coordinator system covers the following major areas:

| Item | Portal | Module |
|---|---|---|
| 1 | CMS | XLOG Coordinator Registration - Forwarding Company |
| 2 | CMS | Coordinator Registration - Forwarding Agent |
| 3 | CMS | Inquiry Status Management |
| 4 | CMS | Booking Status Management |
| 5 | CMS | Terms of Payment Management |
| 6 | CMS | Mode of Transfer Management |
| 1 | WEB | Coordinator Account Management |
| 2 | WEB | Coordinator Directory Management |
| 3 | WEB | Shipper Directory Management |
| 4 | WEB | Inquiry Management - Shipper |
| 5 | WEB | Inquiry Management - XLOG Coordinator |
| 6 | WEB | Booking Management - Shipper |
| 7 | WEB | Booking Management - XLOG Coordinator |
| 8 | WEB | Billing Management - Shipper |
| 9 | WEB | Billing Management - XLOG Coordinator |

Preferably, the freight coordinator system is deployed to a cloud infrastructure through Amazon Web Services (AWS).

A process flow of inquiry management in accordance with an example embodiment is as follows. The shipper books for the service of an XLOG coordinator. The shipper is redirected to the Inquiry Page. The shipper fills-up required details, and submits the accomplished inquiry form for a quotation request. The XLOG coordinator is notified that an inquiry was submitted. The XLOG coordinator then reviews the sent inquiry. The XLOG coordinator sends a quotation based on the submitted inquiry. The shipper is notified that a quotation was sent for review. The shipper has three actions available for the sent quotation, accept and proceed to booking, receive quotation, and renegotiate. If the shipper chooses “Accept the Quotation and Proceed to Booking,” the XLOG coordinator is notified and now proceeds with the booking process. If shipper chooses “Receive Quotation,” the shipper acknowledges the receipt of the quotation. The XLOG coordinator is notified of the acknowledgement. After the acknowledgement, a “Proceed to Booking” action will be available as a shipper action. When the shipper chooses “Proceed to Booking,” the XLOG coordinator is notified and now proceeds with the booking process. If the shipper chooses “Renegotiate,” the shipper inputs a requested rate, and/or input notes to request for a validity extension. The XLOG coordinator is then notified of the renegotiation request, confirms the renegotiation, and attaches another quotation for the shipper's confirmation. If the shipper still chooses “Renegotiate,” the same process applies until the shipper and the coordinator agrees with the terms. The XLOG coordinator now proceeds to booking. The shipper can “Amend” his/her inquiry as long as no booking is finalized yet. An amended inquiry is considered as an another inquiry and is with a new inquiry ID.

A process flow of booking and billing management (export side) in accordance with an example embodiment is as follows. The XLOG coordinator books for shipping line and other service providers in behalf of the shipper. The XLOG coordinator updates the shipper of the booking request containing the booking number, the vessel schedule, voyage number, etc. The shipper is then notified upon receipt of the Booking Confirmation. The XLOG coordinator updates the shipper of the trucking request containing trucking number, truck's plate number, driver's name, etc. The shipper is then notified upon receipt of the Trucking Confirmation. The shipper now provides the Authorization-To-Load (ATL) document to proceed with the product loading from the warehouse. The XLOG coordinator is notified upon receipt of the ATL. Upon submission of the ATL, the shipper also provides the Shipping Instruction together with the packing lists, necessary certificates (e.g. fumigation certificate), sales contract, etc. The XLOG coordinator is notified once a Shipping Instruction is received. The coordinator reviews the Shipping Instruction for incomplete or incorrect details. In the instance of incomplete or incorrect Shipping Instruction, the shipper needs to complete or correct the details of the shipping instruction. Once the shipping instruction is completed, the XLOG coordinator drafts a house bill of lading (BL) based on the BL draft provided by the shipping lines. The shipper is then notified upon receipt of the draft BL. The shipper then reviews the Draft BL for completeness of information. The XLOG coordinator provides another draft BL in cases of incorrect or incomplete details. Once the Draft BL is received, shipping lines can now issue an initial invoice. The XLOG coordinator settles the payment and is then validated by the shipping line. After the confirmation of the Draft BL, shipping lines notifies the XLOG coordinator once the shipment is loaded on the vessel. The coordinator now notifies the shipper of the loading confirmation from the shipping lines. The XLOG coordinator sends a non-negotiable BL to the shipper, together with the Certificate of Origin (upon request) from the customs broker. The shipper is notified upon receipt of the documents. The shipment is now in-transit. Before processing the final BL, The XLOG coordinator issues an initial voice for the shipper's payment processing. Once the payment is settled and is verified, the XLOG coordinator issues a final BL. Upon arrival of shipment at the port of discharge, the XLOG coordinator receives an Arrival Notice from the shipping lines which is then relayed to the shipper.

A process flow of booking and billing management (import side) in accordance with an example embodiment is as follows. Upon the arrival of the shipment, the shipping lines can now issue an import initial invoice. The XLOG coordinator settles the payment and is then validated by the shipping line. After notifying the shipper of the arrival of the shipment, the XLOG coordinator can also issue an import initial invoice already for the processing of the release clearances and documents. The consignee settles the payment and is then validated by the shipping line. The shipping lines now issue the import documents needed for the release of the shipments from the ports and are given to the XLOG coordinators. The XLOG coordinator sends these documents to the shipper for reference. The consignee is notified upon receipt of the import documents. The Customs Brokerage releases the customs clearances and documents, and is given to the XLOG coordinator. The XLOG coordinator notifies the consignee of these clearances and documents. The XLOG coordinator can now process a delivery receipt to be brought by the trucking service to the destination point. The consignee receives a copy of the unsigned delivery receipt for the delivery details. The trucking service now handles and delivers the shipment together with the unsigned delivery receipt. Once shipment received the destination, consignee acknowledges the delivery and signs the delivery receipt. The signed delivery receipt is sent to the XLOG coordinator by the trucking company. This delivery receipt is also sent by the XLOG Coordinator to the consignee for reference. The XLOG coordinator confirms the delivery process and now tags the shipment as delivered. The transaction is now complete.

In a preferred embodiment, freight forwarding companies will register to XLOG as XLOG Coordinators. Registration is to be done in CMS by the back office. Preferably, the forwarding company provides their company details to be able to register as XLOG coordinators.

Freight forwarding companies will also have to register their agents as the coordinator. The coordinators will be first hand users of the XLOG coordinator system for the company. Registration is to be done in CMS by the back office as well. The forwarding agents will have to provide their profile details to be able to register as Coordinators.

In a preferred embodiment, the freight coordinator system comprises a freight coordinator registration module. A diagram flow of freight coordinator registration in accordance with an example embodiment is as follows. First, freight forwarding companies provide their required company details for registration. The XLOG back office then processes these details for registration. Once company is already within XLOG, the back office then sets up the agent accounts for the freight forwarding company. The company provides the required details for their agent's registration. Once the agents are registered as coordinators for the company, they will be receiving notifications on the contact details they have provided. Notifications will contain the link for the agents to be able to set their login credentials.

In a preferred embodiment, the freight coordinator system comprises a client directory management module. The XLOG coordinators will manage a client directory containing the lists of all their shippers together with their consignees. The XLOG coordinators will also have a local guest directory for instances that shipper does not wish to share or disclose his/her list of consignees.

A diagram flow of client directory management in accordance with an example embodiment is as follows. First, the XLOG coordinator adds their shipper to their directory through shipper's reference IDs. The shipper will have to provide their unique reference ID to the XLOG coordinator. Once the shipper is added to the coordinator's directory, the coordinator will request an access to the consignee's directory of the shipper. If shipper confirms the access request, the XLOG coordinator can then pull-up the details of the shipper's registered consignees. In cases the shipper does not wish to disclose his/her lists of consignees, the XLOG coordinator has a local guest consignee directory. The shipper will provide the details of the consignee so that the XLOG Coordinator can add the consignee in his local guest consignee's directory.

In another embodiment, the shipper provides the reference ID which is then added to the freight coordinator's directory. There can be two directories—Freight Coordinator to Shipper, and Export Freight Coordinator to Import Freight Coordinator. The two transacting parties cannot view each other's client directory, unless permission is given by the other party. The freight forwarder requests for the shipper's consignee details. For instance where the shipper does not want to share consignee details, the freight coordinator can add the chosen consignee in their directory under “guest”. Upon successful adding of the consignee, the shipper is then sent notifications.

In a preferred embodiment, the freight coordinator system comprises an inquiry management module. The shippers can now inquire for booking rates and schedule availabilities through XLOG. The inquiry management module is added for shippers who wish to employ services of a freight forwarder or the XLOG coordinator. An inquiry page will be available containing all required details needed by the XLOG coordinator to provide a rate quotation. Through this module, the XLOG coordinator can provide a quotation and manage all incoming inquiries.

A diagram flow of inquiry management in accordance with an example embodiment is as follows. First, to send a booking inquiry, the shipper will need to fill-up all essential details on the inquiry page provided. Once completed, the shipper submits the inquiry form to the XLOG coordinator. The XLOG coordinator reviews the inquiry, checks for the available schedules, and processes a quotation for the shipper's inquiry. The shipper then uploads the quotation through the management system and is for the shipper's confirmation. The shipper confirms the received quotation. The shipper has three options, to receive the inquiry, to renegotiate with the rates or validity, and to accept and book immediately. If the shipper receives the inquiry, a proceed to booking button will be available if shipper wants to advise the XLOG coordinator to proceed with the booking. If the shipper renegotiates with the rate or the validity date, the XLOG coordinator uploads another updated quotation to renegotiate with the shipper's terms. An amendment option will be available after submission of the inquiry in case shipper needs to amend details of his/her inquiry. An amended inquiry will count as an another inquiry. The inquiry cannot be amended anymore once booking process is done.

In one embodiment, registered shippers in XLOG can book services of the XLOG freight coordinator. The shipper sends inquiry through the “Inquiry Page” by filling-up the following details: (1) Customer Name (Shipper), (2) Product, (3) Container Type, (4) Container Size, (5) Container Quantity, (6) Packaging, (7) Terms of Payment (INCO Terms), (8) Mode of Transfer (e.g. Door to Door), (9) Port of Loading, (10) Port of Discharge, (11) Target Shipment Date, (12) Target Rate, (13) Validity Request, (14) Free Time (Origin), (15) Free Time (Destination), and (16) Other Documents.

Incoterms such as Ex Works (EXW), Free On Board (FOB), Free Carrier (FCA), Free Alongside Ship (FAS), Delivered Duty Paid (DDP), Delivered At Place (DAP), Delivered At Terminal (DAT), Carriage And Insurance Paid To (CIP), Cost, Insurance, And Freight (CIF), Cost and Freight (CFR), Carriage Paid To (CPT) can be used. Modes of transfer include: Door-to-Door, Door-to-Port, Port-to-Door, and Port-to-Port.

The freight coordinator reviews the inquiry, then sends a quotation based on the shipper's provided details. Quotations from the freight coordinator include the rate and the validity date of the quotation. The shipper can “Renegotiate,” “Receive,” or “Accept and Book” the quotation. “Renegotiate” indicates that the shipper wants to renegotiate with the quoted rates. Also, shipper could request for the extension of the quotation validity. “Receive” indicates that the shipper acknowledges receipt of the quotation. “Accept and Book” indicates that the shipper acknowledges receipt of the quotation and allows the freight coordinator to process the booking.

Upon submission of inquiry, the shipper has options to amend previous inquiry. Amending the inquiry redirects the shipper to the “Inquiry Page” with pre-populated details. The amended inquiry now counts as an another inquiry. Inquiries can only be amended if shipper has not confirmed the inquiry yet.

A booking process in accordance with an example embodiment is as follows.

The freight coordinator books the shipping line services, and the other service provider in behalf of the shipper. The freight coordinator sends the Booking Confirmation and the Trucking confirmation to the shipper for reference. The shipper provides an authorization to the forwarder to proceed with the loading of goods. The shipper sends the shipping instruction, which is then confirmed by the forwarder. Once shipping instruction is accepted, the freight coordinator can now provide a draft BL to the shipper.

The shipper then receives a Loading Confirmation stating that the containers are now being loaded to the vessel. Once shipment is already in transit to the destination, the freight coordinator can now issue a non-negotiable BL. Upon shipper's request, the certificate of origin can now be issued as well. The freight coordinator now generates the final billing to the shipper. The shipper processes the payment either by prepaid wallets, by using their credit lines, or by promissory note. The freight coordinator then validates if payment was made. Once the freight coordinator validated that the payment has been made, they now process an issuance of the final BL. Upon shipments arrival on the port of discharge, the shipper receives an Arrival Notice from the freight coordinator.

The freight coordinator from the import side issue the final billing to the consignee. The consignee processes the payment either by prepaid wallets, by using their credit lines, or by promissory note. The freight coordinator validates if payment was made then issues an endorsement of the import documents for customs checking. The customs brokerage issues the customs document needed to proceed with the delivery.

Upon delivery, the consignee signs a delivery receipt to confirm that delivery has been made. The forwarder then sends the signed delivery receipt, signed by the consignee, to the shipper for delivery confirmation. The transaction is now complete.

The shipper cannot access or view the documents released by the shipping lines and the OSPs to the Freight Coordinators. The freight coordinator will have a module to upload documents that will be available for the shipper's viewing. There will be two separate modules for invoicing: (a) shipping lines and other OSPs will send invoices to the freight coordinator for their services, and (b) The freight coordinator will have a separate billing system for its shippers.

In one embodiment, the timeline of the fright coordinator system is as follows:

1. Forwarder Registration

2. Client Directory Management

3. Inquiry Management

4. Booking Process (Shipper)

5. Booking Process (Forwarder)

6. Reports (TBD)

### Port Services System

In a preferred embodiment, the system further comprises a port services system.

Ports are maritime commercial facilities that comprises of one or more wharves, where ships may dock for loading and discharging. The port operators regulate the amounts of all the charges and fees incurred for utilizing the port and its services. Common incurred fees and charges for the shipper include the arrastre charges, the wharfage charges, and the storage charges.

With the traditional port charging procedures, port charges are paid by the shipper through a customs brokerage service. With XLOG's Port Microservice, shippers are informed ahead of their due port charges. Also, the shippers can process the payment through XLOG and pay the port operators directly of their incurred charges.

The Port Service will be a microsite of XLOG for the port operators and its agents. Through this microsite, the port operators will have a forecasted number of shipping reservations going in and out of their port. The microsite will include a charge management system that will let the port operators declare and assign the required port charges together with their respective rates.

The main objectives of the port services system are:

A. To track port utilizations, i.e. shipping vessels and containers going in and out of the port, for management purposes.

B. To manage port operation charges and fees both for export and import transactions.

C. To inform the shippers and/or consignees of their port charges based on their bill of lading.

D. To give port operators a charges/fees collection system that can be directly accessed by the shippers and consignees.

E. To provide a way for shippers and/or consignees to directly process the payment to the port operators.

It is noted that “arrastre” as used herein refers to a person/entity who/which performs portside cargo handling operations, e.g. receiving, handling, custody, security and delivery of cargo passing over piers, quays or wharves, transit sheds/warehouses and open storages within the jurisdictional area of responsibility of the authorized contractor/operator.

It is noted that “bill of lading” or “BL” as used herein refers to a document that establishes the terms of contract between a shipper and a transportation company. It serves as a document of title, a contract of carriage, and a receipt for goods.

It is noted that “container” as used herein refers to a large metal box in which goods are stuffed and handled as one unit. The standard sizes are 20 ft.×8 ft.; 40 ft.×8 ft.; 45 ft.×8 ft.

It is noted that “dock” as used herein refers to a structure attached to land to which a vessel is moored.

It is noted that “harbor charges” as used herein refers to charges by a port authority to a vessel for each harbor entry, usually on a per gross tonnage basis, to cover the costs of basic port infrastructure and marine facilities such as buoys, beacons, and vessel traffic management system.

It is noted that “loading” as used herein refers to the operation of transferring cargo from the quay of barge into the hold or on to the deck of a ship. It is not complete until the cargo has been removed from the slings and placed in the hold or on the deck of a vessel.

It is noted that “port charges” as used herein refers to charges levied against a ship owner or ship operator by a port authority for the use of a port.

It is noted that “wharfage” as used herein refers to the charge that an owner of a facility (terminal or port) charges for the movement of cargo through that facility.

In one embodiment, the port services system comprises a port operator company and agent registration module, port service microsite module, port operator dashboard module, shipping reservation management module—export, shipping reservation management module—import, port charge management module, port charge assignment module, port charge payment module, and port charge payout management module.

Preferably, a port operator company and agent registration can be done in CMS. The CMS admin will register the port operator company and the agents, provided the company and user details to access the Port Services microsite.

Once port agents are registered, they can now access the port services microsite. The port services microsite includes a login page module, port operator dashboard module, shipping reservation management module, and port charge management and assignment module.

The port operator dashboard is the activity display page once port operators have successfully accessed the system. The dashboard contains summaries of bookings that'll be going in and out of the port, as well as the estimated number of container gate-ins.

With regard to the shipping reservation management (export) module, once a shipping reservation from XLOG is done with the confirmation of the draft bill of lading, port operators are informed of the reservation through the shipping reservation management (export) module. This module contains all the shipping reservations utilizing the port for export processes.

With regard to the shipping reservation management (import) module, once a shipping reservation from XLOG has a finalized bill of lading, port operators are informed of the reservation through the shipping reservation management (import) module. This module contains all the shipping reservations utilizing the port for import processes.

With regard to the port charge management module, port operators can declare the port charges, both for import and export processes, through this module. This management system is for standard charges per container unit, i.e. arrastre charges and wharfage charges. Port operators can also declare incidental charges in this module.

With regard to the port charge assignment module, once port operator receives a shipping reservations, they can now assign the port charges for the shipper's/consignee's viewing. Charges assigned to the shipping reservation will be the declared charges from the charge management system/module.

With regard to the port charge payment module, shippers/consignees can view the port charges they will be incurring for utilizing the port services. Also, shippers/consignees can process the payment directly to the port operators, either by using prepaid or by credit lines.

With regard to the port charge payout management module, this module allows the back office admin to handle the payout processes for the port operator once shipper's/consignee's prepaid payment has been validated.

In one embodiment, there are three types of user role: (1) port operator, (2) shipper, and (3) consignee. The port operator manages port operations, services, and utilities; declares port charges per container units; assigns port charges to shipping reservations; and handles payment processes and validations for port charges and fees. The shipper initiates the booking and shipping processes as an exporter; provides the initial booking and shipping details to shipping lines and other service providers, or to freight forwarder; confirms the draft bill of lading for port charge assignment; and handles payment processes of port charges and fees to the port operators on the export side. The consignee receives the shipment as the importer; assigned as the primary notify party upon shipment's arrival at the destination port; and handles payment processes of port charges and fees to the port operator on the import side.

The port services system will cover the following major areas:

| Item | Portal | Module |
|---|---|---|
| 1 | CMS - Main | Port Operator Registration - Company |
| 2 | CMS - Main | Port Operator Registration - Agent |
| 3 | CMS - Main | Port Charge Payout Management |
| 4 | CMS - Main | Port Charge Status Management |
| 5 | CMS - Main | Port Charge Events Management |
| 1 | CMS - Port | Company Account Activation |
| 2 | CMS - Port | Agent Account Activation |
| 3 | CMS - Port | Login Module |
| 4 | CMS - Port | Company Account Management |
| 5 | CMS - Port | Agent Account Management |
| 6 | CMS - Port | Port Operator Dashboard |
| 7 | CMS - Port | Shipping Reservation Management |
| 8 | CMS - Port | Port Charge Management |
| 9 | CMS - Port | Port Charge Assignment |
| 1 | WEB | Port Charge Payment Management |

In a preferred embodiment, the port services system is deployed to a cloud infrastructure through Amazon Web Services (AWS).

A process flow of port charge assignment payment for export in accordance with an example embodiment is as follows. The shipper confirms a bill of lading draft of his/her shipping reservation. The port operator is notified of the confirmation. The port operator then reviews the shipping reservation together with the confirmed BL draft. The port operator then assigns port charges to the shipping reservation based on the confirmed BL draft. The shipper is notified of the charge assignment, and is now available for viewing. The port operator enables the payment for the shipper to directly process his/her payment to the port operator. The port operator sends an initial invoice to the shipper for the payment processing. The shipper either directly pays the port charges to the port operators or has the payment processed through a customs broker. If the shipper wishes to have the payment processed manually with a customs broker, he/she just needs to leave the transaction hanging until the port operator tags it as complete. If the shipper will pay the port charges directly to the port operators, prepaid or credit line payment is available. The Port operator then validates the payment. If the payment is not validated, the shipper then processes the payment again. Once the payment is validated, the port operator can now issue a final invoice. The transaction is now tagged as complete.

A process flow of port charge assignment payment for import in accordance with an example embodiment is as follows. Port operators are notified once the shipper has received the final Bill of Lading. The port operator then reviews the shipping reservation together with the final bill of lading. The port operator then assigns port charges to the shipping reservation based on the final BL. The consignee is notified of the charge assignment, and is now available for viewing. The port operator confirms if the consignee has already settled and is cleared with all the import customs duties and taxes. If the consignee is not yet settled with the duties and taxes, direct payment to the port operator is still enabled. If the consignee is cleared with the customs duties and taxes, the port operator enables the payment for the consignee to directly process his/her payment to the port operator. The port operator sends an initial invoice to the consignee for the payment processing. The consignee either directly pays the port charges to the port operators or has the payment processed through a customs broker. If the consignee wishes to have the payment processed manually with a customs broker, he/she just needs to leave the transaction hanging until the port operator tags it as complete. If the consignee will pay the port charges directly to the port operators, prepaid or credit line payment is available. The port operator then validates the payment. If the payment is not validated, the consignee then processes the payment again. Once the payment is validated, the port operator can now issue a final invoice. The transaction is now tagged as complete.

In one embodiment, a port operator registration can be done in CMS by the back office. The port operator companies will have to provide their company details to be able to register as XLOG port operators.

Port operating companies will have to register their agents as well. In one embodiment, a port operator registration can be done in CMS by the back office. The port operator agents will have to provide their profile and contact details to be able to register and for them to set their login credentials.

A diagram flow of port operator registration in accordance with an example embodiment is as follows. First, port operating companies provide their required company details for registration. The XLOG back office then processes these details for registration. Once the company is already within XLOG, the back office then sets up the agent accounts for the port operating company. The company provides the required details for their agent's registration. Once the agents are registered for the company, they will be receiving notifications on the contact details they have provided. The notifications will contain the link for the agents to be able to set their login credentials.

In a preferred embodiment, the port operators can manage the declaration of the rates (e.g. arrastre charges and wharfage charges) for their port services. The port operators can separately declare charges for both import and export, and easily assign these charges to individual shipping reservations.

In another embodiment, the port operators will declare the rates of the port charges (i.e. wharfage/arrastre) for their services. The port operators will also set the charges for both Import and Export charges. These declared rates and port charges will be applied to the individual reservations of the shipper/consignee. Through the port charges management module, the port manager can easily declare port charges per individual reservations.

In one embodiment, the port operators can assign charges to individual shipping reservations utilizing the port for export transactions. The port operator can also enable the direct payment method for shippers to process the payment directly to the port operator.

In another embodiment, for port charge assignment (export), the port operators assigns charges from the charge management system/module and assigns charges based on the shipper's confirmed draft of the bill of lading.

A diagram flow of port charge assignment for export in accordance with an example embodiment is as follows. Once the shipper confirms the draft of the bill of lading, the port operator can now assign a port charge to that shipping reservation. The port operator reviews the draft BL then assigns the port charges. The shipper processes the payment either by prepaid or by using credit line. Once the payment is validated, port operator proceeds with loading the containers onto the vessel.

In another embodiment, the port manager can manage a list of all the shipping reservations on their port for export. The port manager reviews the BL draft from that shipping reservation, then assigns a port charge to that reservation. The port manager is able to pull-up pre-loaded port charges from the port charges management. The port manager is also able to manually upload a new charge if specific charges are needed to apply. The shipper then confirms the assigned port charges and decides for the payment process. The shipper has an option to pay either directly to the port manager, or through the custom brokers. If the shipper chooses to pay the port charges directly to the port operator, the shipper then does the payment process. If the shipper chooses to pay the port charges through the customs broker, the shipper will have an option to link the port charges to his/her customs broker reservations. In the case that the shipper has no customs broker reservations yet, he/she is redirected to the customs broker reservation page to book for the services of a customs broker. The shipper also needs to state if payment of port charges will be through his/her in-house brokerage, or a broker outside of XLOG.

Preferably, the port operators assign charges from the charge management system and assigns charges based on the final bill of lading. A diagram flow of port charge assignment for import in accordance with an example embodiment is as follows. Port operators assign the port charges on the import based from the final bill of lading. Once the final bill of lading has been issued, the port operators can now review this and assign the corresponding charges after. The consignee processes the payment either by prepaid or by using credit line. Once the payment is validated, the port operator releases the gate pass for the container release order.

In another embodiment, the port manager can manage a list of all the shipping reservations on their port for import. The port manager reviews the final BL from that shipping reservation, then assigns a port charge to that reservation. The port manager is able to pull-up pre-loaded port charges from the port charges management. The port manager is also able to manually upload a new charge if specific charges are needed to apply. Uploaded charges are initially for the shipper's view only until all duties and taxes are paid. Once the shipper has settled these duties and taxes, port manager will now open the payment option to the shipper. The shipper then confirms the assigned port charges and decides for the payment process. The shipper has option to pay either directly to the port manager, or through the custom brokers. If the shipper chooses to pay the port charges directly to the port operator, the shipper then does the payment process. If the shipper chooses to pay the port charges through the customs broker, the shipper will have an option to link the port charges to his/her customs broker reservations. In the case that the shipper has no customs broker reservations yet, he/she is redirected to the customs broker reservation page to book for the services of a customs broker. The shipper also needs to state if payment of port charges will be through his/her in-house brokerage, or a broker outside of XLOG.

An example timeline of the port services system is as follows:

1. Port Operator Registration

2. Port Charges Management

3. Port Charges Assignment

4. Payment Process (Shipper)

5. Reports (TBD)

As noted above, the present invention or any part(s) or function(s) thereof, including but not limited to elements denoted by reference numerals 2, 4, 6, 8, 10, 12, 101, 102, 103, 104, 105, 106, 108, 110, 112, and 114, may be implemented using hardware, software, or a combination thereof, and may be implemented in one or more computer systems or other processing systems and using mobile apps. A computer system for performing the operations of the present invention and capable of carrying out the functionality described herein can include one or more processors connected to a communications infrastructure (e.g., a communications bus, a cross-over bar, or a network). Various software embodiments are described in terms of such an exemplary computer system. After reading this description, it will become apparent to a person skilled in the relevant art(s) how to implement the invention using other computer systems and/or architectures.

The computer system can include a display interface that forwards graphics, text, and other data from the communication infrastructure (or from a frame buffer) for display on a display unit. The display interface can communicate with a browser. The computer system also includes a main memory, preferably a random access memory, and may also include a secondary memory and a database. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. The removable storage unit can represent a floppy disk, magnetic tape, optical disk, etc. which is read by and written to by the removable storage drive. As will be appreciated, the removable storage unit can include a computer usable storage medium having stored therein computer software and/or data.

The computer system may also include a communications interface which allows software and data to be transferred between the computer system and external devices. The terms “computer program medium” and “computer usable medium” are used to refer generally to media such as the removable storage drive, a hard disk installed in the hard disk drive, and signals. These computer program products provide software to the computer system.

Computer programs or control logic are stored in the main memory and/or the secondary memory. Computer programs may also be received via the communications interface. Such computer programs or control logic (software), when executed, causes the computer system or its processor to perform the features and functions of the present invention, as discussed herein.

Accordingly, software embodiments of the present invention may be provided as a computer program product, or software, that may include an article of manufacture on a machine accessible or machine readable medium (memory) having instructions. The instructions on the machine accessible or machine readable medium may be used to program a computer system or other electronic device. The machine-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above-described exemplary embodiments, but should be defined only in accordance with the following claims and their equivalents.

In addition, it should be understood that the Figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

What is claimed is:

1. A method for real-time and online freight management in the global logistics industry using a real-time chained black box, comprising:
a. providing a booking request submission stage;
b. providing a booking request acceptance stage;
c. providing a service delivery/fulfillment stage; and
d. providing a service payment stage.

2. The method of claim 1, wherein the booking request submission stage comprises, by a device of a service provider:
initiating a booking request;
displaying at least one applicable contracts with regard to the booking provided by a platform;
determining whether at least one applicable contract is selected;
completing portal field information and submitting the portal field information through a portal of the platform; and
receiving suggestions or offers with regard to the booking from the platform.

3. The method of claim 2, wherein the booking request acceptance stage comprises, by the device of the service provider:
providing a bidding offer through a bidding engine of the platform;
generating a quotation when rates are not available on the platform; and
sending the quotation to a device of a shipper.

4. The method of claim 3, wherein the service delivery/fulfillment stage comprises, by the device of the service provider:
completing service fulfillment/action task(s) provided by the platform;
determining whether a trade document is required;
determining whether other documents are required if the trade document is not required; and
uploading a proof of service delivery/fulfillment to the cloud database and to a blockchain.

5. The method of claim 4, wherein the service payment stage comprises, by the device of the service provider:
generating and sending an invoice to the device of the shipper;
storing the invoice in the cloud database and in the blockchain; and
determining whether the service provider opted for financing.

6. The method of claim 1, wherein the booking request submission stage comprises, by a platform:
validating a booking request received from a device of a service provider;
providing at least one applicable contract with regard to the booking request to the device of the service provider;
auto-populating portal fields using information as per a contract selected by the service provider;
providing suggestions or offers with regard to the booking request;
validating the booking request;
summarizing the booking request for review; and
sending the booking request to a SVCs (Services Available in the Platform), wherein the SVCs comprises sea freight, container yard, trucking, port, freight forwarding, custom brokerage, warehousing, air freight, and insurance.

7. The method of claim 6, wherein the service delivery/fulfillment stage comprises, by the platform:
triggering service workflow fulfillment task(s) and communicating with the SVCs (Services Available in the Platform);
determining whether a template is available if trade documents are determined to be required by the device of the service provider; and
auto-generating at least one trade document if a template is available and storing the at least one trade document in the cloud database and in the blockchain.

8. The method of claim 7, wherein the service payment stage comprises, by the platform:
triggering service workflow payment task(s) and sending the service workflow payment task(s) to the SVCs (Services Available in the Platform);
determining whether an invoice template is available;
auto-generating an invoice if an invoice template is available and storing an auto-generated invoice in the cloud database and in the blockchain;
sending the auto-generated invoice to the device of the service provider;
triggering transaction based financing for the service provider if it is determined that there are credit terms by the device of the shipper and that the service provider opted for financing by the device of the service provider;
updating an AR/AP ledger (account receivable/account payable ledger) if it is determined that there are credit terms by the device of the shipper;
sending notification alerts of payables on or before due dates;
processing payment via a ledger platform when the device of the shipper proceeds with payment;
when the payment was successfully processed in the step of processing payment, determining whether the service provider availed financing;
disbursing loan payment, which includes a principal and an interest if the service provider availed financing;
disbursing a service fee to the service provider; and
triggering transaction based financing for the shipper if it is determined that the shipper opted for financing.

9. The method of claim 1, wherein the booking request acceptance stage comprises, by a device of a shipper:
accepting a bidding offer; and
confirming rates after receiving a quotation from the device of the service provider.
receiving information from the SVCs (Services Available in the Platform), wherein the SVCs comprises sea freight, container yard, trucking, port, freight forwarding, custom brokerage, warehousing, air freight, and insurance;
triggering the bidding engine when the offer bidding setting is on;
sending and receiving information by the bidding engine to and from the device of the shipper and the device of the service provider;
auto-generating a quotation when rates are not available;
storing generated quotations in a cloud date base; and
selecting templates based on a generated quotation.

10. The method of claim 1, wherein the service payment stage comprises, by the device of the shipper:
receiving an invoice from a platform;
acknowledging the invoice and accepting charges;
determining whether there are credit terms;
determining whether the shipper opted for financing if there are no credit terms; and
proceeding with payment if the shipper did not opt for financing.

11. The method of claim 1, wherein the service payment stage comprises, by a device of a bank partner:
receiving information from the device of a platform after transaction based financing for service provider is triggered;
determining whether credit line and loans are approved for the service provider; disbursing an approved amount to a bank account of the service provider;
receiving a loan payments;
receiving information from the device of the shipper after transaction based financing for the shipper is triggered;
determining whether credit line and loans are approved for the shipper; and disbursing an approved amount to the platform.

12. A method for real-time and online freight management in the global logistics industry using a real-time chained black box, comprising:
a. providing a booking request submission stage;
b. providing a booking request acceptance stage;
c. providing a service delivery/fulfillment stage; and
d. providing a service payment stage;
(i) wherein a device of a service provider is configured to perform the following steps:
initiating a booking request in the booking request submission stage,
displaying at least one applicable contracts with regard to the booking provided by a platform in the booking request submission stage,
determining whether at least one applicable contract is selected in the booking request submission stage,
completing portal field information and submitting the portal field information through a portal of the platform in the booking request submission stage,
receiving suggestions or offers with regard to the booking from the platform in the booking request submission stage,
providing a bidding offer through a bidding engine of the platform in the booking request acceptance stage,
generating a quotation when rates are not available on the platform in the booking request acceptance stage,
sending the quotation to the device of the shipper in the booking request acceptance stage,
completing service fulfillment/action task(s) provided by the platform in the service delivery/fulfillment stage,
determining whether a trade document is required in the service delivery/fulfillment stage,
determining whether other documents are required if the trade document is not required in the service delivery/fulfillment stage,
uploading a proof of service delivery/fulfillment to the cloud database and to a blockchain in the service delivery/fulfillment stage,
generating and sending an invoice to the device of the shipper in the service delivery/fulfillment stage,
storing the invoice in the cloud database and in the blockchain in the service delivery/fulfillment stage, and
determining whether the service provider opted for financing in the service delivery/fulfillment stage;
(ii) wherein the platform is configured to perform the following steps:
validating a booking request received from a device of a service provider in the booking request submission stage,
providing at least one applicable contract with regard to the booking request to the device of the service provider in the booking request submission stage,
auto-populating portal fields using information as per a contract selected by the service provider in the booking request submission stage,
providing suggestions or offers with regard to the booking request in the booking request submission stage,
validating the booking request in the booking request submission stage,
summarizing the booking request for review in the booking request submission stage,
sending the booking request to SVCs (Services Available in the Platform) in the booking request submission stage, wherein the SVCs comprises sea freight, container yard, trucking, port, freight forwarding, custom brokerage, warehousing, air freight, and insurance,
triggering service workflow fulfillment task(s) and communicating with the SVCs in the service delivery/fulfillment stage,
determining whether a template is available if trade documents are determined to be required by the device of the service provider in the service delivery/fulfillment stage,
auto-generating at least one trade document if a template is available and storing the at least one trade document in the cloud database and in the blockchain in the service delivery/fulfillment stage,
triggering service workflow payment task(s) and sending the service workflow payment task(s) to the SVCs in the service payment stage,
determining whether an invoice template is available in the service payment stage,
auto-generating an invoice if an invoice template is available and storing an auto-generated invoice in the cloud database and in the blockchain in the service payment stage,
sending the auto-generated invoice to the device of the service provider in the service payment stage,
triggering transaction based financing for the service provider if it is determined that there are credit terms by the device of the shipper and that the service provider opted for financing by the device of the service provider in the service payment stage,
updating an AR/AP ledger (account receivable/account payable ledger) if it is determined that there are credit terms by the device of the shipper in the service payment stage,
sending notification alerts of payables on or before due dates in the service payment stage,
processing payment via the ledger platform when the device of the shipper proceeds with payment in the service payment stage,
when the payment was successfully processed in the step of processing payment, determining whether the service provider availed financing in the service payment stage,
disbursing loan payment, which includes a principal and an interest if the service provider availed financing in the service payment stage,
disbursing a service fee to the service provider in the service payment stage, and
triggering transaction based financing for the shipper if it is determined that the shipper opted for financing in the service payment stage;
(iii) wherein the device of the shipper is configured to perform the following steps:
accepting a bidding offer in the booking request acceptance stage,
confirming rates after receiving a quotation from the device of the service provider in the booking request acceptance stage,
receiving information from the SVCs in the booking request acceptance stage,
triggering the bidding engine when the offer bidding setting is on in the booking request acceptance stage,
sending and receiving information by the bidding engine to and from the device of the shipper and the device of the service provider in the booking request acceptance stage,
auto-generating a quotation when rates are not available in the booking request acceptance stage
storing generated quotations in a cloud date base in the booking request acceptance stage,
selecting templates based on a generated quotation in the booking request acceptance stage,
receiving an invoice from the platform in the service payment stage;
acknowledging the invoice and accepting charges in the service payment stage,
determining whether there are credit terms in the service payment stage,
determining whether the shipper opted for financing if there are no credit terms in the service payment stage, and
proceeding with payment if the shipper did not opt for financing in the service payment stage;
(iv) wherein a device of a bank partner is configured to perform the following steps:
receiving information from the device of the platform after transaction based financing for service provider is triggered in the service payment stage,
determining whether credit line and loans are approved for the service provider in the service payment stage,
disbursing an approved amount to a bank account of the service provider in the service payment stage,
receiving a loan payments in the service payment stage,
receiving information from the device of the shipper after transaction based financing for the shipper is triggered in the service payment stage,
determining whether credit line and loans are approved for the shipper in the service payment stage, and
disbursing an approved amount to the platform in the service payment stage.

13. A system for real-time and online freight management in the global logistics industry using a real-time chained black box, comprising:
(a) a device of a service provider;
(b) a device of a shipper;
(c) a platform on a server computer; and
(d) a device of a bank partner;
wherein the system is configured to provide four stages including a booking request submission stage, a booking request acceptance stage, a service delivery/fulfillment stage, and providing a service payment stage.

14. The system of claim 13, wherein the device of the service provider is configured to perform the following steps:
initiating a booking request in the booking request submission stage,
displaying at least one applicable contracts with regard to the booking provided by the platform in the booking request submission stage,
determining whether at least one applicable contract is selected in the booking request submission stage,
completing portal field information and submitting the portal field information through a portal of the platform in the booking request submission stage,
receiving suggestions or offers with regard to the booking from the platform in the booking request submission stage,
providing a bidding offer through a bidding engine of the platform in the booking request acceptance stage,
generating a quotation when rates are not available on the platform in the booking request acceptance stage,
sending the quotation to the device of the shipper in the booking request acceptance stage,
completing service fulfillment/action task(s) provided by the platform in the service delivery/fulfillment stage,
determining whether a trade document is required in the service delivery/fulfillment stage,
determining whether other documents are required if the trade document is not required in the service delivery/fulfillment stage,
uploading a proof of service delivery/fulfillment to the cloud database and to a blockchain in the service delivery/fulfillment stage,
generating and sending an invoice to the device of the shipper in the service delivery/fulfillment stage,
storing the invoice in the cloud database and in the blockchain in the service delivery/fulfillment stage, and
determining whether the service provider opted for financing in the service delivery/fulfillment stage.

15. The system of claim 13, wherein the platform is configured to perform the following steps:
validating a booking request received from a device of a service provider in the booking request submission stage,
providing at least one applicable contract with regard to the booking request to the device of the service provider in the booking request submission stage,
auto-populating portal fields using information as per a contract selected by the service provider in the booking request submission stage,
providing suggestions or offers with regard to the booking request in the booking request submission stage,
validating the booking request in the booking request submission stage,
summarizing the booking request for review in the booking request submission stage,
sending the booking request to SVCs (Services Available in the Platform) in the booking request submission stage, wherein the SVCs comprises sea freight, container yard, trucking, port, freight forwarding, custom brokerage, warehousing, air freight, and insurance,
triggering service workflow fulfillment task(s) and communicating with the SVCs in the service delivery/fulfillment stage,
determining whether a template is available if trade documents are determined to be required by the device of the service provider in the service delivery/fulfillment stage,
auto-generating at least one trade document if a template is available and storing the at least one trade document in the cloud database and in the blockchain in the service delivery/fulfillment stage,
triggering service workflow payment task(s) and sending the service workflow payment task(s) to the SVCs in the service payment stage,
determining whether an invoice template is available in the service payment stage,
auto-generating an invoice if an invoice template is available and storing an auto-generated invoice in the cloud database and in the blockchain in the service payment stage,
sending the auto-generated invoice to the device of the service provider in the service payment stage,
triggering transaction based financing for the service provider if it is determined that there are credit terms by the device of the shipper and that the service provider opted for financing by the device of the service provider in the service payment stage,
updating an AR/AP ledger (account receivable/account payable ledger) if it is determined that there are credit terms by the device of the shipper in the service payment stage,
sending notification alerts of payables on or before due dates in the service payment stage,
processing payment via the ledger platform when the device of the shipper proceeds with payment in the service payment stage,
when the payment was successfully processed in the step of processing payment, determining whether the service provider availed financing in the service payment stage,
disbursing loan payment, which includes a principal and an interest if the service provider availed financing in the service payment stage,
disbursing a service fee to the service provider in the service payment stage, and
triggering transaction based financing for the shipper if it is determined that the shipper opted for financing in the service payment stage;

16. The system of claim 13, wherein the device of the shipper is configured to perform the following steps:
accepting a bidding offer in the booking request acceptance stage,
confirming rates after receiving a quotation from the device of the service provider in the booking request acceptance stage,
receiving information from the SVCs (Services Available in the Platform) in the booking request acceptance stage, wherein the SVCs comprises sea freight, container yard, trucking, port, freight forwarding, custom brokerage, warehousing, air freight, and insurance,
triggering the bidding engine when the offer bidding setting is on in the booking request acceptance stage,
sending and receiving information by the bidding engine to and from the device of the shipper and the device of the service provider in the booking request acceptance stage,
auto-generating a quotation when rates are not available in the booking request acceptance stage storing generated quotations in a cloud date base in the booking request acceptance stage,
selecting templates based on a generated quotation in the booking request acceptance stage,
receiving an invoice from the platform in the service payment stage;
acknowledging the invoice and accepting charges in the service payment stage,
determining whether there are credit terms in the service payment stage,
determining whether the shipper opted for financing if there are no credit terms in the service payment stage, and
proceeding with payment if the shipper did not opt for financing in the service payment stage;

17. The system of claim 13, wherein the device of the bank partner is configured to perform the following steps:
receiving information from the device of the platform after transaction based financing for service provider is triggered in the service payment stage,
determining whether credit line and loans are approved for the service provider in the service payment stage,
disbursing an approved amount to a bank account of the service provider in the service payment stage,
receiving a loan payments in the service payment stage,
receiving information from the device of the shipper after transaction based financing for the shipper is triggered in the service payment stage,
determining whether credit line and loans are approved for the shipper in the service payment stage; and
disbursing an approved amount to the platform in the service payment stage.

18. A system for real-time and online freight management in the global logistics industry using a real-time chained black box, comprising:
(a) a device of a service provider;
(b) a device of a shipper;
(c) a platform on a server computer; and
(d) a device of a bank partner;
(i) wherein the system is configured to provide four stages including a booking request submission stage, a booking request acceptance stage, a service delivery/fulfillment stage, and providing a service payment stage.
(ii) wherein the device of the service provider is configured to perform the following steps:
initiating a booking request in the booking request submission stage,
displaying at least one applicable contracts with regard to the booking provided by the platform in the booking request submission stage,
determining whether at least one applicable contract is selected in the booking request submission stage,
completing portal field information and submitting the portal field information through a portal of the platform in the booking request submission stage,
receiving suggestions or offers with regard to the booking from the platform in the booking request submission stage,
providing a bidding offer through a bidding engine of the platform in the booking request acceptance stage,
generating a quotation when rates are not available on the platform in the booking request acceptance stage,
sending the quotation to the device of the shipper in the booking request acceptance stage,
completing service fulfillment/action task(s) provided by the platform in the service delivery/fulfillment stage,
determining whether a trade document is required in the service delivery/fulfillment stage,
determining whether other documents are required if the trade document is not required in the service delivery/fulfillment stage,
uploading a proof of service delivery/fulfillment to the cloud database and to a blockchain in the service delivery/fulfillment stage,
generating and sending an invoice to the device of the shipper in the service delivery/fulfillment stage,
storing the invoice in the cloud database and in the blockchain in the service delivery/fulfillment stage, and
determining whether the service provider opted for financing in the service delivery/fulfillment stage;
(iii) wherein the platform is configured to perform the following steps:
validating a booking request received from a device of a service provider in the booking request submission stage,
providing at least one applicable contract with regard to the booking request to the device of the service provider in the booking request submission stage,
auto-populating portal fields using information as per a contract selected by the service provider in the booking request submission stage,
providing suggestions or offers with regard to the booking request in the booking request submission stage,
validating the booking request in the booking request submission stage,
summarizing the booking request for review in the booking request submission stage,
sending the booking request to SVCs (Services Available in the Platform) in the booking request submission stage, wherein the SVCs comprises sea freight, container yard, trucking, port, freight forwarding, custom brokerage, warehousing, air freight, and insurance,
triggering service workflow fulfillment task(s) and communicating with the SVCs in the service delivery/fulfillment stage,
determining whether a template is available if trade documents are determined to be required by the device of the service provider in the service delivery/fulfillment stage,
auto-generating at least one trade document if a template is available and storing the at least one trade document in the cloud database and in the blockchain in the service delivery/fulfillment stage,
triggering service workflow payment task(s) and sending the service workflow payment task(s) to the SVCs in the service payment stage,
determining whether an invoice template is available in the service payment stage,
auto-generating an invoice if an invoice template is available and storing an auto-generated invoice in the cloud database and in the blockchain in the service payment stage,
sending the auto-generated invoice to the device of the service provider in the service payment stage,
triggering transaction based financing for the service provider if it is determined that there are credit terms by the device of the shipper and that the service provider opted for financing by the device of the service provider in the service payment stage,
updating an AR/AP ledger (account receivable/account payable ledger) if it is determined that there are credit terms by the device of the shipper in the service payment stage,
sending notification alerts of payables on or before due dates in the service payment stage,
processing payment via the ledger platform when the device of the shipper proceeds with payment in the service payment stage,
when the payment was successfully processed in the step of processing payment, determining whether the service provider availed financing in the service payment stage,
disbursing loan payment, which includes a principal and an interest if the service provider availed financing in the service payment stage,
disbursing a service fee to the service provider in the service payment stage, and
triggering transaction based financing for the shipper if it is determined that the shipper opted for financing in the service payment stage;
(iv) wherein the device of the shipper is configured to perform the following steps:
accepting a bidding offer in the booking request acceptance stage,
confirming rates after receiving a quotation from the device of the service provider in the booking request acceptance stage,
receiving information from the SVCs in the booking request acceptance stage,
triggering the bidding engine when the offer bidding setting is on in the booking request acceptance stage,
sending and receiving information by the bidding engine to and from the device of the shipper and the device of the service provider in the booking request acceptance stage,
auto-generating a quotation when rates are not available in the booking request acceptance stage
storing generated quotations in a cloud date base and in the blockchain in the booking request acceptance stage,
selecting templates based on a generated quotation in the booking request acceptance stage,
receiving an invoice from the platform in the service payment stage;
acknowledging the invoice and accepting charges in the service payment stage,
determining whether there are credit terms in the service payment stage,
determining whether the shipper opted for financing if there are no credit terms in the service payment stage, and
proceeding with payment if the shipper did not opt for financing in the service payment stage;
(v) wherein the device of the bank partner is configured to perform the following steps:
receiving information from the device of the platform after transaction based financing for service provider is triggered in the service payment stage,
determining whether credit line and loans are approved for the service provider in the service payment stage,
disbursing an approved amount to a bank account of the service provider in the service payment stage,
receiving a loan payments in the service payment stage,
receiving information from the device of the shipper after transaction based financing for the shipper is triggered in the service payment stage,
determining whether credit line and loans are approved for the shipper in the service payment stage; and
disbursing an approved amount to the platform in the service payment stage.
